(19) United States
(12) Patent Application Publication
(10) Pub. No.: US 2015/0271557 A1
(43) Pub. Date: Sep. 24, 2015

(54) MULTIMEDIA TELEVISION SYSTEM FOR INTERACTIVE SOCIAL MEDIA AND SOCIAL NETWORK

(71) Applicant: Joseph Akwo Tabe, Silver Spring, MD (US)

(72) Inventor: Joseph Akwo Tabe, Silver Spring, MD (US)

(21) Appl. No.: 14/223,977

(22) Filed: Mar. 24, 2014

(51) Int. Cl. H04N 21/4788; H04N 21/414; H04N 21/442; H04N 21/258; H04L 12/58; H04N 21/61

(52) U.S. Cl. CPC H04N 21/4788; H04L 51/32; H04N 21/6131; H04N 21/44218; H04N 21/6125; H04N 21/25891; H04N 21/41407

(57) ABSTRACT

A system for facilitating interactive communications with humans on a social media environment where communities meet and share information to impact positive social measurements and generational awareness for improving community cultural and economic values. The system is configured for sharing knowledge for human observations, extracting database information and analyzing queried occurrences to identify stored patterns for communications, providing substance of things hoped for, revealing the evidence of things not commonly seen to embrace sustainable cultural independence using CA, mobile communications or for communications with a WCD configured for short range communication with a smart phone associated with users of a social network platform to receive, transmit, talk and listen to social communications. Social communications includes text messages, interactive television, voice commands, wearable communication, information showing/sharing, harvesting energy, receiving and transmitting data, monitoring physiological conditions of wearer of the DE, and communicating detections to programmed recipients.

### FIELD OF THE INVENTION

The present invention generally relates to a tool, comprising centralized social media platform “CSMP”, centralized SMC “CSMC”, network resource search engine server “NRSES”, support system “SS”, client site program “CSP”, communication environment “CE”, interactive multimedia MT “IMMT”, client interactive interface “CII”, communication apparatus “CA”, wearable communication device “WCD”, social network environment “SNE”, network environment “NE”, topics of information “TOT”, centralized network “CN”, electronic device “ED”, electronic media content “EMC”, social media community “SMC”, network resource “NR”, interactive multimedia communications “IMC”, sensor network “SN”, smart antennas “SA”, multiple antennas on chip “MAOC”, community cultural interest “CCI”, fashion social media “FSM”, mobile television “MT”, wearable device “WD”, fashion world media “FWM.”

The present invention generally relates to the tool further comprising a platform where various communities from around the world meet to share fashion TOI associated with celebrity, science, and engineering. The tool comprises at least a CA, a WCD, a SN, a smart antenna in NA comprising MAOC. Certain embodiments provide the tool comprising a platform to impact positive social measurements to improve CCI. Some embodiments provide the tool comprising an environment that defines fashion in the categories of expressions, love, arts, habits, styles, dress codes, models, and professions, because fashion is not limited to clothing choices Embodiments further provide the tool configured to associate fashion with celebrity media, fashion media, model media, dress code media via FSM and fashion SNE. More particularly, the present invention provides a CA configured for IMC that include MT and mobile photographic CE. Embodiments provide the social media comprising at least an ED, a DE operable for communications, for producing images, for editing images, and for receiving images and sounds of a video signal for social network distributions.

Embodiments further provide the social media and NE comprising platforms configured with software applications for enabling an act of engagement into photographic and video activity and having functions configured to edit, filter, and/or produce frames using an ED, including applications to enable transporting, transmitting, and/or posting the images into the social network platform for interactive television using an ED. The images and sound further comprises broadcast content being captured for reproduction and/or distribution. The ED is operatively configured with embedded camera for enabling image social security network and communications. The social security network comprises EMCs in association with database for photo and video files to enable social media environment for sharing within a SNE. More specifically, embodiments further comprise apparatus for associating a communication device to distribute media information within a network through a control server. The present invention is further related to the methods and apparatus for sensing objects, for taking photographic and video image. Embodiments further provide the social media and NE further configured for analyzing frames from the video data taken to determining the status of a network community and the network community occupancy image security prior to, during and/or after a community social event. Disclosed embodiment further comprises a SNE for transmitting data relating to social network objects to a network community from at least a remote environment.

The present invention further relates to methods and apparatus for detecting sections of a social network community and for transmitting data relating to the detection of occupants in the sections of the network community and further for providing other information relating to the social events conditions to the network community. Disclosed embodiments provide the social media and NE further comprises a CSMP for advancing science, SMC data and engineering knowledge. Embodiments further provide the social media platform in association with a SNE that includes social networking for one-to-one or one-to-many relationships with celebrities, scientists, engineers, beauticians, artists, hair stylists, EC, marketplace, models, and fashion outlets. A centralized platform for SMC networking, a platform to connect remote communities, SMC fleet navigation, government agencies, police department, fire department, Homeland security department, allowing these agencies and communities to network seamlessly in real time through the centralized system. Certain embodiments provide the social media and NE comprising an engine for extracting science and engineering topics and for effecting SMC sharing of social media TOI relating to fashion and positive thinking in centralized communication content. The content database further disposed with information relating to different art of fashion/model, product beta, apparels and electronic contents. Some embodiments provide the engine associated with a CA configured for enabling communications with different personal digital assistant (PDA) and responsive to different platforms. Other embodiments provide the ED further comprising an IMMT apparatus in communication with a CSMC data searchable engine operable for enabling Internet and web-based searches for TOI relating specifically to engineering topics and any fashion/model topics of SMC data equipment for identifying social media and social networking patterns of that particular equipment in which the topics were stored so that additional topics can be extracted from the database for social network, knowledge sharing, and to aid file sharing within various SMC. SMC further comprises companies and apparatus for mining communication data within the centralized communication content database.

Disclosed embodiments further provide the social media and NE comprising a CSMC data SS operable for categorizing files referenced by initial search results. The disclosure further provide the social media and NE in association with a neural network that integrates seamlessly with all existing social media communities, including industries, car rental companies and other remote communities in the nation and around the world through their local existing personal digital assistant (PDA) and enabling these personal digital assistant (PDA) to network and communicate better in real time interaction, real responsive, real resourceful and real responsible to SMC data system analysis, social media scheduling and reprogramming, and monitoring of a communication activities through at least a name search. The CSMC comprises a CA in communication with an IMMT configured with an interface module.

Disclosed embodiments further relates to management and sharing of science, engineering, SMC TOI through networks of computational devices, and more particularly to database system operable for generating request of engineering SMC data information, providing at least one topic of information as an example of information associated with at least a communication name in a local existing system desiring a rental car, engineering topics, SMC topics, and retrieving responses to the name, the engineering topics, and the SMC TOI such that enhancement of identification of relevant TOI is made accessible using such a network for repeating the searching and analyzing and extracting data for additional TOI that is desired. The desired TOI is further provided for tracking the last rental company and/or SMC data information by the named communication within the centralized system, including tracking celebrities, athletes, hiking, jogging, and other personal and community activities. Certain embodiments provide the CSMC consisting of standard SMC sharing celebrity, science and engineering Social Media Topics “NR.”

At least one aspect of the engineering social network is about public declaration, a social media consisting of a network that comprises of dynamic database driven platform that enables interactive web content creation, collaboration, and exchange. The network is a social platform for publicly declaring the will of positivism, associated with the gathering of human knowledge that are reliably organized for shared studies, dealings with the body of facts and truths governing a SS that acquires knowledge for human observations to explain the phenomena of social media in the environment of natural fashion media, model media, and dress code media “FMDC.” The FMDC network further comprises of a social platform for providing substance of things hoped for, revealing the evidence of things not commonly seen. This evidence of things not commonly seen is CHANGE, which can be embraced with the hope for sustainable cultural independence, for by CHANGE the society receives good reports that things which are seen were not spiritually made of things which do appear, but are made through creative minds and innovative discoveries that may lead to economic growth, not as a means of inquiry, but rather as a dimension of social sustainability to gracefully improve corporate and community wellbeing through social, cultural, environmental, and economic vision by the goodness of change.

The CSMC data comprises a search engine tool to facilitate locating the desired SMC TOI in a network such as the NR WEB-SITE. An end user usually would have to access the NR web site that will host the CSMC sharing SMC TOI, allowing the end user to submit one or more search queries relating to the desired information type. Generally, the International search engine is a communication program that when queried for SMC, routes TOI, communicates with a database to retrieve either related information or pointers to the location of related information, or both, by evaluating the server database. The implementation includes a marketplace associated with applications operable to provide marketplace functions and/or services to users of the social media and/or SNE that access the EC frontend and/or backend to provide and/or purchase fashionable products. Wherein at the EC frontend and backend, disclosed embodiments further provide the EC configured with at least a payment method each associated with payment applications for users of the media and NE to connect with payment services and functions. Certain embodiment provides the payment services further configured for the payment applications to allow users to deliver and/or purchase products for, and/or accumulate discounted values that are made available via hours/time of communication within the media and/or NE. Some embodiment provides the EC further comprises a marketplace being associated with applications. Other embodiment provides the marketplace and payment applications each manifesting a way and/or part of the media/network associated with the marketplace. Disclosed embodiment further provides the EC further configured with at least a frontend and/or backend each associated with at least a basic structure for providing distinctive content, form, color, texture, textile, glamour, trending, branding, awareness and/or composition as an alternative embodiment of the services and/or payment applications each comprising services and/or market payment service.

NR further provide information comprising Standard SMC data, having excellent data navigation architecture configured for communication with “A PERSONAL DIGITAL ASSISTANT (PDA)” all SMC environment with links to SMC data agencies, Police department, Homeland security department and the like. However, no such method ever existed that is centralized and opened for every SMC to provide file history of a particular engine instantly without having to go to the actual site or business operation of the company operating such engine to search for the hard copy files of that particular engine in question. Moreover, no such method ever existed that will enable drivers name search and critical data to a malfunctioned engine component without the insertion of a diagnostic tool. Disclosed embodiments further provide the social media and NE configured for enabling data communications with other advance component. The advance or malfunction component is queried precisely described in a system such as the Internet and a data is enabled through NR. Additionally, no such method ever existed that will schedule a social media inspection for any particular engine when such engine has attained a certain mileage indicative of a respective mileage or media consumption requirement to enable a scheduled navigation inspection. However, most if not all inventions arise from a combination of old elements in the art to address a particular need or unsolved problem. Disclosed embodiments provide the CSMC environment further operable to distribute science, engineering, SMC TOI through computing devices to provide celebrity, science, engineering, SMC services or functions. Embodiments provide the social media and NE further comprising an interactive multimedia user interface associated with a communication readable medium for managing a user interaction within a media management application environment. Disclosed embodiments is more particularly directed to science, engineering, SMC TOI through distributed server-based application model operable to connect individual application client devices for exchanging and sharing science, engineering, SMC topics data with one or more members of a varying set of server applications over a conventional communications infrastructure such as the web.

### BACKGROUND OF THE INVENTION

The innovation of social information age has revealed new and exciting opportunities for IMMT capabilities. Personal televisions have been deployed in a variety of arenas to gain image clarity and efficiencies, reduce cost, and increase productivity. Miniaturization and portability have made personal MTs more accessible and a more valued tool in many business environments. Personal MTs have also become a very useful tool in non-business environments, including educational institutions and network community. Embodiments provide a tool that comprises social media and NE comprising a CA that is not limited to MT, for communications with EDs that include a WCD configured for short range communication that allows users of a social network platform to receive, transmit, talk and listen to social communications. The communications further include text messages and voice commands. At least a voice command is enabled via the WCD to enable a mobile search for information about recipients of the social network platform and find locations, and be notified of incoming calls, texts, and events of other recipients when the CA is in proximity. The communication methods include wireless, wired, an LED light, vibration, text displays, texts, melodies, music, sound, alarm, and entertainment events.

Network community MT network in connection with a communication means are gaining increased popularity. Within a network community, multiple personal MTs can be connected together in the network community and/or used for office communication to permit a network community occupant to share image security data and other data without having to massively carry a camera from one remote environment to another. Embodiment provides the social network being associated with a MT network in connection with a communication means. The MT network is configured to enable the network community occupants to receive video/image data associated with video/image frames for sharing within the SNE. Internet access facility is provided to permit access to external networks and services. Thus, a network community occupant can operate an IMMT through his cell phone for communications with a control server to gain instant access to social network information source from anywhere in the world.

A significant challenge is being able to effectively control commercial and industrial communication destination. Embodiment provide the social media and NE further comprising a centralized management system in association with remote communication control devices that are trained to send signals to components of an entertainment center such as, a MT, stereo, and DVD, VCR, blue ray devices, communications, financial processing devices, a camera, and a video. There is no known central device that can communicate and control multiple personal MTs apparatus.

Improved IMMT capabilities and global access to detection of video file information has resulted in significant advancements in the information processing age, there exists a need for a simple, inexpensive, yet versatile system that can integrate the functions of IMMT into multiple image security and detection device for video data and connected to a video files or video frames to enable media database network being access-able from any remote location to enable sharing within a social network community.

Disclosed embodiments provide the social media and NE comprising advanced Internet platform configured for allowing IMC for users with ED, providing enhanced user interface environment comprising at least a form of media communications to remote communication network. The media communication can be in the form of science TOI, fashion engine, model engine, dress code engine, fashion social engine, centralized communications, engineering topics, SMC further comprising topics, audio music, music videos, television programs, sporting events or any other form of positive audio media and/or, positive video media that a user wishes to share, watch, or listen to.

Science and engineering education is a global endeavor and globalizing engineering education and standards would challenge the longstanding scientific preambles of the United States. Advances to globalize science and engineering are needed and would bring economic leadership to the nation. Establishing a centralized science/engineering social network for educational institutions and engineering professionals would present a social forum for knowledge of works to be shared and would expedite the rate at which students develop to phasing/solving real world problems. Knowledge on real world problems such as global warming and environmental emergencies would be easily shared by students and engineering professionals through a centralized science and engineering social network. Through the CN, engineering professionals would be able to identify the best, brightest, and most innovative science and engineering talents. These talents are needed for industrial advancements, but are not easily identified without the implementation of science and engineering social Network.

In reality, the network provides a socially sustainable community that have the capacity to deal with change and to adapt to changing situations and attributes that may be essential for globalization through fashion, model, and dress code “FMDC.” FMDC network is a network of change, providing a CE that has the capability of moving data between storage areas sufficiently scheduled for media communications for reasons of performance and convenience, establishing private CE for individuals and groups such as colleges, universities, churches, stores, organizations, cultural entities, businesses, corporations to explain the phenomena of social media in model media, fashion media, and dress code media, communicating to one another through a centralized system.

Disclosed embodiments provide a Standard SMC environment for sharing topics relating to celebrity, science, social network, engineering and/or Fashion Social network “NR.” Through NR, our nation would be ensured of standard education, economic development, and social/environmental security of the American homeland. The network would recapitalize America's strengths in homeland security. Investment in a centralized science and engineering social network would bring economic, security, science, and educational benefits to the nation. Major American businesses and industries would acquire the skills needed in today's global marketplace for scientist and engineers. NR would serve as a learning environment and also as means of exposure to widely diverse engineering students. These students would develop added engineering cultures, ideas, and science/engineering viewpoints through NR. Additionally, experienced technicians are hard to find because those with such knowledge are retired. As a result, NR would present continuous distribution of that knowledge around the world. Moreover, keeping track of foreign motor carriers crossing U.S. borders has always been difficult and NR services are what motor carriers would need in order to safely operate on U.S. soil. Certain embodiments provide the social media and NE comprising IMMT associated with a communication point for DOT, motor carriers, engineering students and engineering professionals, science students and scientist. Knowledge in science and engineering is crucial if United State industries and the nation itself are to maintain their competitive edge in science, engineering, and industrial developments. In the midst of two struggles such as international struggle against terrorism which is a global threat, and sustaining our national scientific and technological capacities, development in standard SMC data and engineering social network is crucial for information, communications, and for sharing other innovative approach to these struggles.

Disclosed embodiments provide the social media and NE comprising a CSMC for celebrity, science Engineering and Fashion Social Network “NR.” NR relates to providing a search engine for searching SMC TOI, providing SMC topics on advertisements, providing a knowledge base social network for university engineering students and engineering professionals, providing social media scheduling, responsive to files storage medium for SMC companies, and providing data to advance SMC components. In the disclosure, embodiments provide the social media and NE in association with a neural network operatively configured with at least a programmable architecture further configured with at least one dedicated processing elements. The IMMT further at least a software program configured with at least a memory device associated with values being accessible to said dedicated processing elements.

Certain embodiments provide a CSMC comprising a tool for associating social media sharing within social network community that includes celebrity media, fashion media, model media, dress code media and engineering topics. Embodiment provides a market place for networking within the social media environment and providing services that include fashion and engineering TOI that could not be found elsewhere. These services include bodies of SMC sharing social network knowledge sharing media environment consisting of contents that are stored in communication codes, and would be readily described when such information is queried. Additionally, experienced technicians are hard to find because those with such knowledge are retired. As a result, NR will serve as the continuous distributor of that knowledge around the world while also helping DOT keep track of foreign motor carriers crossing U.S. borders and the type of services that those motor carriers need in order to safely operate on U.S. soil. NR is an online SMC data search engine for searching SMC TOI, a social network for engineering students and engineering professionals, and system for national security. NR allows SMC of companies to control their cost while generating higher traffic to their website. NR also serves as the centralized communication point between foreign motor carriers and DOT. Automotive part stores advertisements are connected to consumers through NR to the web-sites of their choice of stores. Parts stores are connected to NR for advertisements and include a click to go system for selected parts for purchase. Advertisers on the network would be able to take advantage of their trademarks or bid on a word.

The objectives of disclosed embodiments is to advance science and engineering knowledge and knowledge of works through standard SMC data engineering social network that would deliver forefront computational and network capabilities for scientist and engineers to extend their frontiers of science. Developing new talent in science and engineering requires finding new ways to teach. The NR objective is to present a comprehensive effort to embrace at all levels the enduring change in science and engineering. Creating real change would require a compelling science and engineering network for diversity, and integrating the network into an organization's mission, strategy, operating structure, and culture is paramount. NR is the engine that would drive the organizational mission because complex problems can best be solved by cross functional teams and that people who work, live, and learn in integrated science and engineering settings develop stronger interpersonal communications and applied science skills NR would embody programs to educate students of different disciplines and reach new innovative aspects of science, engineering, and technologies.

NR further objective is to enable a chart functions where the leaders of educational institutions, celebrities, businesses and industries would connect and present the visibility of knowledge/crisis and refresh the public and students on the social compacts, and direct partnerships toward data for the crisis. These leaders would be able to engage national crisis and post a national strategy, addressing the crisis and the level of competitiveness needed to address the science and engineering aspect of the crisis. NR further objective is to enable a collaborative network forum, which is required to make sustainable change across the spectrum of education, science, engineering, technology, innovation, and crisis. The network would further enable United States to regain its technological edge. The contents of the network site would be defined and students would fulfill their current difficult tasks by connecting with science and engineering professionals.

Disclosed embodiments further provide the CSMC environment comprising a search engine system, includes an entity extractor, a categorizer, and a query generator for managing celebrity topics and for sharing science, engineering, SMC data. SMC data include celebrity media, fashion media, model media, dress code media, and other activities such that when a topic on science, engineering, SMC information is queried, responses are retrieved to enrich knowledge, SMC data, social media scheduling, generating data to queried SMC topics, providing corporate community data, extracting names of communication desiring a rental car, and analyzing advance SMC data component through a centralized database. The search engine system further comprises an IMMT associated to at least a hardware device. Some embodiments provide the hardware device being associated with at least one dedicated processing elements further configured with at least an input array, at least an output array, and/or at least a query array. Certain embodiments provide an entity extractor configured to identify a set of entities as described in celebrity and engineering. Science SMC TOI include selected files, forms, or document content for enabling searching the information related thereto using an information retrieval system. Disclosed embodiments further provide the categorizer operable to define an organized classification of the science, engineering, SMC files, forms, or document content with each class in the organization of component content having associated therewith a classification label. In the disclosure, the classification label corresponds to a category of topics of celebrities, science, and engineering, SMC topics information in the information retrieval system. The categorizer is configured to assign the selected science, engineering, SMC files, forms, or document content a classification label from the organized classification of celebrities, science, and engineering, SMC component content. Certain embodiments provide a query generator operatively configured to automatically formulate a query that restricts a search for celebrities, science, engineering, SMC TOI. The search could be restricted at the information retrieval system for the particular information concerning the set of entities to the category of celebrities, science, engineering, SMC TOI in the information retrieval system identified by the assigned classification label to enable speedy responses to information from the CSMC environment. The CSMC environment further comprises a CA comprising at least a database associated with at least information for celebrity media, science media, engineering media, model media, and dress code media as a SMC.

Disclosed embodiments further provide the CSMC associated with an interactive multimedia interface communicatively connected to at least the CA. The interactive device further associated with at least a data bus comprising a platform for writing input into at least a data memory for at least an array to enable enhancement of continued proliferation of powerful and suitable celebrity, science, engineering, SMC operation. Certain embodiments provide the interactive multimedia interface further configured for allowing interactive communications with computational devices to network through the use of networks connections. Computational devices include communications and other portable devices such as wireless telephones, mega telecommunication, personal digital assistants, and automobile-based communications, EDs, and portable devices. Such portable computational devices are pervasive devices. The networks connecting computational devices for the instant invention include wireless and wired networks which are formed using land lines such as copper wire or fiber optic cable, and wireless networks which employ earth and/or satellite-based wireless transmission links and a combination of wired and wireless network portions. These networks are organized using a client/server architecture in which server computational devices manage celebrity, science, engineering, SMC operational resources such as social media files, data to advance SMC sharing social network media consumption per engine in a NE or a computational SMC of network devices processing power which could be requested by client computational devices such as users of the network. That is, other computational devices not operated directly by an end user such as at least proxy servers, which act on behalf of other machines, could represent either clients or servers.

The IMMT is further configured for optimizing and for sharing celebrity, science, engineering, SMC TOI. Certain embodiments provide the IMMT further comprising at least a cache engine operatively configured with at least one array. The cache engine further comprises at least a markup language configured with at least one array for entering searchable celebrity, science, engineering, SMC TOI. Some embodiments provide the CA further comprising a spider, a crawler, each configured for disseminating celebrity, science, engineering, SMC TOI. Disclosed embodiments further provide a web configured for disseminating celebrity, science, SMC sharing social network engineering TOI. Certain embodiments provide the CSMC data associated with a search engine, further comprising structured celebrity, science, engineering, and SMC data for communications in the NE. The NE communicatively connected to at least one SS configured with at least an index and/or a catalog in association with celebrity, science, SMC topics and/or engineering data. Some embodiments provide the data further includes at least one of celebrity, events, locations, tracking, monitoring, parts purchasing, science and engineering assignments, science and engineering research environment, standard navigation data, social media scheduling, social media forms, media consumption log, mileage log, data to advance components, equipment sales, parts graphics, marketing, name search, sounds, text, video, engineering and/or science TOI, engineering materials and/or tools, and at least an advertisement.

The CSMC system that generates queries for end users by using an entity extractor, a categorizer, a query generator that includes short run aspect vector. The entity extractor is configured to identify set of entities in selected file content for searching information related to celebrity, science, engineering, SMC that enables network and media operations and navigation scheduling through the information retrieval system. The categorizer is further configured to establish an organized classification of individual company file content per equipment with each class in the organization of the content having associated classification labels that correspond to a category of information in the information retrieval system. The file content further contains equipment components per fashion/model topics relevant for retrieval of data to specific queries. The categorizer assigns the selected file content a classification label from the organized classification of content in relation to responding to the queried information in real time. The query generator gathers each query that restricts a search at the information retrieval system to the category of information in the information retrieval system identified by the assigned classification of the individual companies. The category of information further comprises query generator consisting of short length aspect vector generator operable to generate terms for refining the query using context information surrounding the set of entities in the selected file content so that files, including SMC files, forms, or documents are made searchable through the centralized social media network community. These files could be integrated seamlessly with all existing SMC such as industries, commercial SMC, companies, automotive fleet NR, and other remote communities in the nation and around the world communicating through their local existing system and enabling these system to network and communicate better in real time interaction, real responsive, real resourceful, and real responsible to celebrity, science, engineering, SMC topics, including community system analysis, social media scheduling and reprogramming, and enable centralized database interaction with these existing companies and communities through their local communications.

Embodiments provide the social media and NE comprising INTERNET communications in association with widely used network for centralizing celebrity, science, and engineering, SMC environment to connect end users to the celebrity, science, engineering, and SMC client's data to TOI. The INTERNET further provides a global network of computational devices which communicate using a set of protocols called TCP/IP “transmission control protocol/Internet protocol”. A particularly popular aspect of the Internet is the World Wide Web (WWW, or “web”), which is a collection of interlinked celebrity, science, engineering, SMC data files, forms, or documents formatted in hypertext markup language (HTML) to be used for separating celebrity, science, engineering, SMC TOI from other web-based information. These celebrity, science, engineering, SMC files, forms, or document s, or “web pages”, may incorporate text, graphics, audio, and/or video content, and may include suitable links to one another, often called “hyperlinks” or simply “links” Celebrity, science, engineering, SMC include files, forms, or document s or files are requested by client communications through an application program called a web browser configured with at least a software comprising at least one SS being responsive to structured directory of SMC topics, including engineering topics for providing communications to at least one celebrity, science, engineering SMC network infrastructure. Disclosed embodiments further provide the social media and NE comprising a SS responsive to global communications via Internet occurrences of celebrity, science, engineering, SMC TOI.

Certain embodiments provide NR in association with online SMC content for social media and search engine accessibility to enable searching celebrity, science, engineering, SMC TOI and communicating in a social network that further includes engineering students, scientists, photographers, hair stylist, makeup artist, designers, beauticians, engineering professionals, and a system for national security. Engineering professionals would be able to assist students on technical matters on their projects through similar functions. NR comprised of science and engineering social network and web-service application consisting of virtual celebrity, science, engineering, SMC that includes business analytical tool. The tool includes portfolio for celebrity, science, engineering, SMC to engage in social media programs and online market place for social media EC within a social network platform. Engineering professionals will utilize this network to assign research projects, assist on projects, and post jobs Skillful use of NR will bring in businesses equal to a million times the cost. Commercial motor carriers need the service of NR. NR website would be the virtual celebrity, science, engineering, SMC business, in association with analytical tool and portfolio for SMC social media programs, as well as online market place for SMC EC and research distribution. The web plan further includes search engine in association with CA, software, devices, CA, and browsers. The system would be configured with a SS for engineering social network, making it easier for people to meet for personal science and engineering benefit.

Disclosed embodiments further provide the SS further configured to recite on a personal digital assistant (PDA) communicatively connected to remote communication devices. The communication devices are operatively configured for communications with CA, which include Internet and gateway. The IMMT is communicatively connected to an interface comprising I/O network. Software comprises an operating system that is configured with the CA. The communication devices further comprises database in association with celebrity, science, engineering, SMC sharing social network TOI. The browser is communicatively connected to the operating system, which is communicatively connected to the network I/O which connects to the gateway. Certain embodiments provide a cache engine communicatively connected to the CA. Some embodiments provide the cache engine comprising a query and a makeup language for searching science and engineering TOI. The query further comprises apparatus for entering celebrity, science, engineering, SMC TOI. A spider and a crawler are further provided for disseminating SMC TOI. The SS is configured for social network and further comprises structured functions, including chat functions. The communication device further comprises a server tool configured with the software for enabling a server tool to communicate with other EDs through the Internet. Certain embodiments provide the social media and NE configured with an application tool for permitting a user to access the database. Some embodiments provide a model layer for enabling network communications, and a presentation layer for coding data.

The files are requested from server communications, or “web servers”. The transmission of the files over the web uses an additional Internet protocol called hypertext transfer protocol (HTTP). A significant feature of the Internet is that it is substantially free of central organization. A server hosting web page for the CSMC comprises a system connected to the Internet to facilitate social media communications and social networking for community TOI are routed by the centralized search engine to the server operable for retrieval of the information specific to the queried TOI within a server database.

The IMMT is further configured with an entry filtration of video and image contents for retrieval of information from the database. The entry further includes a network address of the end user page consisting of one or more keywords associated with the page content. The network address may further include a brief summary of the topic of information to be searched. The NR search engine is used to describe any such database system to distinguish itself from directory. NR routes all SMC TOI from the internet to the database server, collecting celebrity, science, engineering, SMC TOI automatically using programs such as spiders, robots and/or crawlers. The robots, spiders, and/or crawlers are configured to visit the CSMC web page and collect the needed data by downloading files in relation to the queried TOI and also process the file. Prior art devices such as AltaVista, Google, Yahoo, and Excite are not toned for routing celebrity, science, engineering, SMC TOI. Prior art devices also have no way of directing or enabling scheduling of social media based on engine mileage or media consumption. In addition, a directory may be used with the NR International search engine to describe the end user or a database for which entry information is submitted.

The CSMC is a process-driven celebrity, science, engineering, SMC data management system for managing data relating to science codes, engineering code, SMC codes accessible by processors or modules. The celebrity, science, engineering, SMC further comprises management system that includes a server repository platform that stores science information, engineering information, and engine information, wherein one of the information is referred to as planes having components each describing a respective science codes, engineering codes, and mechanical community data codes.

Disclosed embodiments provide NR in communication with data contents relating to celebrity, science, engineering, SMC network topics, including putting SMC technologies together by directing end users to SMC TOI through the CSMC environment. In the disclosure, embodiments further provide the social media and NE comprising an easier means for employees of industries to share files and data resources through a centralized celebrity, science, engineering, SMC network system. The shared network will enable communication with every SMC sharing social network industries, garage, and all commercial SMC sharing social network companies, engineering companies, and science companies seamlessly through a resourceful time sharing via shared Internet access. The CSMC enables science and engineering searches and further includes server-based network to enable reliability of data to local and distance SMC members. The server network is operable to connect members through a local SNE to include TOI resourceful to their network program, providing step by step social network procedures.

The Web context is configured based on queries, such that, when a user submits a query containing celebrity, science, engineering, SMC TOI, NR search engine would respond with a list of links pointing to information resource for the NR web page hosting derived from matching entries on celebrity, science, engineering, SMC TOI in the search engine's database. Disclosed embodiments provide the term “link” comprising any representation or symbol representing at least an address that points to the location of an information resource, such as a web page. Typically, a link on a Web is a pointer found in one file which references another file. The link on the Web commonly refers to a Uniform Resource Locator (URL), the global address for science engineering, SMC files, forms, or documents and other resources commonly accessible on the Web. The centralized celebrity, science, engineering, SMC network system uses direct attached storage to the server hard drive configured with a network attached storage to consolidate files stored. The server software periodically dumps files into a backup server for future corporate use.

Disclosed embodiments further provide the social media and NE comprising a centralized celebrity, science, engineering, SMC network system configured with server adaptors to maximize productivity and end user longevity. Certain embodiments provide the server adaptor configured to allow end users to end users communication through NR search engine. Thus, the entire network system will periodically need navigation and the URL may be modified at random times by their web masters. When a webmaster changes the content of a web page, including adding or removing content or deleting the page altogether, NR search engine database would not immediately reflect these changes. A typical search will produce a single link that either point to NR web site or its modified web site. Accordingly, when a user clicks on the URL and an error results comes on, if the user is unable to access the envisioned content, NR search engine would strive to keep track of the Web by continuously finding, indexing, and cataloging web pages. Some embodiments provide a server adaptor software configured to automatically re-route traffic signals when any of the server port experiences a community data or is disconnected. Files are always monitored and allow access to multiple server files containing client data to enable prevention of any loss of information when the hardware experiences a community data.

Disclosed embodiments further provide the social media and NE configured with multiple file storage system being centralized for distribution and for enabling maximum protection. Certain embodiments provide the centralized celebrity, science, engineering, SMC network system further configured with a switch to connect client system and servers together to create a client server network within the system and a social environment for communications. Some embodiments further provide the social media and NE configured with backup storage software being operable for providing backup file scheduling such as tape backup and server file storage backup in weekly, daily, or monthly intervals. The backup storage allows the centralized celebrity, science, engineering, SMC system access to remotely recover any lost file. Other embodiments provide the social media and NE further comprising a process for network system operations to eliminate single point community data by advancing an application/technology to keep single components on hand for emergency use. Embodiments further provide the social media and NE configured for indexing comprising storing links pointing to information resources including some or all of the data associated with the information resource.

The celebrity, science, engineering, SMC further comprises a management system that includes sets of tools for performing innovative renovation of celebrity, science, engineering, SMC component and analytical breakdown of possible data for topics information. Disclosed embodiments further provide the social media and NE comprising topics data content relating to celebrity, science, engineering, and transformation social network system in association with a process-based interface to celebrity, science, engineering, SMC TOI with end users and a social platform for advancing science, entertainment, and engineering knowledge. Certain embodiments provide the interface further configured with a SS being operable for mapping desired communications using Protocols, Processes, and Plans. Protocols are the constructs that each stores a script for invoking a respective scripted tool to execute a particular function. Some embodiments provide Protocols comprising a software module being operable as input parameters for retrieving relevant celebrity, science, engineering, SMC information or for generating an output parameter of the function invocation specified as variables being supplied at execution time. In other disclosure, embodiments provide NR search engines in communication with communication applications called spiders or robots for indexing the different elements of web sites on the Internet and for gathering content information for NR search engine database. Essentially, NR search engine robot is configured to index significant number of information resources in the Internet. The robot is further configured for updating links in NR search engine database in a queried dependency manner so that celebrity, science, engineering, SMC TOI are better shared to:

1. Improve knowledge and productivity

2. Improve homeland security and data mining

3. Improve environmental safety

4. Cut navigation cost

5. Gain navigation and social networking flexibility

6. Share resources to gain optimal output in minimal time

7. Increase collaboration through file sharing

8. Improve corporate data security

9. Detect intrusion through multiple firewall configuration

10. Enable corporate privacy control and prevents confidential information

11. Enable anti-spam filtration of unwanted queries

12. Utilize bus to offer point to point lanes to the database

13. Deliver peak performance to meet demands for industrial multitasking

14. Enables continuous background virus check and scanning at firewall

15. Enable multimedia application with intensified multitasking between industries

16. Connecting more employees with maximum performance through a social environment

17. CENTRALIZED ENGINEERING SOCIAL NETWORK

18. Increase collaborative interactive mobile televised media.

The cycle time for NR search engine robots is the time between sampling the same web site and incorporating any changes into NR search engine database. The sampling requires a significant period of time—as long as several months. Moreover, if a particular site is not accessible when a robot comes around to examine it, the robot will not index the web pages on that web site until some future time. In the worst case scenario, the URL pointing to the web site (including any URLs to any of its web pages) could be excluded from the NR search engine database entirely. As more web sites come online, the amount of time for NR search engine robot operation to cover the entire Internet would continue to increase, requiring additional computing resources.

Embodiments provide the social media and NE further configured for time-delay between indexing and re-indexing any one content resource, e.g., a web page. Certain embodiments provide the indexing and re-indexing comprises information stored in the NR search engine database that is stale, e.g., outdated or not “fresh” URLs. In the disclosed embodiments, over a given time period an equal amount of computing resources are dedicated to refreshing each link stored in the NR search engine database. However, given the large number of dynamically changing Internet resources to monitor, and only limited resources (bandwidth and storage) available to do the monitoring, there is a need in the relevant technology for a system and a method of deciding which resources should be updated first and when.

An illustration of a client-server network containing NRSES is shown throughout the drawings. In the disclosure, the network connects various computational devices, such as NRSES, clients, including celebrity, science, engineering, and information content servers. Although these computational devices are shown outside of the oval representing the network system, for clarity, these devices are actually a part of the network as well. In the embodiment, the network system is the World Wide Web, and may include millions of web involving celebrity, science, engineering, SMC data content servers being located anywhere in the world. Each celebrity, science, engineering, SMC is associated to at least a content server that may store, or “host”, one or more web sites. Each web site includes one or more web pages, as described above. Disclosed embodiments further provide celebrity, science, engineering, SMC communicatively connected to NRSES, clients, and social media network content servers hosting the web sites to a network system. Certain embodiments provide the network system further comprises other transmission media/medium and computational devices being wired or wirelessly interconnected to the centralized celebrity, science, engineering, SMC CE within a network.

In a typical searching sequence, communication is established over the network between at least a client and NRSES. Some embodiments provide the CE further comprising a web browser program on the client machine. Other embodiments provide the search criteria being entered by a user of the client machine, and being transmitted to the NRSES. NRSES being operable for searching the information available on the network, including celebrity, science, engineering, SMC TOI. The TOI are made searchable on the information content servers containing celebrity, science, engineering, SMC files, forms, or documents relevant to the search criteria. The search includes searching the database stored on NRSES. The database further includes previously-formed entries corresponding to web pages accessible over the NE. The results of the search are transmitted back to the requesting client. The client may, for example, access particular web pages that are included in the results directly over NE as desired by the user.

The large and constantly expanding size of the Internet and World Wide Web presents difficult challenges for using search engines in the above-described process. For example, most engines are at this time, unable to index (create database entries for) the entirety of celebrity, science, engineering, SMC data files, forms, or documents that are available on the Internet, or even a substantial fraction of these celebrity, science, engineering, SMC data files, forms, or documents. The storage space and computational time constraints which limit the ability of the engines to index celebrity, science, engineering, SMC files, forms, or documents may also limit the complexity of the database entries for celebrity, science, engineering, SMC files, forms, or documents which are indexed, such that only a rough categorization and/or analysis of search results may be performed. This may create various problems for a user without NR search engines. The problems most prior art engines are facing include excessive numbers of “hits”, or celebrity, science, engineering, SMC data files, forms, or documents matching the search queries being returned by these engines.

With prior art devices, the celebrity, science, engineering, SMC data files, forms, or documents are returned in response to a search query which may incorrectly be matched to the subject of the query, and incorrectly or insufficiently be categorized, and if categorized at all, it may not be in a way apparent to the end user. In some cases of NR, for example, priority of search results returned may be influenced by factors such as advertisements on web sites. Resource limitations on the NRSES often prevent the use of algorithms which might improve the accuracy and categorization of search results. The algorithms for categorization and searching through NR are often very good, particularly utilizing techniques from the field of artificial intelligence. The fundamental problem advantage is believed to be the resource restrictions on NR search engines. Hence NR search engines often use quick algorithms for categorization and searching. Typically this involves examining only a few keywords or hyperlinks in a Web page and rapidly returning the results. Incremental classification is often done in a semi-automated or manual fashion. It would therefore be desirable to develop a system and method to improve the accuracy of network search results without increasing resource requirements for NRSES. The desired method would allow improvement of results of both a current search and future searches involving celebrity, science, engineering, SMC TOI.

Disclosed embodiments provide the social media and NE comprises processes in association with constructs that store celebrity, science, engineering, SMC file definitions comprising descriptions to perform a particular tasks to be performed. The task to be performed is described using one or more protocols and/or one or more other processes. By this definition, a process is a grouping of protocols and other processes, wherein the functions described by the protocols and processes perform desired tasks. Certain embodiments provide the processes comprising logical statements written in any scripting language operable to further perform error and recovery operations for the CSMC of networks. Some embodiments provide like protocols and processes comprising written generic format that identifies a type of software module that can be the target of the task of the relationship between the CSMC and at least the end users, but does not identify a specific software module or modules on which the task is to be performed from local communications. Other embodiments provide the end users further comprises servers.

In the disclosure, processes can be used to develop Plans for industrial standard celebrity, science, engineering, SMC of excellence, including maintaining a data to direct and supply information unique to SMC topics. Disclosed embodiments further provide NR comprising celebrity, science, engineering, SMC environment configured for web based network facility. Certain embodiments provide NR further comprises a Plan with developed script that may be executed by a script engine for the CSMC to complete the task described by a connected process. The web based facility is configured to enable on-line services to science environment, engineering environment, SMC environment by handling social media programs on the web based facility. The web-based facility further provides prescribed data to advance SMC equipment format. Plans may also be created by users having a minimal amount of system knowledge by utilizing the contained software for the web based facility to generate SMC topics or programs and forms, and to provide data to SMC without any physical connection to the social media engine. This is accomplished by an automated Plan development tool that polls the user to select a Process to be developed into the Plan.

Disclosed embodiments further provide the polling being achieved by using natural language expressions stored within the Processes themselves and comprises interface switching module being connected to the server database or warehouse. Certain embodiments further provide the Processes being operable for designating range of assigned characters in text and binary comparison with coded characters in the database in response to queried input. Some embodiments further provide the input comprising initial communication for enabling celebrity, science, engineering, SMC communication within a NE and online communications, providing data to queried information. In addition, the user may be polled to the software modules that are operated on and/or created by a selected Process. This is accomplished using the Process information indicating the allowable types of software modules that may be associated with the Process to enable a web based server and a communication to be coupled and further enable interface switching for connecting an input signal from an end user to a network computing terminal based on at least a condition. In this manner, a user can initiate the execution of complex operations without understanding the complexities of, or the interrelationships between, tools and tool interfaces. Furthermore, the condition being in accordance with user security number, wherein the security number is stored such that the CSMC data network terminals, in accordance with other selected conditions, would enable entry capable of accessing contents within the database on selected user security corresponding to the conditions, and wherein the user may need no understand of the interdependencies existing between the software modules that are to be the target of the initiated operation. Plans further include a designation of the software modules that are to be used as input and output parameters of the various task. A Plan may be provided to a script engine for the CSMC for execution either immediately after the plan is created from a process, or on a scheduled basis through a controlled means. The control means further comprises GPS operable for relocating celebrity, science, engineering, SMC assignment and maintaining a directional defined task in exchange for at least a data to the assignment destination.

In the preferred embodiment, the Protocols, Processes, and Plans are each stored as engine/engine in the celebrity, science, engineering, SMC data management system repository for updating connectivity to the database, for updating the range of the assignments when a connection is disabled or enabled, and for processing signal connectivity to updating execution of prescribed functions corresponding to updating functions in response to the operational set mode signals for generating matching data to defined science topics, engineering topics, SMC data advance components. The engine further comprises a platform for celebrities, science, and engineering. Certain embodiments provide a CSMC comprising a system components stored in a manner that is similar to the way in which the Asset components describing the software modules are stored. Furthermore, the associations between Protocols, Processes, and Plans are stored as relationships between the respective CSMC and operable in a manner that is similar to the way relationships between the software modules are represented celebrity, science, engineering SMC topics.

Disclosed embodiments further provide the Protocols, Processes, and Plans for the CSMC comprising an engine operable within celebrity, science, engineering, SMC management system. In the exemplary embodiments of the SMC data disclosure, first, a step by step directory to finding media environments is enabled and providing data for social networking in the media environment is further enabled through a web based online analytical rundown of the SMC data community data. At least the system is configured for providing industrial quo data to enabling vehicular preventive navigation. Next, the system is further configured for ensuring industrial SMC data system that operates by means of online distribution of SMC data and providing community data. The system is further configured for supplying thorough SMC system of network distribution. The distribution further comprises distributing at least a routine procedure online. The transporting safety procedure includes equipment such as transport planes, engines, and marine equipment, executing standard social media inspection and enabling at least data to advance components. NR provides centralized system for university science and engineering students and professional engineers to socialize through a SS comprises a CN further comprising a neural network operatively configured with a programmable architecture configured with one dedicated processing elements.

Disclosed embodiments further provide CSMC data in association with interactive multimedia television associated with a search engine consisting of a media environment for celebrity, science, engineering, and social media TOI. Certain embodiments provide the social media and NE comprising tools operable within a network system to create, update, and manage the search engine. Some embodiments provide the social media and NE in association with asset components used to perform similar functions on the science and engineering NE SMC system NE, providing components community data analysis. The tools are configured responsive to science and engineering topics/problems and for assembling data and enabling social media programs from at least the media consumption data collected from each engine. The relationships existing between the various Network System Components “NSC” allow an end user or an automated development tool to readily discover the interdependencies existing between the constructs, expediting communications to the database warehouse for describing plurality languages to files containing compiled component community data and data to fixed SMC data navigation program, invoking master database and variable PDL file descriptions in conjunction with queried text for online navigation procedures. Online navigation procedure imposes activation of the master database and variable PDL file context, enabling online SMC data to be distributed through web based routing of SMC TOI. Other embodiments provide the social media and NE further comprising impact analysis of celebrity, science, engineering, SMC TOI, including community data analysis after a modification is made to a structure engineering component or one of the SMC system components. Additionally, the repository interface includes automated functions that can be invoked by both the automated Plan development tool and the script engine for the CSMC data engine to simplify Plan development and the execution celebrity, science, engineering, SMC TOI.

Disclosed embodiment provide CSMC environment comprising the Internet and/or the World Wide Web configured for vast repository of information that is extremely distributed internationally and locally by means of identifying celebrity, science, engineering, SMC TOI. The TOI further include the location and manner in which the information was produced. Embodiments further provide celebrity, science, engineering, SMC TOI that are extracted from the Web by the end users through communications with the CSMC environment. The CSMC data engine enables individual users to traverse or surf the Web to locate the data for celebrity, science, engineering, SMC TOI of interest. The CSMC data engine is further configured to manually extract celebrity, science, engineering SMC data information unique to the topic being queried. The CSMC data engine is configured for routing celebrity, science, engineering, SMC TOI and provides an innovative technique for extracting these TOI from a centralized database by extracting relevant information automatically with minimal human intervention.

In another preferred embodiment, the definition of the CSMC data engine further comprises a centrally driven engine for routing celebrity, science, engineering, SMC TOI to end users, providing a CN system for science and engineering schools-universities-professional environment, SMC data industries. Each of the engines for the CSMC data engine comprises a system Components, as well as the relationships that may exist between the components, being created using a pre-defined element type of the topics information or relationship type definition that is also stored within the repository. Embodiments provide the social media and NE further comprising a communication implemented system for extracting and sharing celebrity, science, engineering, SMC TOI from a database. The database is made searchable for occurrences of at least one topic of information. An occurrence of a topic of information that was found is analyzed to identify a pattern in which the topic of information was stored. Additional TOI are extracted from the database utilizing the pattern. In some embodiments, the process is repeated until a predetermined number of topics are found or until no new patterns are identified.

The model definition simplifies the system design and makes operation more robust because the various tools in the system is configured to be synchronized with the element and relationship type definitions instead of having to be aware of special-case and particularized element descriptions. Additionally, modifications to the components can be more readily accomplished because a whole class of element definitions can be modified by making a single change to an element type definition. The type definitions further allows the automated Plan development tool to efficiently query the user for process and other Asset element selections. At least one relationship comprises network implementation. The implementation includes a marketplace in association with applications operable to provide marketplace functions and/or services to users of the social media and/or SNE that access the EC frontend and/or backend to provide and/or purchase fashionable products. Wherein at the EC frontend and backend, disclosed embodiment provides the social media and NE comprising a tool configured with an EC environment associated with at least a payment method each comprising payment applications for users of the media and NE to connect with payment services and functions. Certain embodiment provides the payment services further configured for the payment applications to allow users to deliver and/or purchase products for, and/or accumulate discounted values that are made available via hours/time of communication within the media and/or NE. Some embodiment provides the EC further comprises a marketplace being associated with applications. Other embodiment provides the marketplace and payment applications each manifesting a way and/or part of the media/network being associated with the marketplace. Disclosed embodiment further provides the EC frontend and/or backend comprising at least a basic structure for providing distinctive content, form, color, texture, textile, glamour, trending, branding, awareness and/or composition as an alternative embodiment of the services and/or payment applications each comprising services and/or market payment service.

Embodiments involve the recordation of Plan execution status. Plan Execution Record constructs are created after the execution of any Plan. These constructs are stored as Celebrity, science, Engineering, SMC data System components for recording information and status about Plan execution that are useful in celebrity, science, engineering, SMC data files, forms, or documents. Plan Execution Record Constructs comprise software development process for standard celebrity, science, engineering, SMC data that executes excellent navigation data.

The CSMC data engine would become readily apparent to those skilled in the art from the following detailed description of the preferred embodiments and the drawings are shown simply by way of exemplary illustration of the best mode contemplated for carrying out the invention. As will be realized, the invention is capable of other and different embodiments, and its several details are capable of modifications in various respects, all without departing from the scope of the invention.

### SUMMARY OF THE INVENTION

The present invention provides a tool associated with methods, systems for programmable IMMT, including products for market place environment, image security monitoring and for managing a plurality of devices, destination and/or applications within an environment, such as a network community, business, school, etc., as well as the surrounding areas. The interactive MT further comprises an act of engagement into photographic and video activity and being able to edit, filter, and/or produce frames using an ED, including the ability to transport, transmit, and/or post the images into a social network platform using the ED. A control server is associated with social network platform for storing the images for mass communication. The server further comprises one or more servers or processing systems, and enables centralized communications, command and control of the devices, destination and/or applications. Embodiment provides the interactive MT in association with a processor, a video display controlled by the processor, and a network interface in communication with the processor for receiving Internet video from the server over the Internet.

A user interface device is configured for communications with the processor for transmitting and for receiving video/image selection signals to enable at least a media video module “MVM.” Certain embodiment provides the processor further configured to execute a “MVM” to create an interactive MT “IMT” in association with story content for Internet video. The story contents may comprise frames in the video in communication with the processor for video content display. The MVM in further association with a decoder cooperatively configured for streaming the video content from various locations of the server for display over the Internet. Some embodiments provide the decoder being further configured to decode frames from Internet video to enable video broadcasting clarity. Disclosed embodiment provides interactive MT “IMT” in association with at least a control device in association with a frame selector.

Certain embodiments provide the social media and NE in association with a frame selector operable on at least video/image database for selecting subsets of frames for presentation to the social media to enable social network display of the frames as a social network objects.

In one embodiments of the present invention, the devices, destination means and/or applications include Internet, mobile applications, mobile entertainment and other communication equipment such as, mobile handheld devices, telephones, intercoms, etc. The present invention further includes entertainment systems such as, MTs, DVD, SIM CARD, CD/DVD distributors, communications, electronic applications, stereos, etc. The devices and entertainment system are coupled to a monitoring system such as, communications, image security cameras, and baby monitor with/without cameras, etc. to enable image security system. The image security systems further include devices such as, GPS, GSM, nano sensors, nano-applications, micro fibers, nano-fibers, embedded sensors, and personal communication such as, servers, desktops, notebooks, notepads, personal digital assistants, cell phones, tablets, wireless devices or the like.

In other embodiments of the present invention, the control server distributes information including video, audio, voice, text, graphics, control messages, detection data etc. to coded addresses and/or other applications. The control server supports video/audio serving, telephony, messaging, file sharing, internetworking, and/or image security monitoring.

Yet in other embodiments of the present invention, a detection platform that is small in physical size, has access to power lines for continuous and uninterrupted electrical power, and is physically located within the body of a MT to facilitate transmission and reception of wireless signals is suitable for housing or hosting the interactive hardware in association with the control server. In an instant embodiment, a smoke detector may constitute a router that serves as a detection platform for the control server. The smoke detector is ceiling-wall or side wall mountable to direct connections to a network community. Offices existing voltage AC power line further provide an ideal platform for the control server to enable information to be transported throughout the controlled environment either through a wireless connection or through the power line. The control server can be housed within a wired/wireless access point, which provides the control server with “always-on” and wired/wireless connectivity.

Still in other embodiments of the present invention, a wireless controller such as a digital personal assistant, cell phone, wireless notepad, etc. enable a network community occupant to interact with the control server. Such interaction includes altering the configuration and performance of the other devices, destination and/or applications. Accordingly, the wireless controller provides remote access to other devices, destination and/or applications, and enables the network community occupant to control other functions and/or operations from any location within the environment. In one embodiment, the control server is located within the wireless controller. In another embodiment, the control server is located at a centralized location that is distinct from the wireless controller.

In other embodiments of the present invention, the wireless controllers are equipped with location-awareness and/or network community occupant-awareness functionality. As such, the control server in communication with a MT has the ability to track and/or monitor the position of the wireless controllers and enable personalized configurations and data transmission based on the network community occupant identity.

In yet another embodiment, one or more control microprocessor for enabling communication can be established, either automatically by the control server and the network community occupant, to control the operations, detections, and/or functions of the IMMT system components. A control microprocessor includes a set of commands that, when executed, enables the control server to manage multiple operations and/or functions of one or more of the MT system and other components. The control microprocessor can be associated with a control microprocessor detection data for future recall and execution. The control microprocessors are stored at the control server. In an embodiment, the wireless controller is programmable to issue a generic control request to the control server to thereby execute the sequence of commands from the control microprocessor.

It is still an object of the present invention to provide a new and improved method and system for obtaining information about object's DNA, the image security, and occupancy state of a network community and conveying this information to remotely situated assistance personnel.

It is another object of the present invention to provide a new and improved method and system for obtaining information about objects, the image security, and occupancy state of a network community and conveying this information to remotely situated assistance personnel or assistance hand held/communication devices such as a cell phone to optimize responses to at least an instance of an emergency, including at least a social communications involving the network community and/or enable proper assistance to be rendered to the network community occupants after the social communications has occurred.

It is another object of the present invention to provide a new and improved method and system for determining the presence of an object on a particular location of a common network community and conveying this information over a wired/wireless data link system or cellular phone.

It is another object of the present invention to provide a new and improved method and system for determining the presence of an object on a particular section of a common network community and using this information to activate the operation of interactive wireless network community to provide image security detections and enabling communication with at least a data link system or a wired/wireless network and/or other EDs and smart phones.

It is still another object of the present invention to provide a new and improved method and system for determining the presence of an object and the total number of occupants in various sections of a network community, and, in the event of an emergency-condition, transmitting that information, as well as other information such as DNA or the condition of the occupancy to a receiver site remote from the network community.

It is yet another object of the present invention to provide a new and improved network occupant sensory system and/or a detection platform which determines the social state of any occupants in the network community.

Still another object of the present invention is to provide a new and improved network community monitoring system which provides a communication channel between the network community “Central communication device” and a manned assistance facility to enable communication with the central communication device and the network community occupancy during an event. Wherein a manned assistance facility “MAF” is defined as any hand held communication device “HHCD.”

It is still another object of the present invention to provide a new and improved method and apparatus for obtaining information about a network community within a system and sections in the network community in conjunction with information to the remote facility.

Accordingly, to achieve at least one of these objects, a network community comprises a network occupancy within system for determining at least one characteristic of the occupancy state of the network community constituting information about the occupancy of the network community and enabling communication devices coupled to the occupancy state arranged to transmit information about the occupancy state of the network community. The communication devices may comprise a hidden interactive reporter, a cellular telephone system including an antenna or other similar communication-enabling devices.

The occupant sensing system may include plurality of the same or different sensors; for example, an image-obtaining sensor for obtaining images of the various sections of the network community whereby the communication devices transmits the images. A social communications sensor is provided for determining when the network community experiences social communications, the image-obtaining sensor may be assigned to obtain images including the intruder of the network community. At least one network occupancy sensor further comprises a GPS. Whereby the communication devices being coupled to the social communications sensor and arranged to transmit images of the various sections and locations just prior to the social communications once the social communications sensor has determined that the network community has experienced a social communications, during the social communications once the social communications sensor has determined that the network community has experienced a social communications and/or after the social communications once the social communications sensor has determined that the network community has experienced a social communications.

Embodiments further provide an entertainment platform; an infotainment platform; configured with at least a user interface associated with a communication readable medium further operable within a media management application environment. Embodiments provide the user interface further comprising a plurality of celebrity, science, and engineering topics for displaying at least one TOI in a list of one or more media file sources. Certain embodiments provide at least a list of user selectable media file identifiers from a group consisting of science TOI, wherein selected information is associated with a listed media file identifiers for identifying fashion topics, model topics, and dress code topics. At least one identifier further comprises instructional TOI as to how a user can cause one of the science topics to display selected topic information associated with the listed media file identifiers. Some embodiments provide at least one of: a gaming platform; an entertainment platform; an infotainment platform; a media player platform; a control interface platform; a commence platform; an electronic commence platform; an advertisement platform; a fashion platform; a model platform; a dress code platform; an educational platform; and a learning platform. Other embodiments provide at least one aspect of the user interface comprising displaying an instant messaging through at least one platform as a media file source. In one disclosure, the media file source may comprise messaging platform for users. Embodiments further provide the social media and NE comprising an entertainment platform; an infotainment platform; a messaging platform environment for user communicate with one another. Certain embodiments provide the social media and NE comprising at least one selection platform in association with means for messaging user to cause at least one science topics to be displayed as information associated with media files found in a media platform

Fighting terrorism is a value that is more important to the world than how the world perceive privacy right. The most important problem facing the world today is not privacy right, but rather, the constant involvement of communication activities in non-combat environment. The CSMC data engine is a communication engine comprising an engine for re-enforcing communication monitoring in a SMC crime enforcement network both locally, nationally, and around the world. Disclosed embodiments provide CSMC data engine in communication with communication devices operable to provide specific celebrity, science, engineering, SMC services or functions. Certain embodiments are directed towards a distributed server-based application model comprising varying set of server application where individual application client devices connect to and exchange celebrity, science, engineering, SMC data with one or more members of the group over a conventional communications infrastructure such as the web.

Some embodiments provide a SMC environment comprises human knowledge in association with organized bodies of knowledge that are shared by people so as to produce useful feeds that comprise of reliable knowledge about at least an FMDC TOI to aid and educate the society through the environment of social enterprise. Social enterprise consist of social measurements relating to the way society operates through a systematic examination of truth, existence, reality, causality, exhibiting the freedom of shared knowledge relating to at least one FMDC TOI. Social measurements comprise of asserting the influence of FMDC for the betterment of the society by contributing to product offerings through a blend spirit of positivism and methodological evolution of information backed by the organizing principles underlying the science of Fashion, Models, and Dress Code.

The methodological evolution of FMDC information is geared towards societal change that comes with time, and time blends with technologies and innovations. That is why FMDC sharing is embodied to change the way knowledge is derived about an object, a business, a corporation, an institution, an educational institution, a testimony, a Pastor, an art, an event, a project, a play, a book, a culture, a Bishop, a struggle, a success, the society and its environment. Social measurements further leads to generational awareness, brand awareness, leadership awareness, business awareness, corporate awareness, educational awareness, professional awareness, ethical awareness, religious awareness, institutional awareness, social awareness, cultural awareness, sociological awareness, professional awareness, causal awareness, and service efficiency to the society relating to the positivism in fashion media, model media, and dress code media. Individuals, businesses, corporations, religious groups, cultural groups, and community organizations/associations must have the freedom to choose how to improve their product life in the context of fashion media, model media, and dress code media for their product line. Just as true prophecy never come by the will of man, but from God through the Holy Spirit to bring Lamb upon our feet and Light upon our paths, so must the positivism of good products/objects be lightened to bring out the truth by modeling the products/objects to create a clear path for knowledge and economic growth.

The present invention further relates to a CSMC data engine for providing science and engineering knowledge. The CSMC environment further comprises a search engine for SMC networking, remote communities, SMC data navigation fleet, government agencies, police department, fire department, and homeland security agencies, allowing these agencies and companies to network seamlessly through a centralized system. The system is configured for extracting celebrity, science, engineering, SMC TOI from a centralized communication content database having information relating to science and engineering and to different fashion/model relating to of engines. Embodiments further relates to management and sharing of celebrity, science, engineering, SMC TOI through networks of computational devices, and more particularly for generating request for connections to celebrity, science, engineering, SMC topics information and retrieving responses to the TOI such that enhancement of, and identification of relevant celebrity, science, engineering, SMC TOI is made accessible using such a network system.

The network system is configured to integrate seamlessly with all existing schools, universities, science and engineering professional establishments, SMC networking, including car rental companies and other remote communities in the nation and around the world through their local existing system. The network system is further configured for enabling these system to network and communicate better in real time interaction, real responsive, real resourceful and real responsible to science topics, engineering topics, SMC data system analysis, social media scheduling and reprogramming, and monitoring of a communication activities in a centralized communication content database through at least a name search. Detected data referencing at least a communication desiring at least celebrity, science, engineering, SMC data topic of information is made available to the government and/or homeland security agencies, enabling these agencies to thwart SMC crime data and other activities involving the communication. The database is configured to provide data which are monitored by at least a cache. The cache further comprises a cache engine operable for finding celebrity, science, engineering, SMC data patterns, and for finding other patterns in which communication carries other activities.

The CSMC data engine further comprises Standard SMC data engineering social network “NR” comprising a search engine tool to facilitate locating the desired celebrity, science, engineering, SMC TOI in the network. The network may comprise NR WEB-SITE. Disclosed embodiments provide NR-WEB-SITE comprising a centralized CE for end user to access NR. NR-WEB-SITE is further configured for enabling a platform for the CSMC data engine. The NR search engine is configured for routing celebrity, science, engineering, SMC TOI and for submitting one or more search queries responsive to the information type. Generally, NR search engine is a communication program in communication with a server database containing celebrity, science, engineering, SMC TOI. When queried for celebrity, science, engineering, SMC TOI, the system retrieves either related topics information or pointers to the location of related topics information, or both, by evaluating the server database.

The CSMC data engine in association with NR search engine system that includes an entity extractor, a categorizer, and a query generator for managing and sharing celebrity, science, engineering, SMC topics activities such that when a topic on celebrity, science, engineering, SMC information is queried, responses are retrieved to enrich TOI. The TOI further include SMC group scheduling, generating data to queried SMC data and analyzing advance SMC data component through a centralized database. The entity extractor is configured to identify at least a set of entities as described in the celebrity, science, engineering, SMC data TOI through selected topic files, forms, or documents content. The files, forms, and documents contents are provided for enabling searching the information related thereto using an information retrieval system. Disclosed embodiments further provide the social media and NE configured with a classification label corresponding to category of topics of celebrity, science, engineering, SMC TOI in the information retrieval system. Certain embodiments provide a categorizer configured for assigning the selected celebrity, science, SMC data files, forms, or document content a classification label from the organized classification of science and engineering topics SMC data content. A query generator is configured to automatically formulate a query that restricts a search for celebrity, science, engineering, SMC TOI at the information retrieval system. The information retrieval system comprises particular information concerning the set of entities for the category of celebrity, science, engineering, SMC TOI in the information retrieval system. The information is identified by the assigned classification label being provided to enable speedy responses to celebrity, science, engineering, SMC TOI from the CSMC environment.

The entity extractor identifies the set of entities in selected file content for searching celebrity, science, engineering, SMC TOI, including related social media networking and navigation scheduling through the information retrieval system. The files are requested from server communications, or web servers. Disclosed embodiments provide a server in association with a CA configured for hosting web page for the CSMC data engine. The server is connected to the Internet and the celebrity, science, engineering, SMC TOI are routed through the SMC engine associated with NR search engine. The server is configured for retrieval of information specific to the queried TOI from another server comprising a database system. Generally, a database system is developed and NRSES is in communication with the database system and end user. The search engine directories would route all the celebrity, science, engineering, SMC TOI from the server containing the database system. The database system is developed to aid users in finding specific types of information unique to celebrity, science, engineering, SMC data engines social media and safeties.

NRSES is often used for communications with the database system, distinguishing itself from directory by routing all celebrity, science, engineering, SMC TOI from the internet to the database server system. NR is further configured for collecting celebrity, science, engineering, SMC TOI automatically using programs such as spiders, robots and/or crawlers, which will visit the CSMC data engine web page and collect the needed data by downloading files in relation to the queried TOI and process the files. The CSMC data engine is a process-driven celebrity, science, engineering, SMC data management system for managing data relating to celebrity, science, engineering, SMC data codes and modules. In one instance of the disclosure, NR is configured to link communications in the celebrity, science, engineering, SMC networking, including science and engineering technologies together by directing end users to TOI through the CSMC data engine, making it easier for employees of these industries to share files and data resources through a CSMC data network system.

The CSMC data engine comprises of a centralized celebrity, science, engineering, SMC social network system that includes server-based network to enable reliable science and engineering network and data to local and distance SMC networking. The Web context for the network system is based on queries, such that, when a user submits a query containing celebrity, science, engineering, SMC TOI, the network system in communication with the search engine would respond with a listing of links pointing to information resource. The search engine is further configured for matching entries on celebrity, science, engineering, SMC TOI with the information on the database server. The CSMC data network system uses direct attached storage to the server hard drive comprising a network attached storage to consolidate files stored. The CSMC data network system is further configured with a server adaptor to maximize productivity and end user longevity. The network adaptor is configured for allowing end users to communicatively be connected to the search engine.

The CSMC data network system is further configured with at least a switch being operable to connect client system and servers together to create a client server network within the system. Disclosed embodiments further provide a backup server for allowing the CSMC data access to remotely recover any lost file. Certain embodiments provide a transformation system comprising a process-based interface for celebrity, science, engineering, SMC TOI in communication with end users. Some embodiments provide a search engine associated with communication applications consisting of spiders and robots being operable for indexing different elements of web sites on the Internet and for gathering content information for other databases relating to contents of celebrity, science, engineering, SMC TOI. In the disclosure, embodiments provide NRSES configured with spiders and robots for indexing significant number of celebrity, science, engineering, SMC TOI resources for Internet applications. Ordinarily, the spiders and the robots are further configured for updating the links to the celebrity, science, engineering, and communication content database server in a queried dependency manner so that celebrity, science, engineering, SMC TOI are made searchable with less delay time, and the search results are shareable. The search engine is further configured to provide corporate privacy control and protect confidential information.

The network system is configured to connect various computational devices with the search engine. The celebrity, science, engineering, and communication content database server is communicatively connected to the search engine to store or host one or more web sites. Each web site includes one or more web pages. In a typical searching sequence, communication is established over network between a client and NRSES. In the disclosure, embodiments provide a communication application in communication with a web browser program on the client communication. Search criteria are entered by a user of the client machine, and transmitted to the NRSES comprising communication application. NRSES is further configured for searching the information available on the network that relates to celebrity, science, engineering, SMC TOI. The information includes files, forms, and/or documents relevant to the search criteria. The information stored in the database server in communication with the search engine server. The database includes previously-formed entries corresponding to celebrity, science, engineering, and SMC data contents which are accessible over the network.

Disclosed embodiments provide a CA in association with techniques for extracting celebrity, science, engineering, SMC TOI through search patterns from a database such as the Web. Certain embodiments provide the techniques comprising one or more TOI that act as the initial seed for the search. Some embodiments provide the database or databases comprising a searchable medium for occurrences of the TOI. Other embodiments provide the technique comprising patterns being identified in the array in which they are stored. These patterns are used to extract more topics from the database and the process can be repeated for new topics. Information can be extracted from a database efficiently and accurately with little or no human interaction. Disclosed embodiments further provide a CIM of extracting information from a database. Certain embodiments provide the database being searched for occurrences of at least one topic of information. Some embodiments provide the occurrence of TOI comprises the information that was found, is being analyzed to identify a pattern in which similar topic of information was stored. Other embodiments provide the TOI being extracted from the database utilizing the pattern. In some embodiments, the process is repeated until a predetermined number of topics are found or until no new patterns are identified.

Disclosed embodiments provide a CIM of extracting celebrity, science, engineering, SMC TOI from a database. The database is searched for occurrences of TOI. Occurrences of the TOI that were found are analyzed to identify a pattern in which the TOI were stored. Certain embodiments provide the pattern comprising prefix text, a middle text and suffix text, where the prefix text precedes desired information in the celebrity, science, engineering, SMC TOI and the middle text is between desired information in the TOI and the suffix text follows desired information in the TOI. Additional TOI are extracted from the database utilizing the pattern and the process is repeated for additional TOI. At least one science TOI includes social enterprise, comprising bringing the actualization of potentials in Fashions, Models, and Dress Codes “FMDC” through an objective reality of social bodies being shared in a shared environment by observers that are governed in the SS.

The SS is communicable through electronic NE by means of observation to sharing a common reality that is not commonly absolute by all observers. The shared environment further comprises the Internet in association with electronic CE for sharing productive/objective TOI on CN. The SS further comprises a dynamic website that includes dynamic database driven web-pages by means of server site programming. Certain embodiments provide the social media and NE comprising a SS that comprises of a platform for CSP operable for communicating with the dynamic web-pages. The SS is further configured with interactive interface. The interactive interface is configured with a software based system that provide peer-to-peer CE to enable knowledge based sharing system that is properly configured for efficient communications and that supports decision making. A multicast approach may be employed to deliver these communications between clients within the network and to update the network with additional tools for further interactions and/or interactive communications. The multicast approach includes technologies to deploy the multicast service in existing multiprotocol label switching virtual private network “MPLS/VPN” for transmitting multicast data between FMDC clients within the FMDC network through their private networks by encapsulating the original multicast packets.

The organized bodies of knowledge through the SS would allow the mind and spirit of observers to generate its own reality, in that, what is true in one observer's mind may not be true for other observers. The reality here comprises of the knowledge of positivism, which is the knowledge based on actual positive sense in near real physical, visual and/or virtual experience based on social and/or sociological facts that may lead to economic knowledge in social values. For example, just as a human brain may be pronounced dead by a doctor, the heart in that same body may bring to life another separate body of faith in need of a heart transplant. This is the spirit of positivism.

Other features and advantages of disclosed embodiments would become readily apparent upon review of the following description in association with the accompanying drawings.

### BRIEF DESCRIPTION OF THE DRAWINGS

FIG. 1 illustrates an exemplary embodiment of a CSMC data engine in a server system for communications, includes a cache engine, an indexer, and another server is configured with software for network.

FIG. 2 illustrates an exemplary embodiment of a system for the NE web-enabled devices in communication with the CSMC data engine.

FIG. 3 illustrates further exemplary embodiment of the network comprising multiple communication system configured for Internet applications, further includes a decision engine, a wireless device and a server system for the network.

FIG. 4 shows a flow chart illustrating the exemplary process of extracting celebrity, science, engineering, SMC TOI from a database.

FIG. 5 shows further exemplary embodiment of the network in communication with the search engine for routing information in the network and for extracting information from the database.

FIG. 6 shows further exemplary embodiment in association with the process of identifying a pattern from TOI that have been found in a database.

FIG. 7 shows exemplary embodiment of a table of initial TOI to be searched from the database and the process of verifying that a topic of information has been found in the network.

FIG. 8 is seen an exemplary embodiments of the IMMT in a NE.

FIG. 9 is seen further exemplary embodiments of the IMMT in a structured environment.

FIG. 10 is seen further exemplary embodiment of the IMMT in a NE.

FIG. 11 is an exemplary embodiment of a mobile phone with a touch screen panel operable for communications; interactive gaming; music applications; a slider operable for accessing multimedia buttons.

FIG. 12 is an exemplary embodiment of a mobile phone with numeric keypads operable to provide voice over texting applications; a slide out keyboard; and resistive touch screen character recognition.

FIG. 13 is an exemplary embodiments of NA of CMOS multiple antenna on a chip and nano-wires for transporting energy.

FIG. 14 is an exemplary embodiment of the antenna apparatus and the energy transport medium.

FIG. 15 is an exemplary embodiment of the CMOS multiple antennas on a chip in association with substrate nano-fiber/microfiber embedded with meta-material.

FIG. 16 is seen further exemplary embodiments of communication device comprising energy platform.

FIG. 17 is an exemplary embodiment of a charge transport in association with microfiber/nano-fiber material further configured with silicon substrate.

FIG. 18 is seen a CE comprising a monitoring station, agencies, and a government building.

FIG. 19 is seen further embodiment of a monitoring station comprising a fiber tower network.

FIG. 20 is seen a transmitter further configured with energy apparatus comprising a battery cell which may be charged wirelessly.

FIG. 21 is seen a transmitter and a receiver further configured with energy apparatus in association with a battery cell which may be charged wirelessly.

FIG. 22 is seen an embodiment in association with the circuit diagram of the CA, including a privacy indicator.

FIG. 23 is seen further exemplary embodiment of the IMMT in association with at least an input device, including a keyboard.

FIG. 24 is seen further exemplary embodiment of the IMMT in association with storage medium, a processing unit in communication with a memory device.

FIG. 25 is seen further exemplary embodiment of a SNE.

FIG. 26 is seen an exemplary embodiment of a signup environment.

FIG. 27 is seen an exemplary embodiment of a login environment.

FIG. 28 depicts an exemplary embodiment of the tool.

FIG. 29 depicts further exemplary embodiments of the tool.

FIG. 30 further depicts exemplary network operation of the tool.

FIG. 31 further depicts the tool in a network environment.

FIG. 32 further depicts the tool in network communications

### DETAILED DESCRIPTION OF PREFERRED EMBODIMENTS

The terminology used herein is for the purpose of describing particular embodiments only and is not intended to be limiting of embodiments. As used herein, the singular forms “a”, “an”, “at least”, “each”, “one of”, and “the” are intended to include the plural forms as well, unless the context clearly indicates otherwise.

It would be further understood that the terms “include”, “includes” and/or “including”, “CA”, WCD″ where used in this specification, specifying the presence of stated features, integers, steps, operations, elements, and/or components, but do not preclude the presence or addition of one or more other features, integers, steps, operations, elements, components, and/or groups thereof. In describing example embodiments as illustrated in the drawings, specific terminology is employed for the sake of clarity. However, the disclosure of this patent specification is not intended to be limited to the specific terminology so selected and it is to be understood that each specific element includes all technical equivalents that operate and/or function in a similar manner. It would be further noted that embodiments of the WCD include all/or some elements of the CA and the enclosed IMMT is used concomitantly and/or not used concomitantly with the CA, the WCD, and/or a search engine. It is further proper to note that the elements and/or sensors described in the CA, the IMMT, and the WCD are in general scope and are not intended to be limited to a particular scope, sensors described in one include all families. In some embodiments, the IMMT comprises a platform array responsive to media communications. In some embodiments, the IMMT further comprises a platform array responsive to signal radiation. Other embodiments herein describe apparatus configured for media communications, sensors network, mobile communications, entertainment, short distance communications, education and social network.

The foregoing and/or other objects and advantages would appear from the description to follow. Reference is made to the accompanying drawings, which form parts hereof, and in which are shown by way of illustrations specific embodiments in which the embodiments may be practiced. These embodiments being described in sufficient detail to enable those skilled in the art to practice the teachings, and it is to be understood that other embodiments may be utilized and that further structural changes may be made without departing from the scope of the teachings. The detailed description is not to be taken in a limiting capacity, and the scope of the present embodiments is best defined by the appended claims. Referencing the drawings, wherein reference numerals designate identical or corresponding parts throughout the several views, exemplary embodiments of the present patent application are hereafter described. The numbers refer to elements of some embodiments of the disclosure throughout. As used herein, the terms “and/or” and “at least one of” include any and all combinations of one or more of the associated listed items.

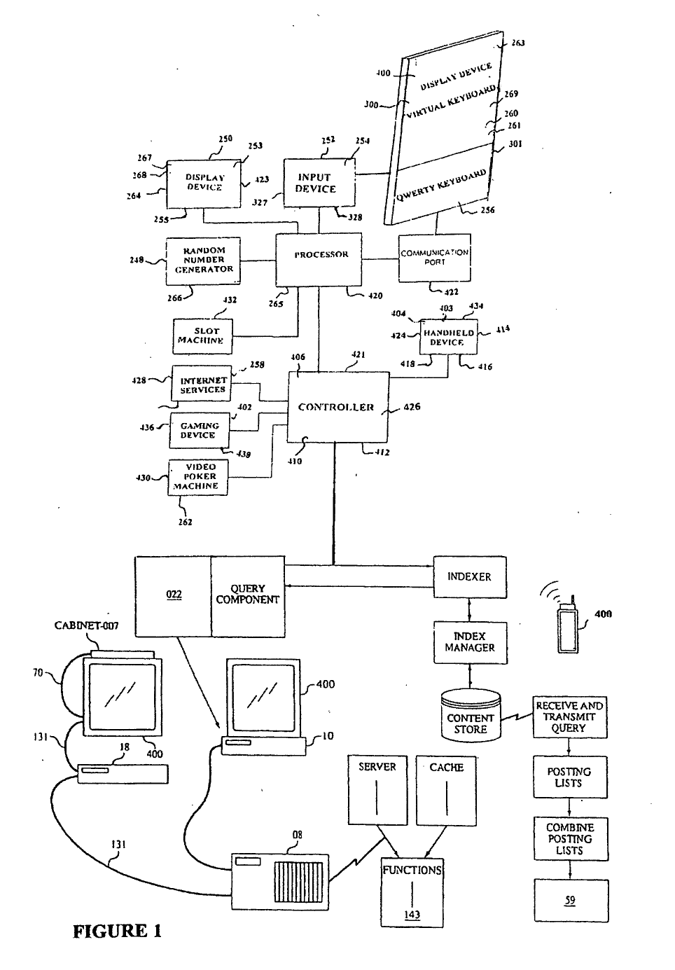

Referring to FIG. 1 is seen an exemplary embodiment of the search engine comprising a network CA. The IMMT further includes a cell phone 400. The IMMT further comprises at least an input device 252, including a keyboard 254. The keyboard 254 may consist of a virtual keyboard 255 and/or QWERTY keyboard 256 in further communication with a random number generator 248. The IMMT further comprises a CSMC that includes a search engine. At least one media community comprises celebrity, science, SMC data and engineering topics data processing system operable on a social platform 258 operatively configured for multicast virtual private network for advancing celebrity, science, SMC data and engineering knowledge. The social platform 258 comprises a social network application in communication with the processor 420. Disclosed embodiments further provide interactive interface comprising a keyboard disposed on an LCD display screen 260 further configured with sensors 327 operable for object recognition to enable an efficient touch screen interaction. The social platform further comprises an environment for communications of celebrity, science, engineering, and/or SMC TOI. At least one science TOI further comprises FWM consisting of a social platform for publicly declaring the will of positivism, sharing human knowledge for organized studies, dealings with the body of facts and truths to explain the phenomena of social media in the environment of natural fashion media, model media, and dress code media “FMDC,” exhibiting a dimension of social sustainability to gracefully improve corporate and community wellbeing through social, cultural, environmental, and economic vision by the goodness of change. Change can be embraced with the hope for sustainable cultural independence.

Certain embodiments provide the sensors 327 further configured for video recognition 262. Some embodiments provide the IMMT further configured with a touch screen display device 260 operable for interactive communication, in association with at least an activation button 264 configured for at least one of: phonebook 266, calendar 268, dictionary 267, calculator 265, and camera 263. Disclosed embodiments further provide the IMMT further comprising at least one of: a mobile communication device 400, a gaming device 402, a media device 403, an interactive interface device 404, and a WCD. The IMMT further comprises a CA 400 in association with a communication recordable medium 10 operable on a communication readable program being recorded to cause at least one communication device to receive plurality of celebrity, science, SMC data and engineering reference documents. The CA further comprises database in association with TOI relating to science topics, SMC sharing social network topics and/or engineering topics. The CA is further operable for storing a frequency through which a module generates content when queried and is further operable for determining keyword compatibility based on the frequency. Disclosed embodiments provide the interface device further comprising at least an integrated phone/PDA in association with the IMMT 400 further configured with integrated connectivity apparatus 406 operable to provide global roaming for communications to a media environment and for accessing celebrity, science, engineering, SMC sharing fashion social media/network TOI. At least a communication port 422 configured for communications with the IMMT 400. Certain embodiments of the disclosure provide the IMMT further comprising a smart-phone/GSM phone 400 being operable on plurality microprocessors 420. Certain embodiments provide the IMMT further configured for allowing multiple inputs/outputs 252. Some embodiments provide the IMMT comprising a touch screen 260 configured with interactive interface 261 operable to enable communication interactions. The multiple communication interactions further comprising at least one of interactive communication, entertainment, infotainment, collaborations, detection, sensing, tracking, blogging, gaming, music, video, social network, and phone book.

Yet other embodiments provide the IMMT further configured with at least a slider 253 operable to access multimedia buttons and/or numeric keypads further configured with piezoelectric sensors 327. The piezoelectric sensors 327 further comprise crystals 328 configured to provide voice operations and/or voice over text applications that include voice command. Disclosed embodiments further provide the IMMT configured for pattern recognition and voice over text technology operable to provide hands free texting applications while driving. Still, other embodiments provide the IMMT further comprising a smart phone operable for networking with other remote communication device that include an infotainment device in proximity with the smart phone to allow hand's free communications data transfer applications. The IMMT in further association with of carbon fiber 408 and/or silicon substrate nano-fiber/microfiber consisting of resistive touch screen 260 and/or character/pattern recognition 269 in association with a communication board 300. Certain embodiments provide housing 301 for the IMMT 400 in association with a carbon fiber 408 and/or a silicon-substrate-nano-fiber/microfiber. Disclosed embodiments further provide an IMMT further configured with at least a WAP browser 410 and/or an integrated GPS device 412 and/or an MP3 music device 414 and/or a camera apparatus 416 in communication with an interactive multimedia interface. The interactive interface further comprising an apparatus operatively configured with at least a multi-protocol label switching comprising a label switched path operable on at least a SS operatively configured for mapping desired communications and to execute at least a process to at least a reference document. Disclosed embodiments further provide an IMMT further configured with an internal antenna apparatus 418 further configured with a controller 421 in communication with a predictive text messaging applications 423. Disclosed embodiments further provide the social media/NE further comprising a SS communicatively connected to at least a dedicated processing element being operable for providing carrier based multicasting virtual private networks. Certain embodiments provide the IMMT 400 further configured with at least one of: infrared sensor 326, calendar 268, FM radio 424, and GPS sensor, MAOC, Bluetooth technology 426, and GPRS Internet services 428. Disclosed embodiments further provide the IMMT 400 comprising a video poker machine 430 and/or a slot machine 432, and/or a handheld device 434 and/or a gaming device 436 and/or a play station 438 in communication with communication port 422. Preferred embodiments provide the IMMT 400 further comprising a search engine for routing celebrity, science, engineering, SMC TOI.

At least one interactive interface apparatus is a user interface associated with a communication readable medium within a media management application environment. Embodiments provide the user interface in association with a plurality of science topics for displaying at least one TOI in a list of one or more media file sources. Certain embodiments provide at least a list of user selectable media file identifiers from a group consisting of science TOI, wherein selected information is associated with a listed media file identifiers for identifying fashion topics, model topics, and dress code topics. At least one identifier further comprises instructional TOI as to how a user can cause one of the science topics to display selected topic information associated with the listed media file identifiers. Some embodiments provide at least one of: a gaming platform; a media player platform; a control interface platform; a commence platform; an electronic commence platform; an advertisement platform; a fashion platform; a model platform; a dress code platform; an educational platform; and a learning platform. Other embodiments provide at least one aspect of the user interface comprising displaying an instant messaging through at least one platform as a media file source. In one disclosure, the media file source may comprise messaging platform for users. Embodiments further provide a messaging platform environment for user communicate with one another. Certain embodiments provide at least one selection platform in association with means for messaging user to cause at least one science topics to be displayed as information associated with media files found in a media platform

Some embodiments provide the network 20 comprising distributed collection of nodes interconnected by communication links 131 and segments for transporting reference document data between end nodes. Other embodiments provide the end notes comprising communication devices and workstations. Disclosed embodiments provide the network comprising local area networks (LANs); wide area networks (WANs). The IMMT 400 further comprises circuit board comprising electronic system's applications further configured for embedded network for at least one of: a wired communications device, a wireless communications device, a cell phone, a handheld communication device, laptop communication, desktop communication, telemetry device, a switching device, MP3 player, a router, a repeater, a codec, a LAN, a WLAN, a Bluetooth enabled device, a digital camera, a digital audio player and/or recorder, a digital video player and/or recorder, a communication, a monitor, a television set, a satellite set top box, a cable modem, a digital automotive control system, a control module, a communication module, a digitally-controlled home appliance, a printer, a copier, a digital audio or video receiver, an RF transceiver, a personal digital assistant (PDA), a digital game playing device, a digital testing and/or measuring device, a digital avionics device, a media device, a medical device, and a digitally-controlled medical equipment.

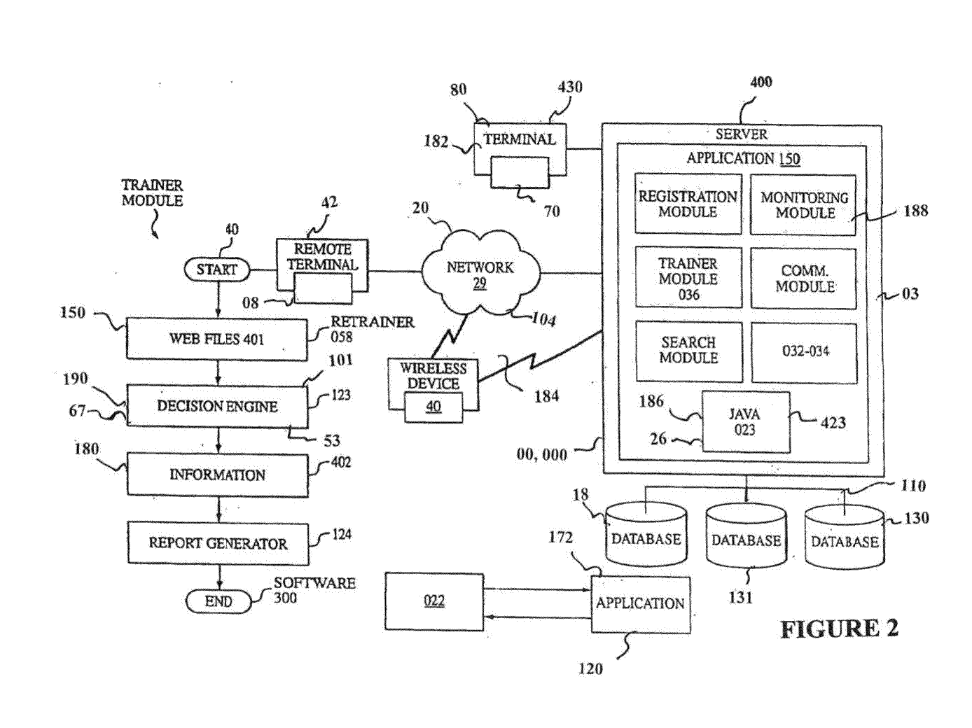

Referring to FIG. 2 is seen an exemplary embodiment of a NE, comprising an IMMT 400 in communication with an output device 70 operable for outputting celebrity, science, engineering, SMC TOI. Disclosed embodiments further provide the IMMT 400 further comprising at least a CA 430 configured with software 300 further comprises an operating system. Certain embodiments provide the CA 430 in association with the IMMT 400 for communication with at least a server 00, 000. Embodiments further provide the CA 430 in communication with a client module 120 operable for determining that at least a key word maps to celebrity, science, engineering, SMC data object identifier. The IMMT 400 further communicatively connected to the CII module 172 for enabling communications with network 20 and or plurality network. The network further configured to redirect links to profiles. Some embodiments provide the network further configured for providing network services for disseminating celebrity, science, SMC data and engineering topics. The IMMT 400 further comprises at least a software program 300, wherein at least one software program is configured with at least a memory device 180 in communication with search module 190 comprising values being accessible to the dedicated processing elements 423. The IMMT further comprises at least hardware means comprising the dedicated processing elements further configured with an input array 182, an output array 184, and/or a query array 186. The CA 430 further comprising at least a database in association with an application module 130 configured for providing information relating to celebrity, science, engineering, SMC topics and/or TOI. At least one information further comprises science information relating to sociological knowledge that are reliably shared to produce useful feeds relating to a person, a product, a culture, an association, entertainment, a sport, an event, a career, a show, a business, an organization, a program, an educational institution, a corporation, consisting of TOI to aid and educate the society through the environment of social media, asserting the influence of positivism for the betterment of the society. Certain embodiments provide CA in association with a monitoring module 188 operable for monitoring and storing the frequency through which each module generates content when queried. Some embodiments provide a communication module 192 in communication with registration module 194 operable for determining keyword compatibility based on the frequency.

The CII module 172 is communicatively connected to at least one CA 430, further comprising at least a decision engine 123 disposed with a data bus comprising a platform for writing input into at least a data memory for at least one array. Other embodiments further provide the decision engine 123 operatively configured with a report generator 124 in communications with network connection keys. The network connection keys in communication with files, forms, documents, and/or industrial files 18, network files 110, graphic user interface 101, sensors 104, web files 401, and system memory 53. Certain embodiments provide the IMMT further configured with system bus architecture 67 in communication with an interactive interface comprising an input device 80. Disclosed embodiments further provide the CA comprising a report generator 124 in communication with an instruction program 26. Certain embodiments provide the instruction program 26 configured with trainer module 036, and a retrainer module 058. The trainer module 036 and the retrainer module 058 are associated with CPU 03. The CPU 03 is in communication with a java class 023, a clickn Vest Servlet class 032, and a Servletrunner application 034.

Disclosed embodiments further provide the CA 430 configured with files, forms, and documents, further comprising data relating to celebrity, science, and engineering, SMC TOI. The IMMT further comprises a wireless device 40 configured for photographic and video applications operable for optimizing and/or for sharing SMC data and/or engineering TOI. Certain embodiments provide the IMMT in association with a remote terminal and/or a network terminal 022 associated with a sharing platform. The IMMT further configured with a readout tool 08 in communication with an address book 131 communicatively connected to content store. Disclosed embodiments further provide the CA 430 further comprising at least a module for determining that at least a key word maps to an object identifier for celebrity, science, engineering, SMC TOI.

The network terminal 022 is further provided for communication with a query component. Certain embodiments provide the IMMT 400 in communication with a NE 29 associated with at least a server application 150. The server application 150 further includes at least one of: a registration module 194, a monitoring module 188, a trainer module 036, a communication module 192, a search module 190, and/or java application software 023. Certain embodiments provide the server application further comprises java application software 023 in communication with a database server 000. Disclosed embodiments provide the IMMT 400 further affixed with ports and/or terminals comprising network terminal 022 in communication with the application module 130. Certain embodiments provide the IMMT being turn on by at least a start button for communication with at least a control device. Other embodiments provide the IMMT further disposed with touch screen a control device in association with a wireless device 40. The wireless device 40 communicatively configured for communications with remote terminals 42. Disclosed embodiments further provide the IMMT in communication with at least one of: report generator module 124, information module 402, retrainer module 058, web-files module 401, a clickn Vest Servlet class 032, and a Servletrunner application 034, and/or a decision engine.

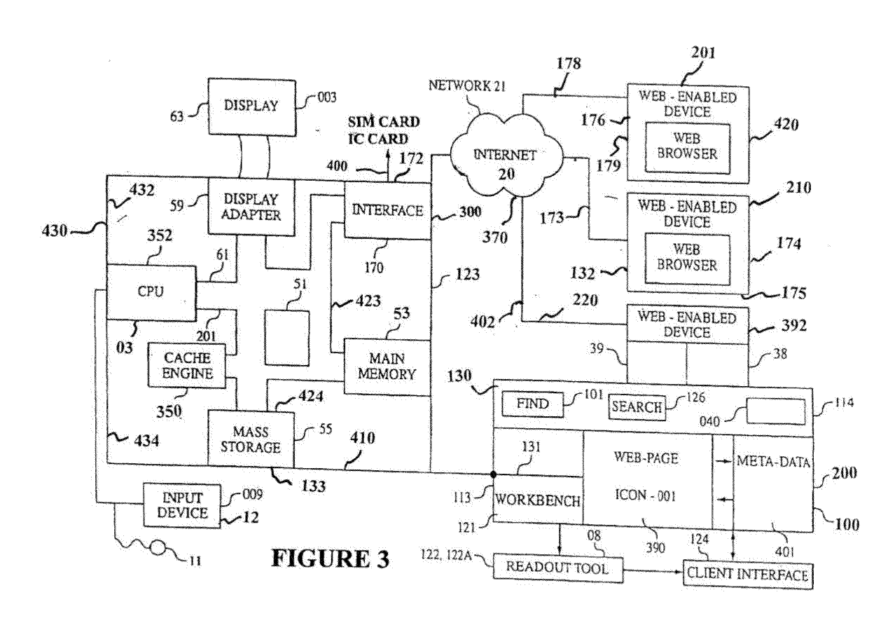

Referring to FIG. 3 is an illustration of a NE 21 comprising an IMMT 400 in communication with a communication system comprising a display device 003, a sound card 61, speakers 63, a cache engine 350, a network interface 170, a display adapter 59, intelligence logic 352, a media device 201, and a central processor 51. The IMMT further includes an input device 009 comprising at least a keyboard 11 and a mouse 12. The IMMT further includes an IC card and a SIM card in communication with network interface 170. The CPU 03 is operable with the intelligence logic 352 to process commands and applications, in communication with memory 53, decision engine 123 and web-enabled devices. Disclosed embodiments further provide the web enabled devices comprising a browser 040. The network 21 is responsive to communications through the Internet. Certain embodiments provide an IMMT further configured with the browser 040, a server search report 39, and client search programs 38. Disclosed embodiments further provide an IMMT configured with graphic user interface 101, a search program manager 126, a browser 040, an ICON 001, and a storage medium comprising at least a meta-data 114. At least a web-page manager 392 is provided comprising addresses 131, corporations 200, industries 100, schools and ware houses 121 and a workbench 113. The communication system further comprises an affinity analyzer 122, a data analyzer 122A, a readout tool 08, a web-page 390, a report generator 124, web file module 401, and client interface being operable with software application 300.

The IMMT 400 comprises celebrity, science, SMC data and engineering TOI. Disclosed embodiments provide the IMMT 400 further comprising a data processing system 410 operable on a social platform 420. The social platform 420 comprises a SNE operatively configured for multicast virtual private network. Disclosed embodiments provide the virtual private network 178 operable for transmitting same data to multiple receivers in a network. Certain embodiments provide the multicast virtual private network 178 in communication with at least a multicast packet 176 configured for replication with at least a router 179. The multicast private network comprises a network interface 170 for advancing celebrity, science, SMC data and engineering knowledge. The network interface 170 further comprises: at least a CA 430 in communication with a communication recordable medium 432 being operable on a communication readable program 434. The communication readable program 434 is configured to cause at least one communication device to receive plurality of celebrity, science, SMC data and engineering reference documents in communication with CII module 172 operatively configured with at least a multi-protocol label switching 173 being operable on at least a SS 210 operatively configured for mapping desired communications. Disclosed embodiments further provide the multicast-protocol label switching 173 further configured to direct data from network note 20 to network note 21 in communication with a virtual link Certain embodiments provide the multi-protocol label switching further configured for carrying data from network note 20 to network note 21 in communication with a virtual link At least one SS 210 is configured with the social platform 420 and communicatively connected to at least a dedicated processing element 423.

The multi-protocol label switching 173 is further configured to speed up network traffic flow to effectively manage structured reference documents comprising celebrity, science, engineering, SMC TOI. Other embodiments provide the virtual private network 178 further associated with the router 179, for communications with the multiprotocol label switching network 173. The router 179 configured for the distribution of celebrity, science, engineering, SMC TOI across a shared multiprotocol label switching network. Disclosed embodiments provide the router further includes Internet protocol addresses for establishing multiple switched paths with the multiprotocol label switching network. Other embodiments provide the multiple switched paths comprising plurality point to point paths assignments for celebrity, science, engineering, SMC network. Some embodiments provide the router 179 further configured for maintaining communications with the database 130 containing celebrity, science, and engineering, SMC reference documents for the TOI. Other embodiments provide the database further comprising prefix of the TOI that matches celebrity, science, engineering, SMC topics addresses in the packet's network destinations address field. Disclosed embodiments further provide the network in association with Internet protocol configured to determine at least a direction for the packet transmission from the router to at least a remote communication system. In the disclosure, the packets further comprise Internet protocol data-gram comprising network addresses for remote destinations.

The dedicated processing elements 423 being operable for providing carrier based multicast virtual private networks 178. Some embodiments provide multi-protocol label switching 173 consisting of labels 175 in communications with packets 176 to forward decisions made on the contents of the labels. Disclosed embodiments further provide the IMMT 400 further operable for categorizing SMC documents and engineering files referenced by initial search results, comprising implementing at least a method for receiving at least a query that maps to objects identifier for SMC data and engineering topics. The virtual network further comprises interactive collaboration within a secure celebrity, science, engineering, SMC data reference document. The virtual network further comprises a server-based social network operable for community distribution of knowledge. The network is configured with document management system in communication with a server database that includes at least a professional functionality and a plurality of interactive functionalities. Scientists, engineers, SMC personnel may assemble into the network through the social platform. Interactive functionalities include allowing networks of scientists, engineers, students, universities, SMC personnel to share knowledge and documents in a remote secured environment.

Disclosed embodiments provide the IMMT 400 further configured with software applications 300 comprising a structured program operable to remotely create, delete, edit and manage celebrity, science, engineering, and/or SMC documents and view information about the documents in a plurality of customized locations. At least one customized location further comprises FMDC network consisting of a social enterprise for bringing the actualization of potentials in Fashions, Models, and Dress Codes “FMDC” through an objective reality of social bodies being shared in a shared environment by observers that are governed in the SS. The SS is further communicable through the NE by means of observation to sharing a common reality that is not commonly absolute by all observers. The SS further allows the mind and spirit of observers to generate its own reality, in that, what is true in one observer's mind may not be true for other observers. The reality here comprises of the knowledge of positivism, which is at least the knowledge based on actual positive sense in near real physical, visual and/or virtual experience based on social and/or sociological facts.

Certain embodiments provide the IMMT 400 further associated with at least a neural network 220 for communications with at least a cache engine 350 being operable for responding to at least a SMC data and engineering topic request using a server response data that is cached at a network operable with at least a programmable architecture 424. Disclosed embodiments provide the programmable architecture 424 further configured with at least one dedicated processing elements 423. Certain embodiments further provide the cache engine 350 in communication with cache database 133. Some embodiments provide the search engine 402 in communication with the cache engine 350 configured for providing applications that include services associated with the internet 370. Other embodiments provide the CA in association with the search engine 402. The search engine in communication with at least a crawler 174 and an index database 132. Disclosed embodiments further provide the IMMT 400 in communication with a display adaptor 59 operable for communications with network client's PERSONAL DIGITAL ASSISTANT (PDA), corporations 200, SMC network 100, web file modules 401, and client interface 172.

Embodiments provides the communication readable program 434 further comprises communication readable medium in communication with software code for a media management application, the code configured to implement functions comprising: generating an application environment within a user interface, the environment comprising a plurality of platforms; displaying in a first of the platforms a listing of one or more sources from which media files may be accessed; displaying in a second of the platforms a listing of user selectable media file identifiers, each identifier associated with a media file and with the one or more sources of science topics; displaying in at least one of the platforms first selected information associated with the listed media file identifiers; displaying in a another platform instructional information as to how a user can cause at least one platform to display second selected information associated with the listed media file identifiers; and displaying in at least one platform science TOI and/or a media player control interface through which the user can direct the playing of the media files associated with the listed identifiers.

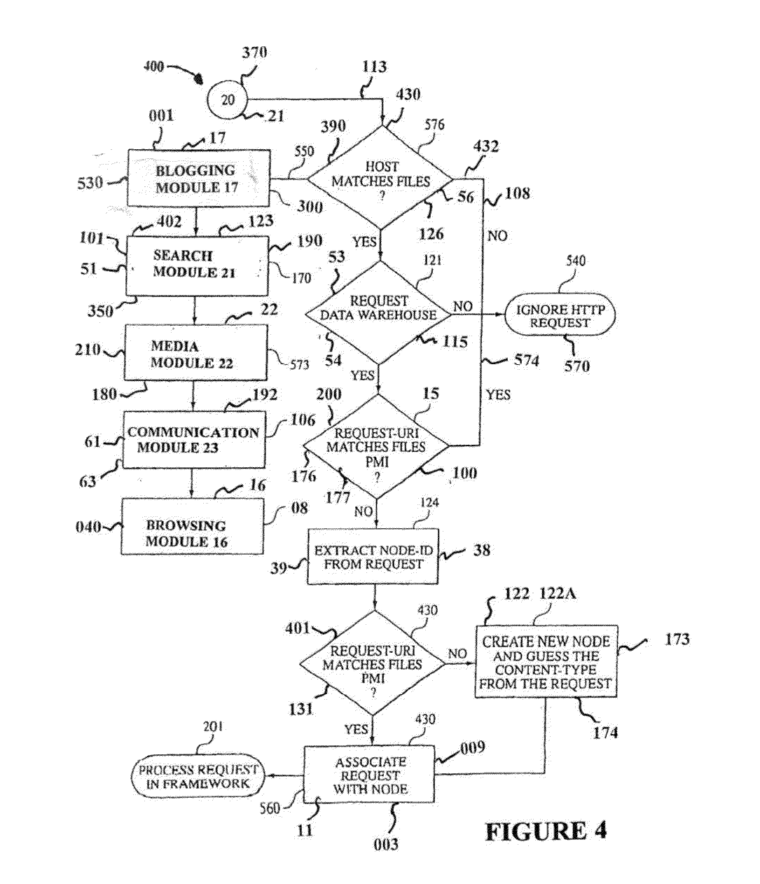

Referring to FIG. 4 is an exemplary illustration of the intelligence logic for the IMMT 400, comprising a blogging module 17 configured with application session layer 550 and software 300, a search module 190 in communication with network interface 170, a media module 22 configured with signal booster chip 573, a communication module 192 in communication with signal booster chip 573 and antenna circuit 106, and a browser module 16 in communication with a readout tool 08. At least a file memory device 53 is provided in communication with the software 300. Disclosed embodiments provide the IMMT 400 in association with data warehouse 121 communicatively connected to the search module 190 configured with a primary memory interface “PMI” 54 for communication with primary programs 15. Certain embodiments provide the IMMT configured with a client identification node “ID NODE” in communication with affinity analyzer 122 and data analyzer 122A. The media module 22 is communicatively connected to the media device 201, and the search module is communicatively connected to HTTP report generator 124 in communication with presentation layer 540. Some embodiments provide the CA 430 configured with a default gateway 432 in communication with a transport layer 560.

Certain embodiments provide the IMMT being operable on a platform 576 configured for processing images, media consumptions, host files, and science/engineering information. The PMI 54 further comprises at least a content file in communication with at least a subscription identifier 56 being programmable for providing at least a hash table network 176. Disclosed embodiments provide the hash table network 176 further comprising a decentralized distribution of the structured reference documents consisting of celebrity, science, engineering, SMC TOI. The distribution hash table 177 is operable for providing a lookup network service, providing connections and records, including a peer to peer network communications for scientists, engineers, SMC personnel. At least one cache engine 350 is operatively configured with at least one array operable for implementing steps for intercepting celebrity, science, engineering, and SMC topics at network element, comprising one or more celebrity, science, SMC topics and/or engineering data packets that at least a client application addressed to a server application.

The search engine further comprises at least a markup language configured with at least one array for determining at least an application layer message that is contained in at least one portion of at least one data packets for specifying a particular request necessary for entering the searchable celebrity, science, SMC and/or engineering TOI. The search engine 402 further comprises at least one of: a spider 173, a crawler 174, at least one being operable for disseminating celebrity, science, SMC and/or engineering TOI. Embodiments further provide NE 20 comprising a platform for disseminating the IMMT 400 over the social media and NE configured for processing request in framework. The social media and NE further comprises platform in communication with remote communication personal digital assistant (PDA) configured for providing images, client's network mileage readings and media consumptions. The IMMT 400 is further configured with search columns 21 and file columns 22. Certain embodiments provide the IMMT 400 configured with column 23 comprising forms 16, social media programs “PMI” 15, and host files. Some embodiments provide the IMMT 400 configured with an indexer 108 in communication with data warehouse 121, social platform layer 574, and report generator 124. Other embodiments provide the IMMT 400 operable for data warehouse request. The IMMT further configured to associate request with notes and to create new notes if a queried note with associated name does not exist.

In the disclosure, request to URI is compared for matches to files and ignoring HTTP request is enabled. Embodiments provide the apparatus further operable for extracting notes that contains Identifications from request. The NE comprises the IMMT 400 in communication with a communication system comprising a display device 003, a sound card 61, speakers 63, a cache engine 350, a network interface 170, a display adapter 59, intelligence logic, a media device 201, and a central processor 51. The IMMT further includes an input device comprising at least a keyboard 009 and a mouse 11. The IMMT further includes an IC card, SIM card, and interface. The CPU is operable with the intelligence logic to process commands and applications, in communication with memory 53, decision engine 123 and web-enabled devices. The network 21 is responsive for communications through the Internet. Certain embodiments provide an IMMT further configured with a browser, a server search report 39, and client search programs 38. Disclosed embodiments further provide an IMMT configured with graphic user interface 101 comprising interactive interface apparatus, a search program manager 126, a browser 040, an ICON 001, and storage medium comprising at least a meta-data and/or a database server 115. At least a web-page manager communicatively connected to links associated with addresses 131, corporations 200, industries 100, schools and ware houses 121 and a workbench 113 containing celebrity, science, engineering, SMC TOI. The communication system further comprises an affinity analyzer 122, a data analyzer 122A, a readout tool 08, a web-page 390, a report generator 124, files 401, and client interface being operable with software application 300.

Embodiments provide the CA in communication with a readable medium comprising software code configured for a media management application. The software code further configured to implement functions comprising: generating an application environment within a user interface, the environment comprising a plurality of platforms; displaying in a first of the platforms a listing of one or more sources from which media files may be accessed; displaying in a second of the platforms a listing of user selectable media file identifiers, each identifier associated with a media file and with the one or more sources of science topics; displaying in at least one of the platforms first selected information associated with the listed media file identifiers; displaying in a another platform instructional information as to how a user can cause at least one platform to display second selected information associated with the listed media file identifiers; and displaying in at least one platform science TOI and/or a media player control interface through which the user can direct the playing of the media files associated with the listed identifiers. In one embodiment, the present invention includes a user interface for a media management application comprising: managing science TOI; managing engineering TOI, managing transportable data comprising SMC TOI, a media management application environment comprising a plurality of platforms; a first platform in which is displayed a listing of one or more information sources from which media files may be accessed; a second platform in which is displayed a listing of user selectable media file identifiers, each media file identifier associated with a media file comprising one or more information sources; at least one platform in which is displayed first selected information is associated with the listed media file identifiers; at least one platform in which is displayed instructional information as to how a user can cause the another platform to display second selected information associated with the listed media file identifiers; and at least one platform in which is displayed a media player control interface through which the user can direct fashion contents, model contents, dress code contents, and the playing of media files associated with the listed identifiers.

At least one application layer 530 message is a java message consisting of SMC data and/or engineering TOI configured for Web based applications. The search engine 402 further comprising a structured celebrity, science, SMC data and engineering NE 20 communicatively connected to at least one SS 210 in communication with a social platform 573 configured with at least an index and/or a catalog comprising celebrity, science, SMC topics and/or engineering data. The data further includes at least one of; parts purchasing, standard navigation data, social media scheduling, social media forms, media consumption log, mileage log, data to advance components, equipment sales, parts graphics, marketing, name search, sounds, text content file, communication name monitoring, video, Internet protocol television 180 comprising a communication system, engineering and/or celebrity, science, engineering materials and/or tools, and at least an advertisement. Disclosed embodiments further provide the IMMT 400 being associated with at least one software program 300, further configured for communications with at least one SS 210 being responsive to structured directory to celebrity, science, SMC and/or engineering topics and providing communications relating to at least celebrity, science, SMC and/or engineering TOI in a network infrastructure.

At least one SS 210 is further responsive to global communication via Internet 370 for routing the occurrences of celebrity, science, SMC documents and/or engineering TOI. Certain embodiments provide the CA 430 operatively configured with the software program 300. Some embodiments provide the software program 300 further comprises at least a protocol being programmed for providing directory approaches to routing celebrity, science, SMC images and/or engineering TOI and for analyzing at least an occurrence of the information. Other embodiments provide the TOI further comprises of keywords that are communicable to prioritize keywords in the list that frequently occur in a set of celebrity, science, SMC data and engineering topics documents. Disclosed embodiments further provide the Internet protocol television 180 configured for delivering Internet television services over the Internet, comprising structured celebrity, science, engineering, SMC TOI.

At least one protocol is operable for accessing and/or for delivering structured data containing celebrity, science, SMC images, SMC videos, and frames, filters and/or engineering TOI over the Internet 370. At least one CA 430 is configured to associate a communication device for communication with the cache engine 350, operable to apply integral reference content rate for each celebrity, science, SMC and engineering topics in at least a set of annotation type. The cache engine 350 is further operable for caching data operations being requested from at least one CA 430. The CA 430 is further operatively configured with at least one network data storage medium in communication with at least a network client. The network storage medium further comprising a cache memory for caching structural functions and further operable for requesting data structures comprising celebrity, science, engineering, SMC TOI by network client through the NE 20.

At least one software program is operatively configured with at least one SS 210, further comprising at least a mapping circuit associated with a lookup table which is indexed by a pattern ID value for providing at least one celebrity, science, SMC topics and/or engineering TOI using at least a pattern responsive to at least a potential query of the topics. Disclosed embodiments further provide the IMMT 400 in communication with a SS 210 configured with at least a chat function operable for enabling live chat associated with TOI relating to at least one of; celebrity social network, engineering social network, science and/or engineering project sharing and/or project development, science TOI relating to the will of positivism, social media preventive navigation, SMC services, SMC data analysis, SMC data to advance image components, SMC image classifications, SMC vendor's classifications and/or information, SMC equipment sales, parts graphics, marketing, biological analysis, at least a name search, sounds, text, content file, video, Internet protocol television communication system, engineering tools, and at least advertisement.

The FWM “FWM” platform is a NE that allows individuals and companies to capture large audiences through presentation of fashion brands, trends, styles, and awareness. Let your public declarations reflect every possible influence on the broad areas of fashion which isn't defined solely by clothing choices, but is also conveyed through the manner in which people carry themselves that in turn inform and reflect their personalities and world views. Yes, fashion touches on prevailing styles, customs, and behaviors, both individually and collectively. Further, the FMW platform is configured to allow individuals and corporations the opportunity for a ready forum to announce, display, reveal, share and advertise their products. Users of the network are encouraged to project and embrace creative minds to achieve all stated goals. Indeed, this forum is a centralized fashion tool to reach worldwide clienteles thereby facilitating online brand passion, fashion passion, brand postings, and customer loyalty. The expected positive community impact will not only succeed at the above-listed goals, but must also be seen as a potentially effective medium for enhancing brand success, business awareness and, in the long-run, growing a versatile community with noticeable cultural and economic improvements. Let organized, structured fashion be the guide in all SNEs.

Some embodiments provide the will of positivism further comprising at least one of: spoken words, written words, advertised objects, body expressions, photographic expressions, image expressions, love expressions, passion expressions, positive expressions, advertised products. The positivism further comprises bringing out the actualization in real positive sense through a social environment. For example: “In the beginning of creation Heaven and earth was first created by God and the power of His word brought light to the surface of the earth. God created us out of His own image and empowered us to take control of all His creations. The power of God's words is on our tongue and He made us beautifully out of His likeness.” The will of positivism can be derived from God's word to reflect one's inner thought, such as: “Let the world hear our voices through our fashions, our models, and our dress codes.

Let the voice of the community create a model based on the CCI. Let the voice of a religious affiliation create a model based on their culture.

Let the voice of a business or a corporation creates a model based on the uniqueness of their product offerings. FMDC network is a network of change for media communication. FMDC is about publicly declaring the science of positivism in you, a person, a product, a business, a corporation, an institution, a career, a job, a culture, an event, and a show, an educational institution through fashion media, model media, and dress code media. The network further provides an environment for signing and for uploading of fashion, model, and dress code, and for automatically creating a virtual private network “VPN” within FMDC network so that one can share positive declaration with friends, family members and others. The network further comprises a public network such as the Internet to connect clients at remote sites together in FMDC network so that they can share their will of positivism with others. The VPN is desired to reveal the science of positivism for mass communications, and for providing peer-to-peer network connectivity between clients, friends, businesses, corporations, and more.

FMDC network is a social platform for providing substance of things hoped for, revealing the evidence of things not commonly seen. This evidence of things not commonly seen is CHANGE, which can be embraced through fashion media, model media, and dress code media with the hope for sustainable cultural independence. For by CHANGE societies would receive good reports, for things which are seen are not spiritually made of things which do appear as a means of inquiry, but rather appear as a dimension of social sustainability to gracefully improve corporate and community wellbeing through social, cultural, environmental, and economic vision. FMDC network further provides a CE for individuals and groups such as colleges, universities, churches, stores, organizations, cultural entities, businesses, entertainment/sport entities, events, corporations and more, to present the will of positivism of these groups or their product through a social media environment consisting of fashion media, model media, and dress code media, so that the science of positivism for their product offerings may be shared through a centralized system.

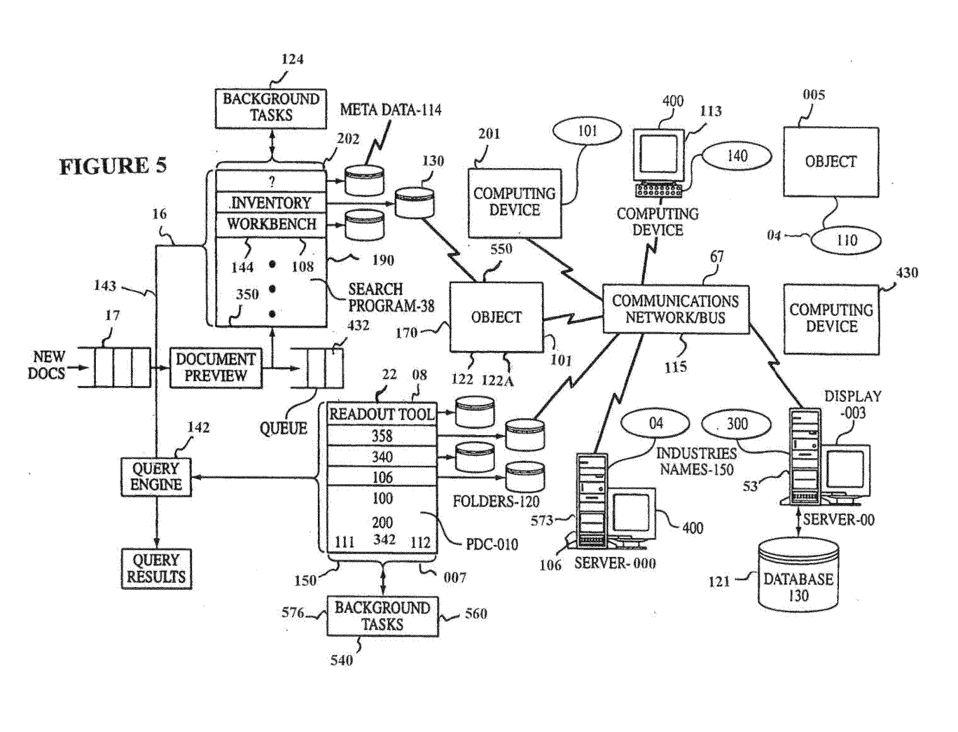

Referring to FIG. 5 is seen exemplary embodiments of the IMMT 400 is disposed with at least a query component configured with an indexer 108 in communication with an index manager 202. Embodiments further provide a NE comprising a server 000, 000 and a cache engine 350 in communication with structured program comprising functions 143 configured for operations with software 300. The functions 143 further include social platform 573 includes a SNE being operable to receive and transmit communications to at least one of: a memory 53, a cabinet 007 comprising a content store for celebrity, science, engineering, SMC TOI. Disclosed embodiments further provide a centralized celebrity, science, and engineering, SMC data network system further configured with server 00 and 000 associated with adaptors to maximize productivity and end client longevity. Certain embodiments provide the server adaptor further configured to allow end client to end client communication through NR search engine. Certain embodiments provide communication network system in association with a bus 67 configured to periodically provide navigation associated with the URL. The URL may be modified at random times by their web masters. The communication network bus 67 is further configured to connect with single link that either point to NR web site or its modified web site by continuously finding, indexing, and cataloging the web pages. Some embodiments provide password module 140 in communication with the server adaptor software configured to automatically reroute traffic signals when any of the server port experiences a community data or is disconnected. Other embodiments provide a query engine 142 in communications with files and forms modules being monitored to allow access to multiple server files containing client data to enable prevention of any loss of information when the hardware experiences a community data.

Disclosed embodiments further provide the query engine 142 configured for communications with multiple file storage system being centralized for maximum protection and for providing real time query results. Certain embodiments provide the query engine 142 in communication with IMMT 400 further comprising CA 430 configured with user interface 101 operable for centralized celebrity, science, engineering, SMC data network system. Some embodiments provide the IMMT further comprises a PDC 010 configured with a switch to connect client system and servers together to create a client server network within the system and a social media environment for communications. Other embodiments provide the IMMT communicatively connected to application module 130 in communication with data warehouse 121, folders 120, readout tool 08, search program 38, and document parser 144. The document parser further includes new documents. Disclosed embodiments provide the search program 38 further associated with background tasks. The background tasks further include types of SMC data 340, advance network topics components 342, industries 100, corporations 200, industries names 150, government agencies 111, and remote communities 112. Some embodiments further provide the backup storage software being operable for providing backup file scheduling such as tape backups and server file storage backups. The backup storage further allows the centralized celebrity, science, engineering, SMC system access to remotely recover any lost file. Other embodiments provide the communication network bus 67 operable to eliminate single point community data. In the disclosed embodiments, indexer 108 is provided for storing of links pointing to information resources including some or all of the data associated with the information resource, including workbench 113, inventory 114, and term center 115. The query engine 142 further provides objects 110 being stored in graphical hardware 04. The objects are displayable on display devices 003. Certain embodiments provide the IMMT further associated with at least a memory consisting of the content store in communication with input devices. Some embodiments provide the content store associated with database containing TOI for advancing celebrity, science, engineering, SMC knowledge. The input device is further operable to receive and transmit query, and in communication with listings and/or combine posting relating to celebrity, science, engineering, SMC TOI. At least a display adaptor is communicatively connected to the posting and/or the listings.

Certain embodiments provide the NE comprising the IMMT 400 configured with intelligence logic associated with a blogging module 17 configured with the session layer 550 and software 300. Disclosed embodiments provide the IMMT 400 further comprising a search module 190 in communication with network interface 170, a media module 22 configured with signal booster chip 573, a communication module 23 in communication with signal booster chip 573 and antenna circuit 106, and a browser module 16 in communication with a readout tool 08. At least a file memory is provided in communication with the software 300. The data warehouse 121 further comprises database server being communicatively connected to the search module 190. The search module 190 is configured with a primary memory interface “PMI” in communication with primary programs 15. Disclosed embodiments further provide an IMMT configured with a client identification node “ID NODE” in communication with affinity analyzer 122 and data analyzer 122A. The media module is communicatively connected to the media device 201, and the search module is communicatively connected to HTTP report generator 124 in communication with presentation layer 540. Some embodiments provide an IMMT further configured with a default gateway 432 in communication with a transport layer 560.

Certain embodiments provide the IMMT further operable with means 576 for categorizing celebrity, science, social media, social network, and engineering files referenced by initial search results. Certain embodiments provide the means 576 for categorizing files further comprising implementing at least a method for receiving at least a query that maps to objects identifier for celebrity, science, SMC, and engineering topics. Some embodiments further provide the means 576 configured with at least a neural network in communications with at least a cache engine operable for responding to celebrity, science, SMC and engineering topic request using a server response data that is cached at a network. Disclosed embodiments further provide the network being associated with network element operable with at least a programmable architecture configured with the dedicated processing elements. Certain embodiments provide the IMMT communicatively connected to the interactive interface apparatus for communications with a link to a profile further configured for providing network services relating to celebrity, science, SMC data and engineering TOI. At least one science topic of information further comprises sociological studies. At least one other science TOI further comprise social studies. At least one other science TOI comprise a social network consisting of an environment for social media.

In the embodiment, the science TOI further comprises models. A model is a representation of a system that allows for investigation of the properties of the system and/or prediction of the future outcomes. A model comprises of many shapes, sizes, and styles. It is important to emphasize that a model is not just the real world object but also consist of human construct to help the society better understand real world systems via personal digital assistant (PDA). A model should at least have an information input, an information processor, and an output of expected results, and should provide an environment where:
simplifying assumptions must be made;
boundary conditions or initial conditions must be identified
the range of applicability of the model should be understood

This may include conceptual models that consist of qualitative models highlighting important connections in real world systems via personal digital assistant (PDA) and processes as a first step in the development of the more complex models. People receive information, process this information, and respond accordingly many times each day. This sort of processing of information is essentially a conceptual model of how things in our surrounding environment actually work.

A model may also be visualized as a visualization model. Visualization models comprise of direct links between data and some graphic or image output that may be linked with other type of models to convert the intended output into a visually useful format.

A model may also consist of abstractions of reality to deliberately emphasize one part of the reality at the expense of other parts. This is necessary due to objective power limitations, and may enable others to focus their attention on an important aspect of the model. Models are also mathematical, logical, business, corporate, or some other structured representation of reality consisting of the specific applications of the models to arrive at some outcome.

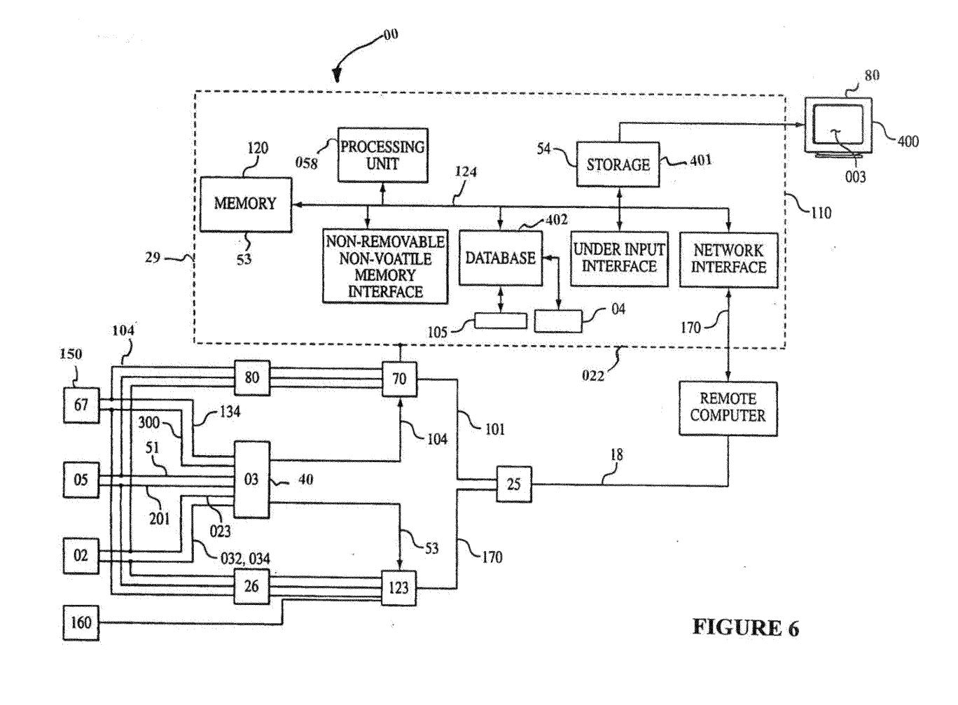

Referring to FIG. 6 is seen further exemplary embodiment of the IMMT 400 further disposed with storage medium 54, central processor 51, and an analyzer 122 is in communication with a memory device 120. Disclosed embodiments further provide the memory further comprising a portable memory, a non-removable non-volatile memory interface, a database, input interface and network interface 170. Certain embodiments provide an IMMT associated with the memory, further comprising hardware 105, a graspable hardware/browser 04, and a display device 003. Other embodiments provide the IMMT 400 further configured with software 300, a central processor 51, a RAM 05, a ROM 02, a network adaptor 160, a router 179 and a media device 201. Disclosed embodiments further provide the IMMT 400 further comprising at least an output device 70, a remote communication device in communication with a connection key 25. The connection key further configured for communications with industrial files 18, network files 110, decision engine 123, graphic user interface 101, sensors 104, and system memory 53. Certain embodiments provide an IMMT being further configured with system bus architecture 67 in communication with an input device 80. Some embodiments provide the output device 70 further comprises a report generator 124 in communication with an instruction program 26. At least a CPU 03 is provided, in communication with a java class 023, a clickn Vest Servlet class 032, and a Servletrunner application 034.

Disclosed embodiments further provide the files, forms, and documents further associated with data relating to celebrity, science, engineering, SMC TOI.

### Fashion Social Media

The fashion industry has been late to join the SMC, and the delay to adopt fashion with SMC is hindering sales promotions, preventing social measurements for business and fashion trend awareness. The launching of FWM as a social network is important for the fashion industries. It brings to light positive public declaration of fashion brands, styles, and trends. The search engine platform for the FWM is a centralize communication hub for the fashion world that would further increase communication speed, strengthen brand awareness and impact community awareness through FSMNE. The search engine platform configured for searching fashion trend relationship with consumers to enable cultural and community awareness, brand awareness, trend awareness, and generational awareness.

The IMMT 400 is in a NE 29, comprising at least a server application 150. The server application 150 further includes at least one of: a registration module, a monitoring module, a trainer module, a communication module, a search module, and/or java application software 023. Certain embodiments provide the java application software 023 in communication with a database server. Disclosed embodiments provide the IMMT further disposed with ports and/or terminals comprising a network terminal 022 for communication with at least an application. Certain embodiments provide the IMMT 400 being turned on by at least a start button for communication with at least a control device 40. Other embodiments provide the control device 40 further comprising a wireless device communicatively configured for communications with remote terminals. Disclosed embodiments further provide the IMMT 400 comprising at least one of: report generator module 124, information module 402, retrainer module 058, web-files module 401, a clickn Vest Servlet class 032, and a Servletrunner application 034, and/or a decision engine. Certain embodiments provide the IMMT further comprises hardware means associated with at least one dedicated processing elements configured with image generator, a photographic array, an input array, an output array, a television array, and a query array. The IMMT 400 further comprises interactive interface apparatus is communicatively connected to the CA.

The CA further comprises a data bus comprising a platform for writing input into at least a data memory in communication with the query array. The IMMT further comprises plurality server 00 each responsible for some portion of the database server workload. The database server comprises of celebrity, science, engineering, SMC files, forms, and documents stored in a distributed file system. Certain embodiments provide the distributed system further comprising partitions configured for associating clients/users of the networks area with celebrity, science, engineering, and SMC TOI that are allocated to specific servers. Some embodiments provide the software program further comprising a mechanism for copying contents of an application to each of the servers that are operable for independent applications. Other embodiments provide the contents of each individual component of the server further configured for retrieving and for modifying data relating to celebrity, science, engineering, and SMC topics.

In the embodiment, the science TOI further comprises fashion models. Some embodiments further provide social media platform for celebrity and science topics that include fashion TOI. Certain embodiments provide the fashion topics further comprising an art ultimately consisting of individual statement of expression. Art is also a religion, a job, a peek into a personality, playfulness, an escape, or a disguise. Fashion further comprises a feast for the eyes. Fashion is not limited/not something that exists in dresses only. Fashion is in the sky, in the streets, and has to do with ideas, the way we live, what is happening around the society. Fashion isn't defined solely by clothing choices, but it is also conveyed through the way we carry ourselves, our personalities and our views of the world. Fashion comprises of a prevailing style, custom, dress, or behavior.

Fashion also comprises fashion trends, consisting of anything which is popular in a culture at any given time. Fashion is inclusive of areas such as; style of dress, cuisine, literature, art, architecture, and structures, fashion trends and many other popular factors. Though fashion trends often change rapidly, fashion is often used to describe the latest version of these trends. Fashion is also used positively as a synonym for style, glamour and beauty. However, fashion can also be expressed to have negative connotations of fads and trends, and materialism. Other embodiments further provide celebrity, science and engineering TOI further comprising Dress Code. At least one embodiment provides Dress Code being associated with a set of rules governing what garments may be worn together and in what setting to convey a social message. Some embodiments provide fashion comprising clothing wearable to convey a social message, even if not intended. In limited definition of fashion, if a receiver's code of interpretation differs from the sender's code of communication, misinterpretation follows. In every culture, current time fashion governs the manner of consciously constructing, assembling, and wearing clothing to convey a social message. Clothes convey other social messages, including the stating, claiming personal, cultural identity, establishing, maintaining, defying social group norms, and further appreciating comfort and functionality.

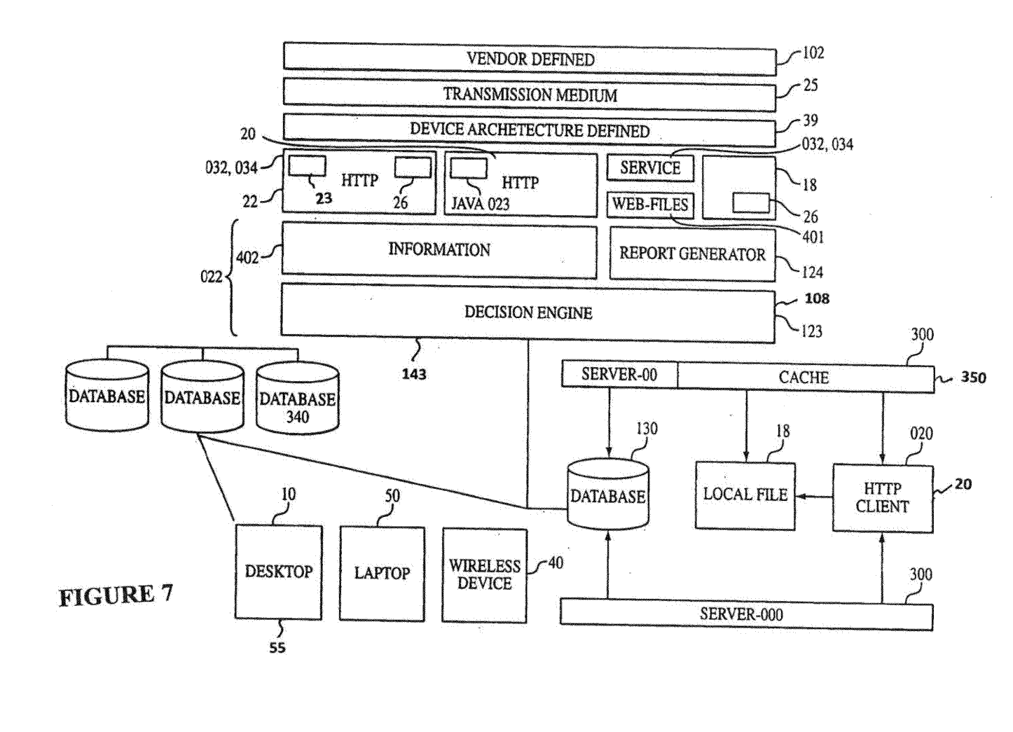

Referring to FIG. 7 is seen an exemplary embodiment of celebrity, science, engineering, SMC NE comprising an IMMT 400 configured with software 300 in communication with a vendor device 102, operable for outputting TOI relating to celebrity, science, engineering, SMC data. The IMMT further comprise a transmission medium 25, a communication system 10, a lap top device 50, and a wireless device 40. A decision engine 123 is further configured for adding more self-organizing maps for defining the various celebrities, sciences, engineering, and SMC topics. The decision engine 123 is configured with Java classes: the JSTAR class 023 and the ClicknVestServlet class 032. The JSTAR Class 023 is a Java class that is also called a JSTAR Java Servlet. The JSTAR class 023 is an object-oriented, Java language based application. The IMMT further comprising at least a module for determining that at least a key word maps to an object identifier for celebrity, science, engineering, SMC TOI. Disclosed embodiments further provide the IMMT 400 further associated with at least one of: report generator module 124, information module 402, device architecture 39, web-files module 401, a clickn Vest Servlet class 032, Servletrunner application 034, and/or a decision engine 123. A network 20 includes network terminal 022 being provided for communication with a query component 23. The query component is configured with an indexer 108 in communication with an index manager 22. Embodiments further provide a NE associated with server 00, 000 and a cache engine 350 for communications with functions 143 in communication with software 300. The functions 143 further include functions associated with SNE being operable to receive and transmit communications to at least database 340, 130 and local file 18.

Certain embodiments provide the IMMT in association with MAOC, a memory consisting of the content store for communications with an input device. Some embodiments provide an instruction program 26 in communication with the content store associated with database containing TOI for advancing celebrity, science, engineering, SMC knowledge. The input device is further operable to receive and transmit query, and in communication with listings and/or combine posting relating to celebrity, science, engineering, SMC TOI. At least a display adaptor is communicatively connected to the posting and/or the listings. Disclosed embodiments further provide the IMMT 400 configured for desktop communication 10, network communication 20, hand held communication 30, wireless communications 40, laptop communication 50, communications relating to gaming device 55, and a server 00. The IMMT further configured for allowing/providing networking with HTTP client 020.

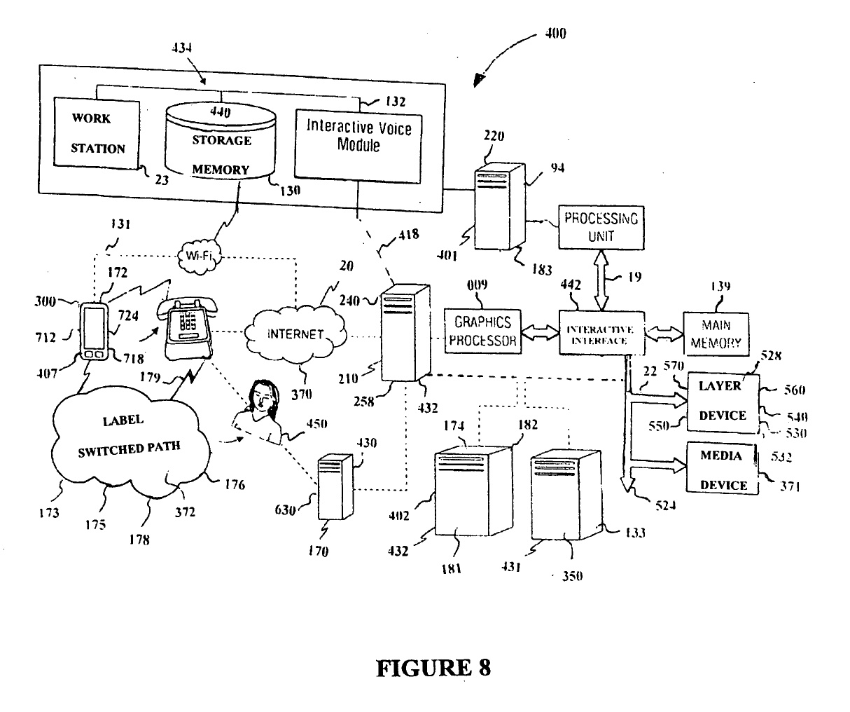

Referring to FIG. 8, the IMMT 400 includes clients applications 120 coupled to a network 20. The network 20 comprises celebrity, science, engineering, SMC data network known for effectuation knowledge and communications through the various devices. The network 20 can be a local area network (LAN), a wide area network (WAN), or a combination thereof. It is contemplated that the network 20 may be configured as a public network, such as the Internet, and/or a private network, and may include various topologies and protocols operatively configured for distribution of celebrity, science, engineering, SMC TOI. In accordance with one embodiment of Disclosed embodiments, the IMMT 400 configured with at least one application 130, such as a multi-player online game, over the network 20. Furthermore, the applications 130 is distributed among several servers 00, 000 coupled to the network 20. Embodiments further provide the CA in association with application 130 configured to connect clients 120 with multiple servers 00, 000. Embodiments further provide the CA in association with means for distributing the applications 130 among the multiple servers 00, 000, providing computational workload for communications with network clients 120 being identified with topics relating to celebrity, science, engineering, SMC to exchange shared knowledge. Disclosed embodiments provide an IMMT 400 operable to adjust the number of servers 00, 000 that a distributed applications 130 uses, depending upon the variation in the application's load. Disclosed embodiments may further be employed to control the distribution of celebrity, science, engineering, SMC topics workload among the varying set of servers 00, 000 over which the applications 130 is distributed. Certain embodiments provide the IMMT 400 further configured for communications with wireless devices 40. Disclosed embodiments are configured for utilizing key entry as query to communicate with applications 130 further configured for retrieving the TOI from the database. At least a client registration module is provided in communication with a client monitoring module.

The document management comprises a tool configured to allow celebrities, scientist, engineers, SMC personnel to simultaneously view a window having folders relating to the TOI and a window having an open document. The open document is shared with a first network 20 and not shared with at least one member who is not a member of the first network. The member is capable of clicking and dragging at least an open reference document into one of the folders containing desired communications, such that the open referenced document is shared with members of network 21 and is not shared with at least one member who is not a member of the first network 20 or the second network 21. At least one member of the second network 21 is not a member of the first network 20 within the social platform environment. The network 20 and 21 comprises one or more data links that enable the transport celebrity, science, engineering, SMC reference documents, including desired electronic data between communication systems via personal digital assistant (PDA) and other ED. The CA is further configured for transferring voice and text data over the network 20 for communications with remote communication devices. The communications further include connections such as hardwired, wireless, or a combination of hardwired or wireless connections to the Internet. The IMMT 400 properly views the connection as a transmission medium. Transmission media can include the network 20 and/or data links which can be used to carry or transport desired communications, including codes in the form of communication-executable instructions or data structures to be accessed by a general purpose or special purpose remote communication system.

The monitoring module responsive to query keys is operable for communication with the communication module. The communication module is configured with the research module operable for routing celebrity, science, engineering, SMC TOI from the database to the client 120. The trainer module 036 is operable to configure to the pattern in which the query key is enabled. Each individual key corresponds to some element of the application workload for celebrity, science, engineering, SMC topics relating to searchable TOI 402 consisting of the aggregations of all possible celebrity, science, engineering, and other SMC topics. Query keys are grouped into key groups or clusters of potentially varying sizes of the topics being handled by server 00 and 000. Disclosed embodiments further provide the IMMT 400 in association with at least one of: report generator module 124, information module 402, retrainer module 058, web-files module 401, a clickn Vest Servlet class 032, and a Servletrunner application 034, and/or a decision engine 123. Certain embodiments provide the IMMT further comprises hardware means in association with at least one dedicated processing elements configured with an input array, an output array, and a query array. The IMMT further comprises a decision engine 123 in communication with an interactive interface operable for presenting TOI, product or services for celebrity, science, engineering, and SMC data. A decision wizard is further configured to provide comparative product charts. The decision engine 123 is further configured for providing information about the various product or services. The decision engine 123 may present a series of questions to the clients 120 about various celebrities, sciences, engineering, and the SMC to enable proper sharing navigation rundowns and scheduling. Predictive networks and artificial intelligence is further associated with the decision engine 123. The decision engine 123 is configured with a report generator 124 in communication with software 300. Disclosed embodiments further provide the IMMT 400 in communication with network terminals 022 and/or remote terminals. At least a server is configured to perform load shedding in accordance with disclosed embodiments via modifying one or more groups that it currently manages.

Disclosed embodiments provide the CA 430 further configured for providing advertising and marketing services by means of indirect methods of marketing communications that include social media marketing, search engine marketing, inquiry marketing, internet marketing, live chat marketing, mobile marketing, mobile app marketing, blogging, Internet television marketing and other forms of passive, sharable, virtual and/or viral communications channels. Certain embodiments provide the CA 430 further comprises a tool for sharing and managing business information in the field of fashion and fashion social media, providing marketing consulting in the field of fashion and fashion social media, executing social media strategy and marketing consultancy focusing on clients to create and extend their product and brand strategies by building virally engaging marketing data. Some embodiments provide the CA 430 further comprising a system in communication with a website that displays rankings of fashion TOI comprising celebrity media, fashion media. Models media, dress code media, advancing community culture, brands sharing and/or marketing, styles posting, and for advancing trends education, trending, beauty topics, photographic images, arts, and hair stylists.

Other embodiments provide the CA 430 further comprises a platform for fashion expressions, expressions; sharing love and the popularity of social happenings based on social media for entertainment and fashion world purposes. Embodiments provide a CA operatively configured for advancing innovative technologies and for enabling consulting in the field of social media and fashion, providing online services for connecting social network users and social media views with retailers for the purpose of facilitating discounted purchases of fashionable products, associated to a website for enabling users connectivity to provide specific informed recommendations of specific consumer products and services validated by the users' inputted preferences and social network. The CA 430 further comprises a computer system configured for providing interactive web site communications by allowing users to consolidate and manage centralized fashion topics within a SNE. The CA allows users to create accounts to enable connections to existing and emerging application programming interfaces (APIs) and/or mobile applications “Mobile App.”

Certain embodiments provide the CA 430 further configured for conducting on-line personal lifestyle performance assessments based on the science of positivism, comprising the principles of emotional happiness by means of users' inputted preferences for social network communications, providing media environment for fashion education and faith-based devotionals via social networking. Some embodiments provide the CA 430 in communication with the software program 300 configured for managing media operations and for organizing network operations, including fashion education and shows for commercial purposes, providing entertainment in the nature of fashion shows, enabling entertainment and fashion services that include television programs in the field of fashion, models, dress code, trending, branding, styles, celebrity etc. The television program further comprises organization of fashion shows for entertainment and education purposes, production and distribution of videos in the field of fashion education, fashion, clothing, wearable, wearable communications, garments, styles, brands, expressions, modeling, fashion advertisement; and advertising retail store services featuring virtual goods that include clothing, wearable, electronics, wearable electronics, fashionable products, electronics, digital communications, enabling communications with imagery devices for posting in online virtual worlds. Other embodiments provide the CA 430 further comprises a system and/or tool for enabling personalized stylist services that include evaluating the physical attributes of a person/business lifestyle, lifestyle expression, corporate fashion, business fashion, casual fashion, cultural fashion, community fashion, and fashion styles of others; recommending clothing and accessories to achieve personalized image desired by the person/business “Client”, providing a network for sharing; fashion show; fashion world show; celebrity fashion media; celebrity model media; fashion world celebrities; dress world media; and dress code world media. Embodiments further provide the CA comprising a platform for fashion social media, a platform for fashion social networking, a platform for discussing fashion TOI, a fashion television broadcasting platform, a photographic television platform.

The IMMT 400 further comprising virtual private networks 21 configured to deliver/broadcasting communications data via Internet Protocol Television edge routers 371 operable on a multi-protocol label switching environment 372. Disclosed embodiments provide the multi-protocol label switching environment 372 further operable for sharing multicast state celebrity, science, SMC data and engineering data through a delivery tree associated with at least a server tool 009 for communications with other EDs via Internet 370 and/or broadcast channels. The CA 430 is configured with software program 300 comprising at least communication instructions in communication with at least an application tool comprising a module 130 operatively configured for delivering broadcast channels via Internet Protocol Television edge routers 371, in communication with the multicast virtual private networks 21. Certain embodiments provide the virtual private network 178 further operable for sharing and/or permitting at least a client to access a database 132 associated with structured celebrity, science, SMC data and/or engineering TOI.

Some embodiments provide the IMMT further comprising communication readable storage medium 440. The communication readable storage medium 440 further comprises communication instruction being further operable for sharing the same multicast state and multicast delivering tree through a CSMC environment, comprising a search engine 402 operable for centralizing at least one remote CA 430 via at least a cable and/or wireless connections. The IMMT 400 is further configured for providing at least a physical connection for at least a network infrastructure operable for managing at least one communication device at a remote location. Disclosed embodiments provide at least one interface module 170, being further operatively configured for providing network connectivity to enable communications with network infrastructure 20. At least the network connectivity further comprises providing communication channels for communications with at least a remote communication system and the network infrastructure 20. The network 20 further operable for disposing at least one of: network management, remote network operation, network client authentication, security, identifications, permissions and/or rights, and for locating at least a physical address of at least one remote communication within the network 20. Disclosed embodiments further provide the IMMT 400 in association with at least a layer device 530.

The layer device 528 further comprising at least one of: a model Layer 532 comprising communication instructions operable in multicast virtual private network for providing structured celebrity, science, SMC topics and/or engineering network communications, an application layer 530 comprising communication instructions operable in at least a multicast domain tree for providing structured celebrity, science, SMC topics and/or engineering application services, a presentation layer 540 comprising private edge router operable for providing coding to structured celebrity, science, SMC topics and/or engineering data, a session layer 550 comprising at least one module operatively configured with at least one interface module 170 operable for broadcasting/channeling at least a single communication signal configured for delivering structured celebrity, science, SMC topics and/or engineering data to at least an end client, a network layer 570 comprising at least a call signal transmission processing module operable for providing structured celebrity, science, SMC topics and/or engineering TOI via at least an Internet protocol 370, and a transport layer 560 comprising apparatus operable for providing structured celebrity, science, SMC topics and/or engineering TOI for communication between at least a CA 430 and at least a gateway/default gateway 432. Certain embodiments provide the IMMT 400 further comprises apparatus for updating connectivity and/or for providing structured celebrity, science, SMC data and/or engineering technical support.

In one embodiment, the network interface module 170 functions at a low level of abstraction to control or respond to I/O devices of the wireless communication device 30 as directed by the client interface module 172, in communication with the central processing unit 51. The network interface module 170 may receive client input, such as an input signal resulting from a client using IMMT 400, browser 040, or keyboards 11. The network interface module 170 is further configured to convert input to an appropriate signal that may be interpreted by the client interface module 172. The network interface module 170 may also receive signals from the client interface module 172 that specify a particular decision to be rendered on the screen 003, and may generate appropriate signals to effectuate the desired celebrity, science, SMC topics, and engineering topics decision being displayed.

### The Search Engine

The search engine platform is a very important tool for bringing to light fashion trend relationship with consumers so that casual awareness and community cultural awareness would be easily empowered to impact all generations. The platform is a genuine interactive tool for centralizing fashion communications environment, bringing speed and communication efficiency to better social interactions between designers, and fashion outlets, bringing brands, styles, fashions, and fashion trend to clients and users of the network. The search engine platform would support FWM as a contemporary platform to accelerate connections with people of all demographics. The FWM has already been launch to bring the cosmic powers of social media to the community through fashion expression and trend predictions to the fashion world. A visualization of the search engine platform could be seen as an important tool for creating direct links between data expressions and some graphic/image expression of facts that may be linked together to convert the intended expressions into fashionable output for visually processing Of the outward facts. Additionally, consumers residing in different parts of the world would appeal to accelerated demographic reach to join such a unique market share environment and capture fashion power trend through a prioritized spending on model-related products, including beauty services. Fashion businesses and fashion outlets would be able to accelerate the supply of up-to-date fashion styles and brands to their local and worldwide customers through the powers of the centralized social media NE and the opportunities that the search engine platform and the FWM brings.

In another embodiment, the network interface module 170 may assume a larger role and work concurrently with the client interface module 172 for sharing data relating to celebrity, science, engineering, SMC TOI. In yet another embodiment, the client interface module 172 may be merged with the network interface module 170 through a common network 20, including the Internet 370. Disclosed embodiments further provide a central communication engine in association with Internet search engine 402 for communications with personal communication devices, wireless communication devices, lap tops, media devices, gaming devices, and television set apparatus, desk tops, and mobile devices such as smart phones. Certain embodiments provide the wireless communication device 30 being implemented as part of a personal communication device. Some embodiments provide the application layer 530 further configured with keyboard 11 and/or voice auditory applications. Some embodiments provide servers 00 and 000 further comprising wired and/or wireless communication device and/or a remote server. Disclosed embodiments further provide the client interface module 172 further comprising mobile devices. Certain embodiments provide the network interface module 170 further configured to create, select, arrange, and administer to the screen the TOI for collaboration with the client interface module 172. At least the collaboration further comprises the sharing of tasks to render results relating to searches for celebrity, science, and engineering, SMC TOI. Each search result corresponding to celebrity, science, engineering, SMC topics may be translated to electronic documents such as web page, advertisement responsive to the queried relevant to celebrity, science, engineering, SMC TOI.

Disclosed embodiments provide the IMMT 400 in association with a browser 040 configured with variety of different algorithms operable for choosing a candidate key group of celebrity, science, engineering, SMC topics. In one embodiment, the server keeps track of the celebrity, science, engineering, SMC topics associated with each individual key group that is being managed. Certain embodiments provide counters and/or monitors comprising a display 003 operable for independently tracking of the application activity in each of the key groups. Some embodiments provide the servers 00 and 000 further operable for selecting the key group that is contributing the maximum celebrity, science, engineering, SMC for sharing social network topics load. The IMMT 400 is further configured to provide client interface 170 operable for enabling communications with mobile device 30. The IMMT 400 further includes a cellular telephone 30 for communicating between the servers 00 and 000 and client 120. The client 120 further comprises a PDA, a personal communication, and a personal communication device. Certain embodiments provide a display screen that structurally programmed to display any appropriate information to client 120 for communications with the IMMT 400. Some embodiments provide the IMMT 400 operable for displaying information relating to Internet 370, and searching application that consist of celebrity, science, engineering, SMC TOI. Certain embodiments provide a SS 210 in association with a social platform 420. The social platform 420 is configured with a search button for searching celebrity, science, engineering, SMC topics. Some embodiments provide the social platform 420 further comprising a social network for sharing knowledge and for searching celebrity, science, engineering, SMC TOI. At least a search engine 402 is provided for searching celebrity, science, engineering, SMC topics. The search engine 402 may be communicatively connected to at least a cellular tower. The query keys comprise data entry keys used to enter information such as alphanumeric characters, and may take the form of a standard telephone keypad. Disclosed embodiments further provide the IMMT 400 configured for occurrences of alphanumeric information and voice recognition operation.

The IMMT 400 further comprises data processing system comprising a central processor 51, servers 00 and 000, and a network 20. The client 120 is connected to the data processing system through the servers 00 and 000 each coupled to the network 20. The client 120 may communicate wirelessly with the network 20, such as over a cellular telephone network. The network 20 further comprises a local area network (LAN) or a wide area network (WAN), including the Internet 370. The servers 00 and 000 may include content servers that store collections of documents such as web pages, advertisement servers, and celebrity, science, engineering, SMC services such as, text-only ads, image ads, graphical ads, audio clips, and video ads clips. The services may include e-mail servers that provide email functionality to client devices 120 and embedded information, including machine-executable code or links to other documents. The servers 00 and 000 further configured to store electronic content in electronic documents written in EHTML (Extensible Hypertext Markup Language), HTML (Hypertext Markup Language), WML (Wireless Markup Language), CHTML (compact HTML), or in any other appropriate format. The data processing system may take any applicable form and may receive information requests from client 120. Disclosed embodiments provide the software program in association with the data processing system configured for locating suitable information corresponding to a query request. Certain embodiments provide the data processing system operable for formatting the information received for presentation on the display 003 to convey the formatted information to the client 120. The data processing system further associated with the interactive interface module 172 operable to permit communications in a variety of ways. Some embodiments provide the data processing system in communication with the servers 00 and 000 over the network 20. In the disclosure, embodiments provide the data processing system further operable to access and process electronic data content that is stored on the servers 00 and 000. The data processing system is further configured for communications with the client 120 via the network 20, including the cellular phone network or a combination of networks. A report generator 134 may receive and process a request from the client 120, such as a network search request. The network search request may include one or more search query terms entered by a client 120 in search input device 80.

A search engine 402 may then receive the search request from the report generator 134, and may search a searchable indexer 108 for electronic content appropriate for, or corresponding to, the search request. The indexer 108 may include an index database 130 in communication with a cache engine 350 in communication with a cached information database. The index database 130 may contain data representing searchable information available to the CPU 51. The CPU 51 may scan the Internet 370 or various intranets for content celebrity, science, engineering, SMC topics, web sites, workgroup discussions, technical books, electronic books, etc. The CPU 51 may extract key words, phrases, or other objects from the content, and may organize the information in the index database 130, or partition the database 130 in a manner that allows ready searching. Disclosed embodiments further provide a social media and SNE comprising a platform operable for sharing celebrity, science and engineering TOI to change the way knowledge is derived about an object, a business, a corporation, an institution, an educational institution, a testimony, a Pastor, an art, an event, a project, a play, a book, a culture, a Bishop, a struggle, a success, the society and its environment. Social measurements would lead to generational awareness, brand awareness, leadership awareness, business awareness, corporate awareness, educational awareness, professional awareness, ethical awareness, religious awareness, institutional awareness, social awareness, cultural awareness, sociological awareness, professional awareness, causal awareness, and service efficiency to the society relating to the positivism in fashion media, model media, and dress code media. Individuals, businesses, corporations, religious groups, cultural groups, and community organizations/associations must have the freedom to choose how to improve their product life in the context of fashion media, model media, and dress code media. Just as true prophecy never comes by the will of man, but from God through the Holy Spirit to bring Lamb upon our feet and Light upon our paths, so must the positivism of good products/objects be lightened to bring out the truth by modeling the products/objects to create a clear path for knowledge and economic growth.

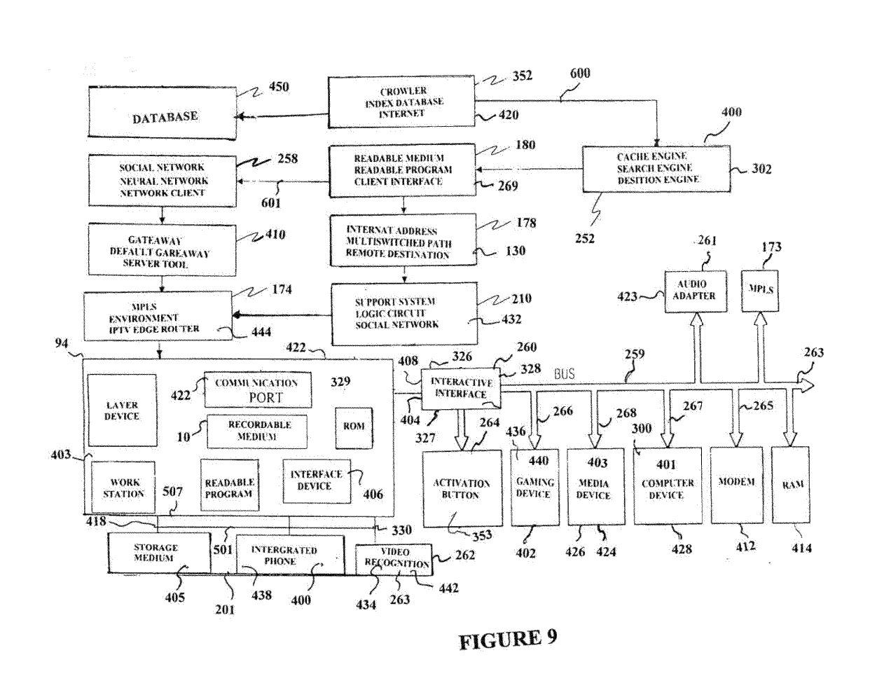

Referring to FIG. 9 is seen an exemplary embodiment of the CA. The IMMT 400 comprises at least an input device 252, including a keyboard 254. The keyboard 254 may consist of a virtual keyboard 255 and/or QWERTY keyboard 256 in further communication with a random number generator 248. At least a social network application 258 is configured with the keyboard and in communication with the processor 420. Disclosed embodiments further provide the keyboard being disposed on an LCD display screen 260 configured with sensors 327 operable for object recognition. Certain embodiments provide the sensors 327 further configured for video recognition 262. Some embodiments provide the sensors being disposed with the IMMT configured with a display device 260 operable with at least an activation button 264. The IMMT 400 further comprises at least one of: phonebook 266, calendar 268, dictionary 267, calculator 265 and camera 263. Disclosed embodiments further provide the IMMT further comprising at least one of: a mobile communication device, a gaming device 402, a media device 403, and an interactive interface device 404. Disclosed embodiments further provide the interactive interface device in association with at least an integrated phone/PDA configured with integrated connectivity apparatus 406 operable to provide global roaming. At least a communication port 422 is provided with the IMMT 400. Certain embodiments of the disclosure provide the IMMT comprising a GSM phone 400 being operable on plurality microprocessors 420. Certain embodiments provide the IMMT further operable to allow multiple inputs/outputs 252. Some embodiments provide the IMMT in association with a touch screen 260 associated with an interface 261 configured for at least one of: interactive communication, interactive gaming, music, video, and phone book.

In one embodiment, the present invention includes a user interface for a media management application comprising: a media management application environment comprising: a first platform in which is displayed user selectable postage, each representing a source from which media files may be accessed, wherein one of the postage represents a media file source comprising science TOI, an instant messaging platform, and wherein a user selecting the messaging platform postage causes a list of postage representing selected messaging to users that the user desires to communicate with to be displayed on at least a display device; and a second platform in which is displayed, in response to the user selecting one of the messaging user postage associating with a selected messaging to users, information associated with media files found in a media box of the selected messaging to users. In one embodiment, the present invention includes a communication readable medium in association with software code for generating a user interface for a media management application, the code configured to implement on one or more processor functions comprising: generating a media management application environment; displaying in the environment, a first platform in association with a list of user selectable postage, each representing a source from which media files may be accessed, wherein one of the postage represents a media file information source comprising at least one of: science TOI, engineering TOI, transportable data comprising SMC TOI, an instant messaging platform; displaying in the environment, in response to a user selecting the messaging platform postage, a list of postage representing selected messaging to plurality users that the user communicates with; and displaying in the environment, in response to the user selecting one of the messaging user postage associated with a selected messaging to users, a second platform comprising information associated with media files found in a media box of the selected messaging to users.

Yet other embodiments provide the IMMT further configured with at least a slider 253 operable to access multimedia buttons and/or numeric keypads configured with piezoelectric sensors 327. The piezoelectric sensors 327 further comprise crystals 328 configured to provide voice operations and/or voice over text applications. Certain embodiments further provide the piezoelectric sensors further comprises means for converting mechanical energy into sound, voice, electrical energy, and communication signal. Disclosed embodiments provide the IMMT further configured with voice over text technology operable in proximity with the infotainment device to provide hands free texting/voice applications while driving. Still, other embodiments provide an IMMT further associated with carbon fiber 408 and/or silicon substrate nano-fiber/microfiber comprising resistive touch screen 260 and/or character recognition 269 and/or a communication board 300 associated with at least one of, a smart phone, an infotainment device. Certain embodiments provide a housing 301 for the IMMT 400 in association with a carbon fiber 408 and/or a silicon-substrate nano-fiber/microfiber. Disclosed embodiments further provide the IMMT further configured with at least a WAP browser 410 and/or an integrated GPS device 412 and/or an MP3 music device 414 and/or a camera apparatus 416 and/or an internal antenna apparatus 418 further configured with a controller 421 in communication with a predictive text messaging applications 423. Certain embodiments provide the IMMT 400 further configured with at least one of: infrared sensor 326, calendar 268, FM radio 424, Bluetooth technology 426, and GPRS Internet services 428. Disclosed embodiments further provide the IMMT 400 comprising a video poker machine 430 and/or a slot machine 432, and/or a handheld device 434 and/or a gaming device 436 and/or a play station 438 in communication with communication port 422.

Some embodiments provide the cache engine 350 further comprising at least a data structure pointer generator circuit 352 operable for generating information that correspond to at least a matching trigger pattern being communicable for providing at least communication patterns for celebrity, science, SMC topics and/or engineering topics, comprising at least a structured celebrity, science, SMC data, fashion expression, art expression, and/or engineering expressions. At least one celebrity, science, SMC data, and/or engineering expression is configured with computable functions. At least one communication patterns further comprises at least one of; a context free grammar, at least a text expression comprising at least a make and/or at least a model of a SMC data engine, at least a text expression comprising of at least a desired celebrity, science, SMC topics and/or engineering topics, and at least a text expression comprising at least a celebrity, science, SMC topics and/or engineering TOI.

The IMMT 400 further configured for verifying additional topics, comprising text, images, videos, frames, filters, signal clarity, celebrity, science, SMC and/or engineering TOI that matches a predetermined number of pattern, wherein the predetermined number of pattern is greater than at least 1, and wherein the additional topics is rejected if it does not match the predetermined number of pattern by at least once. Disclosed embodiments provide the IMMT 400 further associated with at least one coordinated set of programs each functionally structured for communications with the communication readable medium 440 operable for delivering celebrity, science, SMC data and engineering topics through at least a broadcast channels, including Internet Protocol Television edge routers 370 being further operable for providing continuous distribution of celebrity, science, SMC topics and/or engineering knowledge and/or for providing national security applications.

Certain embodiments provide the IMMT further associated with at least one cache memory 354 operatively configured with at least one communication readable program 434. Some embodiments provide the cache memory 354 in communication with the software program in association with a communication code consisting of celebrity, science, SMC topic data and/or engineering TOI. Some embodiments provide the IMMT 400 further comprising a communication engine 402 configured with each cache memory 354 and responsive to queries. The queries comprise of at least one of: science and engineering topics, a SMC topics and/or engineering vendor: SMC topics and/or engineering provider, a person, SMC topics and/or engineering company, SMC data, SMC data models, motor carrier contents, at least an educational institution program and/or curriculum, at least an engineering network, at least a SS comprising a social media and social network platform operable for communicating celebrity, science, engineering, SMC topics, and at least a network client location. Embodiment further provide the communication readable medium comprising software code configured for generating a user interface to enable a media management application. The code is further configured to implement on one or more processor functions comprising: generating a media management application environment; displaying in the environment, a first platform comprising a list of user selectable postage, each representing a source from which media files may be accessed, wherein one of the postage represents a media file information source comprising at least one of: science TOI, engineering TOI, transportable data comprising SMC TOI, an instant messaging platform; displaying in the environment, in response to a user selecting the messaging platform postage, a list of postage representing selected messaging to plurality users that the user communicates with; and displaying in the environment, in response to the user selecting one of the messaging user postage associated with a selected messaging to users, a second platform comprising information associated with media files found in a media box of the selected messaging to users.

At least one coordinated set of programs further comprise an electronic mall associated with an electronic commence “e-commence.” The electronic mall comprises an electronic shopping center comparable to physical mall were live chat is enabled. An e-commence is required as the revenue platform for the network operation. The EC is the sales aspect of FMDC e-business and further consists of the environment for the exchange of data to facilitate financing and payment aspects of business transactions. The e-commence features include the following:

The ability to buy and sell advertised products or services in FMDC network over electronic systems via personal digital assistant (PDA), such as the internet. The ability to use payment systems via personal digital assistant (PDA) that includes domestic and international payment methods, including electronic funds transfer, supply chain management, Internet marketing, online transaction processing, electronic data interchange (EDI), inventory management systems via personal digital assistant (PDA), and automated data collection systems via personal digital assistant (PDA). The electronic data interchange (EDI) further comprises at least one of: business-to-business exchange of data; business-to-business buying and selling; group buying, means for providing security for business transactions; means for exchanging data among parties that know each other well; means for arranging data among parties; means for one-to-one (or point-to-point) connection; means to facilitate business transaction and fund transfer electronically.

Business transactions further include advertiser's e-tailing or virtual storefront connection, connecting the advertisers VPN on FMDC network to the web sites of advertising company. E-tailing further comprises a virtual storefront on FMDC Web sites operable as a virtual mall; online catalogs; news groups; teleconferencing; and shopping card, providing an environment for a person to checkout and share with friends within FMDC network. E-tailing further comprises a place for direct retail shopping that may be accessed 24-hour availability for global reach, including business-to-consumer online shopping and business-to-business online shopping environment, an enterprise content management, online shopping and order tracking, further providing an environment for users to interact and provide custom and ordering information via multimedia social prospects.

Enterprise content management further comprises means for simplifying storage capabilities, security, version control, process routing, and retention so that better business value could be delivered. Group buying further comprises a collective buying process that offers products and services at significantly reduced prices on the condition that a minimum number of buyers would make the purchase with the deal kicking in once a set number of people agree to buy the product or service. Embodiments further provide the CA comprising instant messaging configured for adaptation of behavioral integrity to enable the use behavioral targeting to select and add other users.

Newsgroup is a special messaging system posted from users within FMDC network. Newsgroups are technically distinct from, but functionally similar to discussion forum on the world-wide-web. Teleconferencing further comprises means for allowing users to rank programs or models in the fashion/media environment by voting for it. The more votes a fashion/model gets, the higher the fashion/model moves up the page. Teleconferencing further comprises a fashion poll, a model poll, a dress-code poll, an event poll, a show poll. Teleconferencing further comprises means for providing virtual educations. Disclosed embodiments further comprising media for e-learning environment to implement learning processes, out of classroom learning, course management, technology enhanced learning, web-based learning, and corporate learning environment. These e-learning are enabled in the form of text, image, animation, video streaming, and audio.

Disclosed embodiments further provide the IMMT in association with the CA configured for categorizing celebrity, science, SMC topics and/or engineering files referenced by initial search results. The IMMT further comprising at least a data modeling tool 100 responsive to categorization. Certain embodiments provide the data modeling tool 100 configured for manipulating icons within at least a graphic user interface module 170 being executable on at least a structured platform further associated with celebrity, science, SMC topics and/or engineering network infrastructure. Some embodiments provide a neural network 220 configured with the data modeling tool 100 and operable for deleting and/or updating at least a structured celebrity, science, SMC topics and/or engineering data. At least one data modeling tool is communicatively connected to at least one array operable for Web browsing. At least one neural network 220 further configured with a decision engine 123 responsive to celebrity, science, SMC topics and/or engineering TOI. Disclosed embodiments provide the neural network 220 further configured with at least one cache engine 350 responsive to at least a downloadable celebrity, science, SMC topics and/or engineering content. Certain embodiments provide the communication readable program 434 in communication with the neutral networks 220. At least one communication readable program 434 further comprising at least a software 300 configured with communication instructions programmed for at least one of: delivering broadcast channel through Internet Protocol Television edge routers, using multicast virtual private networks for at least a broadcast channels, applying at least a multicast label switching protocol to at least one virtual private networks, sharing the same multicast state and providing at least one broadcast channels in communication with each virtual private networks, training each neural network 220 for adjusting at least a correlation of celebrity, science, engineering, SMC topics as a function of at least an activity consisting of at least a topic and/or a product of celebrity, science, SMC topics and/or engineering content.

### Centralized Social Media Network

The search engine platform may also be visualized as a centralized social media NE and marketing environment configured for sharing fashion TOI. The search engine platform would also complement FWM as part of the social media network that allows companies in the fashion industry to capture large audience through the presentation of different brands, trends, styles and the abstraction of reality from all fashion presentations. Specifically, the search engine platform would adopt the fashion Industries to a SMC as a sustainable centralized fashion marketing platform to reach their customers worldwide to accelerate online brand passion, increase fashion passion, and also increase the level and quality of online brand postings and customer loyalty. The search engine platform is a network tool for providing substance of things hoped for, and for revealing the evidence of things not commonly seen to bring fashion cultural change.

The IMMT 400 further comprises a CA 430 in association with a search engine 402 communicatively connected to at least one remote IMMT operatively configured with at least one SS 210. At least one neural network 220 in communication with the search engine 402 and operable for providing services relating to celebrity, science, SMC topics and/or engineering in a social network platform 102. The social network platform is operable on at least a social platform 420 in association with at least a button configured for providing a SNE for at least one of: educational institutions, SMC, local communities, companies and/or agencies, and science/engineering institutions and/or companies in association with each other. At least one SS 210 comprises at least one social platform 573 configured for connecting celebrities, science and engineering students and/or engineering professionals via a centralized NE such as the Internet. Disclosed embodiments further provide the SS 210 operatively configured for project postings responsive to university courses for acting, art, music, photographers, films, science and engineering students and/or responsive to jobs and/or project postings from at least an engineering company and/or science/engineering professional environment. The science and engineering professional environment further comprises an environment for students and/or engineering professionals to socially/educationally be engaged in research projects in association with at least one of plurality universities and/or remote location, whereby at least a centralized communication is associated with the SS 210. The SS 210 is operatively configured for celebrity, science, engineering, SMC data social network, and further comprises at least a chat function 104 responsive to at least the social CE106.

Disclosed embodiments further provide CSMC environment in communication with communication devices operable to receive specific celebrity, science, engineering, SMC topics and enable services and/or functions. Certain embodiments provide a media system that is directed towards a distributed server-based application model in association with varying set of server applications. The server applications further comprise client application configured for communications with client devices being communicatively connected to the IMMT to receive and/or share celebrity, science, and engineering, SMC data over via a communications infrastructure such as the web. Embodiments provide the IMMT in association with servers communicatively configured to provide one or more communication-related services relating to celebrity, science, engineering, and SMC environment for sharing social network TOI. The increasing use of the Internet has become popular for distributing computational data, and the processes involved has made the Internet a commonplace for data distribution since it allows computational burden to be shared across multiple servers and prevents catastrophic single-point community data. Disclosed embodiments further provide the IMMT in association with the CA, comprising a system/platform for distributing celebrity, science, engineering, SMC topics and for sharing knowledge using protocols to negotiate with database servers containing the celebrity, science, engineering, SMC reference documents.

The IMMT 400 further comprises applications being characterized by rapidly varying changing components of a database server 121 associated with TOI warehouse. Disclosed embodiments further provide the database server 121 comprising components of the celebrity, science, engineering, SMC data content being stored, and logically configured for predictions of the client query or loads. The interactive device further includes at least a data bus 200 comprising a platform for writing input into at least a data memory for at least one array to enable enhancement of continued proliferation of powerful and suitable celebrity, science, engineering, SMC topics operation. Certain embodiments provide the interactive device further configured for allowing computational devices to communicate and network via networks connectivity. The computational devices include communications and other portable devices such as wireless telephones, mega telecommunication, personal digital assistants, and automobile-based communications, EDs, and portable devices. The networks connecting computational devices for the instant invention include wireless and wired networks which are formed using land lines such as copper wire or fiber optic cable, and wireless networks which employ earth and/or satellite-based wireless transmission links and a combination of wired and wireless network portions. These networks are organized using a client/server architecture 110 in which server computational devices manage to enable celebrity, science, engineering, and social media networking resources such asocial networking, social media files, data to advance SMC network component, computational SMC data, increasing devices processing power which could be requested by client computational devices such as clients of the network. In this regard, other computational devices not operated directly by an end client such as at least proxy servers, which act on behalf of other machines, could represent either clients or servers. Disclosed embodiments provide the CA 430 in association the software program configured for structured operation, comprising techniques for extracting celebrity, science, engineering, SMC TOI through search patterns from a database such as the Web.

Certain embodiments provide the techniques further comprising one or more TOI that act as the initial seed for the search. Some embodiments provide the database or databases in association with a searchable medium for providing occurrences of the TOI. Other embodiments provide the technique further comprising patterns being identified in the array in which they are stored. These patterns are used to extract more topics from the database and the process can be repeated to search for new topics. Information can be extracted from a database efficiently and accurately with little or no human interaction. Disclosed embodiments further provide the technique comprising a CIM of extracting information from a database. Certain embodiments provide the database being searched for occurrences of at least one topic of information. Some embodiments provide the occurrence of TOI comprising the information that was found and being analyzed to identify a pattern in which similar topic of information was stored. Other embodiments provide the TOI being extracted from the database utilizing the pattern. In some embodiments, the process is repeated until a predetermined number of topics are found or until no new patterns are identified.

Disclosed embodiments provide the technique further comprising a CIM of extracting celebrity, science, and engineering, social, and media community TOI from a database. The database is searched for occurrences of TOI. Occurrences of the TOI that were found are analyzed to identify a pattern in which the TOI were stored. Certain embodiments provide the pattern comprising prefix text, a middle text and suffix text, where the prefix text precedes desired information in the celebrity, science, engineering, SMC TOI and the middle text is between desired information in the TOI and the suffix text follows desired information in the TOI. Additional TOI are extracted from the database utilizing the pattern and the process is repeated for additional TOI. The terminal 022 connected between clients 120 and distributed for communications with servers 00 and 000 through a location-based distributed system. Servers 00 and 000 are configured with key to encode a particular location in a hierarchical grid comprising celebrity, science, engineering, SMC topics. The topics are distributed among the constituent database servers on the basis of the location regions that each server manages.

The database servers are partitioned for celebrity, science, engineering, and SMC topics for communications among the constituent servers. Each server is configured to manage different celebrity, science, engineering, SMC sharing social network topics partitions for distribution efficiency. At least larger clusters are broken down into smaller clusters comprising smaller key groups of celebrity, science, engineering, SMC TOI for logical representation of splitting process through binary tree. Disclosed embodiments further provide the servers 00 and 000 configured for receiving a topic request specifying a particular key group combination that determines if a query should be processed. Certain embodiments provide the request comprising the logical steps needed to respond to the query in case the server 00 and 000 determines that the key group combination is incorrect, or that the query should be communicated to an alternate server. The IMMT 400 is disposed for detailing the steps a client is seeking to determine the appropriate server for a particular key group.

The IMMT 400 is further configured for adaptive load distribution technique based on the representation of celebrity, science, engineering, SMC topics with distributed hash table. The document management tool further comprising information processing apparatus communicatively connected to the memory device 59 for storing digital broadcast content of the reference document for which a number of copies can be made, and include a writing device for writing the content on external recording medium, in communication with an IC medium reader/writer for reading an IC medium and recording the number of copies that can be made of the content on the IC medium in association with the document identifier. The IMMT 400 is further configured for determining whether an identifier of the content is recorded on the IC medium when the content is copied to the external recording medium and, when it is determined that the identifier is recorded, the hash table controls the writing device to write the content on external recording medium and to update the number of copies that can be made of the content and a hash value is recorded in the memory. In the disclosed embodiments, key groups of celebrity, science, engineering, SMC topics are associated with a variable depth of TOI based on virtual network. The network is configured for directing identifiers containing queried celebrity, science, engineering, SMC topics to a particular key group server in association with target servers 00 and 000. The servers 00 and 000 are distributive operable to exchange local signaling messages to determine the particular TOI that is being queried in relation to celebrity, science, engineering, SMC topics.

Disclosed embodiments provide servers 00 and 000 in association with child server configured for exchanging load information from an IMMT 400 operable for managing an active key group of celebrity, science, engineering, SMC topics. Certain embodiments provide a parent server 00 and 000 in association with IMMT 400 operable to split larger key groups of celebrity, science, engineering, SMC topics into smaller clusters. Some embodiments provide the parent server 00 and 000 comprising IMMT configured for instructing the child servers for communications with clients 120 and the parent server. It is contemplated that the mapping of celebrity, science, and engineering, SMC topics include partitions responsive to query keys in accordance with disclosed embodiments. Celebrity, science, engineering, SMC topics being partitioned for representation by the allocation of variable-sized key groups to individual servers 00 and 000. The affinity analyzer 122 could represent an encoding of one or more application-specific celebrity, science, engineering, SMC attributes, on the basis of which the celebrity, science, engineering, SMC topics is partitioned. It is further contemplated that affinity analyzer 122 could represent an arbitrary mapping that has a relation to any semantically relevant celebrity, science, engineering, SMC attributes. Disclosed embodiments may be applied to any form of encoding relating to celebrity, science, engineering, and SMC topics for communications with the affinity analyzer 122. Disclosed embodiments further provide the optional data analyzer 122A comprising operational communication language configured for binary keys relating to digital communications. Certain embodiments provide the binary keys in association with applications relating to celebrity, science, engineering, and SMC topics to be presented for distributions. At least one application is a mobile application.

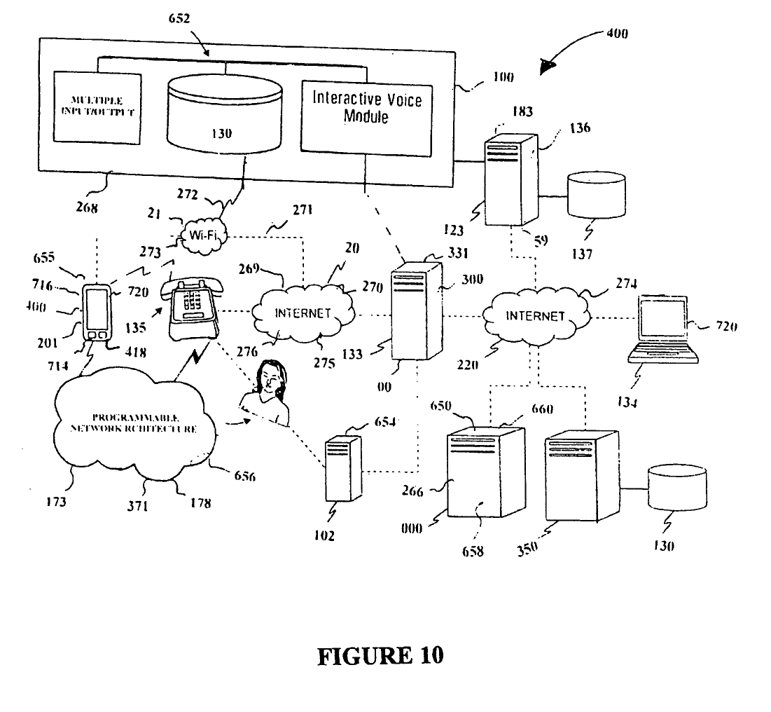

Referring to FIG. 10, is seen the IMMT 400 further configured for optimizing and for sharing celebrity, science, engineering, SMC TOI. Certain embodiments provide the IMMT 400 comprising at least a cache engine 350 operatively configured with at least one array 182, 184, and 186. The cache engine 350 in association with at least a markup language configured with at least one array 182, 184, and 186 for entering searchable celebrity, science, engineering, SMC TOI. Some embodiments provide the CA 430 in association with a spider 173, a crawler 174, each configured for disseminating celebrity, science, engineering, SMC TOI. Disclosed embodiments further provide a web configured for disseminating celebrity, science, SMC topics and/or engineering TOI. Certain embodiments provide the web in association with the CSMC search engine comprising a structured celebrity, science, SMC data distributed in a networking environment communicatively connected to at least one SS 210.

The SS 210 is further configured with at least the indexer 108 and/or a catalog 201 comprising celebrity, science, SMC topics and/or engineering data. Some embodiments provide the data further includes at least one of; fashion, model, products, dress code, brands, styles, awareness, expressions, love, parts purchasing, science and engineering assignments, science and engineering research environment, standard navigation data, social media scheduling, social media forms, media consumption log, mileage log, data to advance components, equipment sales, parts graphics, marketing, name search, sounds, text, video, engineering and/or science TOI, engineering materials and/or tools, and at least an advertisement.

Disclosed embodiments further provide the CSMC comprising a search engine system 402 that includes entity extractor 112, a categorizer 114, and a query generator 116 for managing and for sharing celebrity, science, engineering, SMC data activities such that when a topic on celebrity, science, engineering, SMC data information is queried, responses are retrieved to enrich knowledge, SMC data social media scheduling, generating data to queried SMC data component community data, extracting names of communication desiring a rental car, and analyzing advance SMC data component through a centralized database server 121. The search engine system 402 further comprises an IMMT in association with at least a hardware device 04. Some embodiments provide the hardware device 04 comprising at least one dedicated processing elements 118 configured with at least an input array 182, at least an output array 184, and/or at least a query array 186. Certain embodiments provide the entity extractor 112 further configured to identify a set of entities as described in the engineering. Science SMC TOI may be selected from files, forms, or document content for enabling searching the information related thereto using an information retrieval system 185. Disclosed embodiments further provide the categorizer 114 operable to define an organized classification of the celebrity, science, engineering, SMC files, forms, or document content with each class in the organization of component content having associated therewith a classification label 187. In the disclosure, the classification label 187 corresponds to a category of topics of celebrity, science, engineering, SMC information in the information retrieval system 185.

The categorizer 114 is further configured to assign the selected celebrity, science, engineering, SMC files, forms, or document content a classification label 187 from the organized classification of celebrity, science, engineering, SMC content. Certain embodiments provide the query generator 116 operatively configured to automatically formulate a query that restricts a search for celebrity, science, engineering, SMC TOI. The search could be restricted at the information retrieval system for the particular information concerning the set of entities to the category of celebrity, science, engineering, SMC TOI in the information retrieval system 185 being identified by the assigned classification label 187. The classification label 187 is configured to enable speedy responses to information from the CSMC environment. The CSMC environment is in communication with a CA 430 in association with at least a database 340 consisting of at least information for celebrity, science, engineering, SMC topics.

Disclosed embodiments further relates to science and engineering topics management and sharing of celebrity, science, engineering, SMC TOI through networks of computational devices, and more particularly to database system 340 operable for generating request of celebrity, science, engineering SMC data information, providing at least one topic of information as an example of information associated with at least a communication name in a local existing system 432 desiring a rental car, engineering topics, SMC topics, and retrieving responses in association with the name, the engineering topics, and the SMC TOI such that enhancement of identification of relevant TOI relating to the communication person 434 is made accessible using such the network 20. The network 20 is further utilized for repeating the searching and analyzing and extracting data for additional TOI that is desired in association with the communication person 434. The desired TOI is further provided for tracking the last rental company and/or SMC data information by the named communication person 434 within the centralized communication system 400. Certain embodiments provide the CSMC 400 further comprising standard SMC data for enabling social networking “NR.”

Disclosed embodiments further provide the CSMC environment in association with interactive interface device 170 communicatively connected to at least the CA 430. The interactive interface device 170 further comprises at least a data bus 200 comprising a platform for writing input into at least a data memory 440 for at least an array 182, 184, and 186 to enable enhancement of continued proliferation of powerful and suitable celebrity, science, engineering, SMC topics for sharing operations within a network platform. Certain embodiments provide the interactive device 170 further configured for allowing computational devices to network through the use of networks connections 131. Some embodiments provide the IMMT 400 in association with computational devices, including communications and other portable devices such as wireless telephones, mega telecommunication, personal digital assistants, and automobile-based communications, EDs, and portable devices. The networks connecting computational devices for disclosed embodiments include wireless and wired networks which are formed using land lines such as copper wire or fiber optic cable, and wireless networks which employ earth and/or satellite-based wireless transmission links and a combination of wired and wireless network portions 20 and 21. These networks are organized using a client/server architecture in which server computational devices manage celebrity, science, engineering, and social media networking resources such as science topics, engineering topics, social media files, data to advance SMC data component, media consumption per engine in a fleet, computational SMC data devices processing power which could be requested by client computational devices such as clients of the network. That is, other computational devices not operated directly by an end client such as at least proxy servers, which act on behalf of other machines, could represent either clients or servers.

The CSMC data platform for advancing celebrity, science, SMC data and engineering knowledge, includes social network for enabling celebrities, scientist, engineers, SMC networking, remote communities, SMC data navigation fleet, government agencies, police department, fire department, Homeland security department to network seamlessly in real time through the centralized system. Certain embodiments provide the search engine 402 further configured for extracting celebrity, science, engineering, and SMC TOI from a centralized communication content database having information relating to science topics, engineering topics, and different fashion/model relating to of engines. Some embodiments provide the search engine comprising a CA 430 configured for enabling communication with different systems via personal digital assistant (PDA) and responsive to different platforms.

Other embodiments provide the IMMT 400 operable for enabling Internet and web-based searches for TOI relating specifically to science engineering topics and any fashion/model topics of SMC data equipment, including identifying social media and social networking patterns of a particular equipment in which the topics were stored so that additional topics can be extracted from the database 340 for social network, knowledge sharing, and for aiding file sharing within various science/engineering companies, SMC data companies, and for mining communication data within the centralized communication content database 340. The disclosure further provide a neural network 220 that integrates seamlessly with all existing science and engineering industries, SMC networking, including car rental companies and other remote communities in the nation and around the world through their local existing systems via personal digital assistant (PDA) 432 and enabling these local existing systems via personal digital assistant (PDA) to network and communicate better in real time interaction, real responsive, real resourceful and real responsible to SMC data system analysis, social media scheduling and reprogramming, and monitoring of a communication person's activities through at least a name search

NR further comprises science and engineering social network and web-service application consisting of virtual celebrity, science, and engineering, SMC and businesses analytical tool 08. The tool includes portfolio for celebrity, science, engineering, SMC/social media programs and further comprises of online market place for SMC EC and research distributions. Engineering professionals will utilize this network to assign research projects, assist on projects, and post jobs Skillful use of NR would bring in businesses equal to million times the cost. Commercial motor carriers need the service of NR. NR and website comprises of virtual celebrity, science, and engineering, SMC and business data. The web plan includes search engine comprising of communications, devices, CA, and browsers. The system is configured with a SS 210 for engineering social network, making it easier for people to meet for personal science and engineering topics benefits. Disclosed embodiments provide the SS 210 communicatively connected to communication devices. The communication devices are operatively configured for communications with CA, which include Internet 370 and gateway 433. The IMMT further communicatively connected to an interface comprising network I/O 252. Certain embodiments provide the software 300 further comprising an operating system configured with the CA. The communication devices further associated with database comprising celebrity, science, engineering, SMC TOI. The browser 040 is communicatively connected to the operating system, which is communicatively connected to the network I/O 252 which connects to the gateway 433.

Certain embodiments provide a cache engine 350 communicatively connected to the IMMT 400. Some embodiments provide a cache engine being connected to a query engine 142, in association with a makeup language configured for searching celebrity, science and engineering TOI. The query engine further comprises apparatus for searching and/or entering celebrity, science, engineering, SMC TOI. The spider 173 and a crawler 174 are further provided for disseminating the TOI. The SS 210 is configured for social network and further comprises structured functions, including chat functions 104. The communication device further comprises server 00 and 000 configured with the software 300 for enabling a server tool to communicate with other EDs through the Internet 370. Certain embodiments provide application tool 130 operable for permitting a client to access the database 340. Some embodiments provide a model layer 532 operable for enabling network communications, and a presentation layer 540 for coding data. Celebrity, science, engineering, SMC files are requested from server communications 00 and 000 or “web servers 24”.

The transmission of the files over the web comprises additional Internet protocol 371 called hypertext transfer protocol (HTTP). Disclosed embodiments provide the IMMT further configured for communications with the Internet 370 comprising a substantially free of centralized organization. Certain embodiments provide the server 00 and 000 further configured for hosting web page 25 for the CSMC system comprising of celebrity, science, and engineering, SMC topics. Some embodiments provide the web page 25 being connected to the Internet 370 to further topics relating to celebrity, science, engineering, SMC TOI being routed by the search engine 402 to the database server 121 for retrieval of information specific to the queried TOI from the database 340. The CSMC data system is also configured to enable decentralization of celebrity, science, engineering, SMC TOI and also to allow extremely wide access and an ever-increasing variety science and engineering topics and availability of information relating to various SMC data engines by identifying and locating specific pieces of information on a specific topic such as engine component community data on a particular brand of engine that can be extremely difficult to diagnose. Generally, a database system 340 is developed for communication with search engines 402 and other directories operable for routing celebrity, science, engineering, SMC TOI to and from the server 121 containing the database 340 developed to aid clients 120 in finding specific types of information unique to celebrity, science, engineering, SMC data engines. The database system typically contains entry for web page in association with celebrity, science, engineering, SMC files, forms, or document. The database 340 is searchable relatively quickly without any intervention or the need to retrieve actual web pages in order to perform a search.

The IMMT 400 is further configured with an entry 26 for retrieval of information from the database 340. The entry 26 further includes a network address 27 of the end client page consisting of one or more keywords associated with the page content. The network address 27 may further include a brief summary of the topic of information to be searched. The search engine 402 is further configured to describe any database system to distinguish itself from directory. The search engine would route celebrity, science, engineering SMC TOI from the internet 370 to the database server 121, collecting celebrity, science, and engineering, SMC TOI automatically and using programs such as spiders 173, crawler 174, and/or robots 175. The robots 175, spiders 173, and/or crawler 174 are configured to visit web pages 25 and collect the needed data by downloading files 110 in relation to the queried TOI and also process the file. The CSMC environment further comprises a process-driven search engine for routing celebrity, science, engineering, SMC topics and for managing data relating to science codes, engineering code, SMC codes and modules. The celebrity, science, engineering, SMC further comprises data management system that includes a server repository platform 28 operable for storing science information, engineering information, and also engine information. At least one of the information is a plane having components each describing a respective science codes, engineering codes, and mechanical community data codes.

In the disclosure, embodiments provide the IMMT comprising easier means for employees to discuss TOI relating to celebrities, science, and engineering, SMC networking to share files and data resources through a centralized celebrity, science, engineering, SMC data network system 20 and 21. The shared network will enable communication with every SMC networking, every garage, and all commercial SMC companies, engineering companies, and science companies seamlessly through a resourceful time sharing via shared Internet access. The CSMC further includes server-based network to enable reliability of data to local and distanced celebrity, science, engineering, SMC networking. The server network 20 and 21 is operable to connect industrial employees through a local SNE to connect to TOI resourceful to their business operations, providing navigation programs and preventive navigation, providing step by step social networking procedures for advance searches. The database 340 is accessible through desktop communications, notebooks, wireless devices, and electronic image processing devices from any state in the U.S. and any part of the world. The decision engine 123 is further configured to format a response to a request in a manner usable and readable by client 120. Disclosed embodiments provide the decision engine 123 further operable for converting celebrities, science, and engineering, SMC TOI to at least one of: Wireless Application Protocol (WAP) format, HTML document, XML document, Voice XML result, HTML, EHTML, Java, and Java script, including any other format that the client device may be capable of interpreting. Internal communications within the central processing unit “CPU” 51 are disposed with high speed and high bandwidth networks. The CPU 51 is configured for communications with other appropriate protocol operable for permitting the IMMT 400 to respond to large number of distinct requests simultaneously, or near simultaneously. Certain embodiments provide the IMMT 400 further configured with the CPU 51 operable for allowing scalability. Some embodiments provide the CPU 51 comprising a split system for allowing scalability. Other embodiments provide the CPU 51 communicatively connected to the IMMT 400 for providing operations for network 20 and 21.

Disclosed embodiments provide the wireless communication device 30 further operable for generating requests and for receiving and using information being generated in response to the requests. The wireless communication device 30 is configured to receive and transmit information wirelessly using transmitters 70. The transmitter 70 further comprises output device in communication with a read out tool 08. The read out tool 08 further comprises digital signal processor (DSP) circuitry. Normal voice communication is routed to or from the media device 201 in communication with a speaker/microphone 63. Certain embodiments provide the media device 201 in communication with network interface module 170. Network interface module 170 is further configured to handle all communication with the client, including voice, visual, and data entry communications. Visual presentation of celebrity, science, engineering, SMC TOI is provided via a display screen 003. General data entry is provided through the keyboard 11 comprising interactive interface and or voice recognition or by voice data 12. The IMMT 400 is further configured with appropriate control keys 13 for performing necessary control functions configured for invoking celebrity, science, engineering, and SMC topics. Disclosed embodiments provide the control keys 13 comprising push-buttons, joysticks, and touch-sensitive panels. Certain embodiments provide the control keys in association with multiple interface modules 172. The wireless communication device 30 is configured with communication network applications, including browsers 040, input devices 80 and output devices 70, such as games, applications to assist in dialing numbers, and applications to permit web browsing, including the entry of data as part of the web browsing. The applications may be stored in ROM 02, RAM 05, EPROM 03, Flash memory 04, MRAM, EEPROM 06, or otherwise, as appropriate, and may also be accessed by the wireless communication device 30. Some embodiments provide the keyboard comprising a dialing module 108 configured for providing standard dialing functionality and for receiving entered dialing digits or voice dialing instructions for communication with interface module 170. The interface module 170 further comprises a network interface module being further operable for providing audio/visual signals. The network interface module 170 is further configured for communications with output devices 70. The application layer 530 is configured to receive data other than dialing instructions. Disclosed embodiments provide the dialing instructions comprising search data 126 being entered into the search column 21 of the IMMT 400 or a wireless communication device 30. The application layer 530 is further configured to provide the entered data to the servers 00 and 000.

The Web context is configured based on queries, such that, when a client submits a query containing celebrity, science, engineering, SMC TOI, the search engine 402 would respond with a list of links pointing to information resource for the web page hosting being derived from matching entries on celebrity, science, engineering, SMC TOI in the database 340. Disclosed embodiments provide the term “link” in association with any representation or symbol representing at least an address that points to the location of an information resource, such as the web page 25. Typically, a link on a Web is a pointer found in one file which references another file. The link on the Web commonly refers to a Uniform Resource Locator (URL) comprising the global address for science engineering, SMC files, forms, or documents and other resources commonly accessible on the Web. The centralized celebrity, science, engineering, SMC data network system comprises direct attached storage medium coupled to the server hard drive configured with a network attached storage to consolidate files stored for sharing. The server software 300 is further configured to periodically dump files into a backup server for future use.

Disclosed embodiments provide the server repository platform 28 further comprising sets of tools for performing innovative renovation of celebrity, science, engineering, SMC topics, including analytical breakdown of possible data for the topics information. Certain embodiments provide tools associated with celebrity, science, engineering, and transformation social network system comprising a process-based interface with celebrity, science, engineering, SMC TOI on the web. The web is accessible by end clients and includes a social platform 420 configured for advancing celebrity, science, engineering and/or SMC knowledge. Some embodiments provide the interface module further configured with the SS 210 operable for mapping desired communications using Protocols, Processes, and Plans. Disclosed embodiments further provide the Protocols comprising constructs of stored scripts for invoking a respective scripted tool to execute a particular function. Some embodiments provide Protocols comprising a software module being operable to provide input parameters for retrieving relevant celebrity, science, engineering, SMC information. Other embodiments provide the Protocol further comprising programs for generating an output parameter of the function invocation specified as variables being supplied at the execution time of the topics. In other disclosure, embodiments provide the search engines 402 in communication with communication applications, including spiders 173 and/or robots 175 configured for indexing the different elements of web sites on the Internet 370 and for gathering content information for database 340. The search engine robot is configured to index significant number of information resources in the Internet 370. The robot is further configured for updating links to the database 340 in a queried dependency manner so that celebrities, science, engineering, SMC TOI are shared effectively.

In a typical searching sequence, communication is established over the network between at least a client and IMMT 400. Some embodiments provide the establishment comprising CE that includes a web browser program on the client machine. Other embodiments provide the establishment being associated with a search criteria being entered by a client of the client machine and transmitted to the search engine server 402. The search engine server is operable for searching the information available on the network consisting of celebrity, science, engineering, SMC TOI. The client may, for example, access particular web pages that are included in the results directly over NE as desired by the client. Disclosed embodiments provide processes comprising constructs that store celebrity, science, engineering, SMC topics definitions comprising descriptions of particular tasks to be performed. The task to be performed is described using one or more protocols and/or one or more other processes. In the preferred embodiment, the Protocols, Processes, and Plans are each stored as engine/engine in the celebrity, science, engineering, SMC data management system repository for updating connectivity to the database, for updating the range of the assignments when a connection is disabled or enabled, and for processing signal connectivity to updating execution of prescribed functions corresponding to updating functions in response to the operational set mode signals for generating matching data to defined science topics, engineering topics, SMC data advance components. This engine, which comprises celebrity, science, engineering, and CSMC system components, are stored in a manner that is similar to the way in which the Asset components describing the software modules are stored. Furthermore, the associations between Protocols, Processes, and Plans are stored as relationships between the respective CSMC environments in a manner that is similar to the way relationships between the software modules are represented for celebrity, science, engineering SMC topics.

In another preferred embodiment, the definition of the CSMC data engine further comprises a centrally driven engine for routing celebrity, science, engineering, SMC TOI to end clients, providing a CN system for science and engineering schools-universities-professional environment, SMC networking. Each of the engines for the CSMC data engine comprises a System Components, as well as the relationships that may exist between the components, being created using a pre-defined element type of the topics information or relationship type definition that is also stored within the repository. In one disclosure, embodiments provide a CIM of extracting and sharing celebrity social, science social, engineering social and SMC of fashion TOI from a database. The database is made searchable for occurrences of at least one topic of information. An occurrence of a topic of information that was found is analyzed to identify a pattern in which the topic of information was stored. Additional TOI are extracted from the database utilizing the pattern. In some embodiments, the process is repeated until a predetermined number of topics are found or until no new patterns are identified. The model definition simplifies the system design and makes operation more robust because the various tools in the system is configured to be synchronized with the element and relationship type definitions instead of having to be aware of special-case and particularized element descriptions. Additionally, modifications to the components can be more readily accomplished because a whole class of element definitions can be modified by making a single change to an element type definition. The type definitions further allows the automated Plan development tool to efficiently query the client for process and other Asset element selections. The collection of search result includes a web file module 401 and a data address 131 of celebrity, science, engineering, SMC TOI. The web file module 401 includes a web browser that serves as a label for the search results. In this example, the web browser is configured with the web file module 401. Celebrity, science, engineering, SMC topics are entered in the web browser and presented to indicate the required query word being search to ensure that results matches the search term that was originally entered by the client when specifying network search parameters. The search engine 402 would search the indexer 108 for instances of celebrity, science, engineering, and SMC topics identified from the appropriate index entries. The indexer 108 providing contextual data to the client interface module 172 comprising the relevant information pertaining to the identified entries.

### Fashion Cultural Change

Change would be embraced through trust in fashion media, model media, and dress code media with the hope for sustainable community cultural independence and economic vision. Trust is a very crucial component of fashion marketing and the search engine platform would further provide an environment where fashion industries, fashion outlets, brands, and trends are easily accessible, providing an ideal SS for building and sharing consumers trust and loyalty. The search engine platform further configured to provide an ideal environment to distinguish between brands and styles in support of social media by offering promotions, perks, and discounts for various fashion models and professional dress codes to impact corporate awareness. The application of the search engine on a social media platform would be an effective SS for brand success and business awareness, sharing community social measurements to bring generational awareness and to improve CCI to impact economic values.

The search engine platform is a SS for revealing CHANGE in the fashion industries to the fashion world so that fashion brands could be embraced for sustainable community cultural and economic independence. In order to maintain customer base, FWM is immersed in the search engine platform as a social media SS for sharing knowledge relating to fashion media, model media, and dress code media.

The FWM is providing this platform for the fashion SMC as a sustainable centralized fashion tool to reach worldwide audience to accelerate online brand passion, increase fashion passion, increase the level of online brand postings, and improve customer loyalty. The platform is a NE that allows individuals and companies in the fashion industries to capture large audience through the presentation of fashion brands, fashion trends, fashion styles and brand awareness through the abstraction of reality to envision future fashion models. Let your positive public declarations bring out social measurements that may lead to generational awareness, brand awareness, leadership awareness, business awareness, corporate awareness, educational awareness, professional awareness, ethical awareness, religious awareness, institutional awareness, social awareness, cultural awareness, sociological awareness, casual awareness, and service efficiency to the society. Fashion isn't defined solely by clothing choices, but it is also conveyed through the way we carry ourselves, our personalities and our views of the world. Fashion comprises of a prevailing styles, customs, dresses, or behaviors, and these may be fashioned and shared to change the way knowledge is derived about an objects.

Further comprising FMDC network consisting of a dynamic database driven social network platform for interactive web content creation, collaboration, and exchange. In this manner, a user is allowed to login, create an account, and upload information. Once the user's information is uploaded, a web page would be created for that user. The user would then be able to distribute or connect with others with whom he/she had exchanged cryptographic public keys with. The connection and/or distribution are allowed within FMDC NE. The web page creation is the user's virtual private network “VPN” within FMDC network. The user may use the public network such as the Internet or wireless device to connect with other users at remote sites through FMDC network and share or discuss FMDC TOI. The VPN is to connect users in the network with other users in the network, while providing better features such as:
Security
Reliability
Scalability
Network Management
Policy Management

The architecture of the Social VPN is configured for communication with FMDC centralized infrastructure where users would authenticate, once the account is confirmed, they would then be allowed access to the system and be discovered by their friends whom they have exchanged their cryptographic public keys with. The FMDC network further includes a peer-to-peer overlay used to route messages and to deliver videos between VPN endpoints.

Some embodiments provide profiles relating to user profile, user social links, web based services for users interactions over the internet, including e-mail, instant messaging, online community services, means to connect with friends, live chat, and means to connect with present and/or former school mate; career oriented peer-to-peer interactions; user recommendation system linked to trust; a link that allows sharing of information and ideas; be able to share visible profiles with a list of “friends” who are also users of the FMDC; means to generate a profile from answers to questions such as age, location, interests, etc.; be able to allow users to upload pictures, add multimedia content or modify/enhance the look and feel of the profile; be able to allow users to post blog entries, search for others with similar interests and compile and share lists of contacts; user profiles dedicated to comments from friends and other users; be able to upload or stream live videos; ability to create groups that share common interest or affiliations; be able to hold discussions in forums; a control that allow users to choose who can view their profile, contact them, add them to their list of contacts; a mobile community for mobile phone users to create their own profiles; an interactive community environment to connect individuals based on shared business needs or experiences, make friends, and participate in the FMDC environment; services that allow customers to build their own mobile community and brand it; a real-time that allows users to contribute content for live world broadcast, means for Interpersonal communication, E-COMMENCE MARKET PLACE.

Searching the indexer 108 may employ matching algorithms to search on the identified search term, and may further include identifying terms related to the search term or terms likely to be selected by the client in the future. Selected future topics are similarly searched in the indexer 108 on the terms relating to celebrity, science, engineering, SMC TOI. The web file module 401 is further configured for communications with the decision engine 123 being operable with the search program 39 configured for web browsing. A client may reference the web browser 040 and the decision engine 123 to make a determination responsive to celebrity, science, engineering, SMC TOI. The decision engine 123 may represent a portion of a web page, stored files, e-mails, telephone numbers, electronic books, science and engineering text, etc. relevant to the TOI. The data address 131 is configured to specify the location of the associated content relating to the topics being queried. Disclosed embodiments provide the data address 131 being operable with an address designator 020 comprising URL. Certain embodiments provide the address designator 020 being operable for identifying servers 00 and 000 that houses the content identified by the search engine 402. In this manner, display 003 comprises an area being conserved for search result to be presented.

Disclosed embodiments provide cached database further comprising copies or partial copies of content that the CPU 51 has identified. In one embodiment, the cached database may contain web pages or portions of web pages comprising textual content, non-video content, audio content, visual content, and video content. The cached database is further configured to connect client 120 to the IMMT 400 to request copies of the content rather than remote copies, which may otherwise require making direct contact with the content provider. The IMMT 400 provides information for various Internet applications 370, including system parameters, and information about registered clients. Disclosed embodiments provide the SS 210 further comprises a media control device. A communication search program 39 is configured to manage the operation of the CPU 51, in association with the search engine 402 and media control device 201 and the client interface module 172. The search engine 402 and media control device 201 include a crawler 174 communicatively configured with network 20 for requesting electronic documents from the servers 00 and 000. Content from crawler 174 is stored in the index database 132 or cache database 133 for further searches or retrieval. Contents from crawler 174, is classified according to the electronic format being provided for various applications such as mobile device applications, desktop applications, or wireless device applications. The search engine 402 and media control device 201 are logically configured for communications with the indexer 108. The client interface module 172 is further configured to prepare electronic content for presentation on the display device 003 responsive to client input. In one embodiment, the client interface module 172 may prepare search result elements for presentation to a client in response to a client's tendered search query request. The client interface module 172 may determine the appropriate celebrity, science, engineering, SMC topics format, layout, arrangement, selection, quantity, graphic type, and grouping of the topics for presentation via display device 003 of the client 120. The client interface module 172 is further configured for determining whether to include additional celebrity, science, engineering, SMC TOI relating to the client search result. The client interface module 172 is further operable for routing client input data or for routing any selections from the client 120. Selections may be retrieved with the mobile device 30. Alternatively, the client interface module 172 could reside on the client 120, rather than within the central processing unit 51. The software 300 is further configured to allow the server tools to communicate with each other for effecting permits users to perform search task.

The tools are configured for communication with the ROM to provide security and reliability on the industrial files and folders. The file or folders are in association with the database being coupled with a primary domain controller “PDC”, or another set of file/folder server for keeping records. The PDC centralizes network CA, enabling a centralized communication engine for allowing scientist, engineers, SMC networking, remote communities, SMC data navigation fleet NR, government agencies, police department, fire department, and homeland security agencies to network seamlessly through a centralized system and for extracting and sharing social media TOI for social networking within a centralized communication content database. Detected data referencing at least a communication desiring at least a SMC topic of information may further comprise fashion topics made available to the community, the government, other agencies, businesses and/or homeland security agencies, enabling these agencies to thwart SMC data and other activities involving fashion social communications. The database further provides data to clients of the networks to be monitored by at least a cache engine. The cache engine enables finding other patterns in which the communication carries other activities. The network adapters provide the physical connection to the network 20 and 21, locating the physical addresses of industrial communications or other devices. The PDC is configured to receive the industry's names and passwords at the initial logon screen. Disclosed embodiments provide the PDC further operable to create security identification that will set the permission and rights for clients of the network and industrial services. Connectivity to the network is allowed through protocol communication, permitting data to be sent through the network adapters into cables or other wireless means. The network interface 170 is further configured to pull out or put into network adapters the queried data through the cables without any internal protocol. The communication process from one network communication to the server 00 and 000 operable for retrieving data passes through model layers that are assigned specific task to the layers. The application layer supports files, application services, print services, message services, and database services before they are sent to the presentation layer 540. The transport layer 560 is operable for delivering the queried data to the end user. The network layer 570 is in communications with routers configured for moving data through the Internet 370. The Internet protocol layer is configured to encapsulate the search packages into data-gram that will run through its algorithms into the database problem and data addresses.

Server 000 and 00 are operatively configured with a cache engine 350 and communicatively connected to a query engine. The cache engine further configured to provide easier and faster means of delivering the desired celebrity, science, engineering, SMC contents of the TOI relevant to the desired queried topics. The cache engine identifies celebrity, science, engineering, SMC topics from the user selections within the network 20 and 21. The cache engine further downloads content that matches user defined preferences and enables communication with the servers 000 and 00 for data transmission. The servers are embodied in the system through which at least a background task is enabled to allow a posting for allowable task to be performed by at least a registered user. Server 000 and 00 are further configured with registration module, a monitoring module, a search module, and a communication module communicatively connected to database 340. The network 20 and 21 further includes the Internet being connected to at least a web-enabled device having at least a browser operatively configured with the cache engine in communication with a client.

Server 000 and 00 and the query engine are further configured with filters which are connected to nodes which are coupled to the Affinity Analyzer to determine which components are involved in the processing performed to accomplish a particular function or task associated with celebrity, science, engineering, SMC sharing social network TOI. The Affinity Analyzer further configured to provide graphic expressions comprising display representing the various components and element relationships for code and data components provided by the database platform. The graphical displays are enabled to illustrate complex fashionable element of celebrities, science, and engineering for the SMC, further comprising components of drawings to be displayed on the networks 20 and 21. Certain embodiments provide the graphical display further configured for advanced impact analysis of celebrities, science, engineering, and the SMC, sharing social network TOI, and providing data relating to the queried data. The system allows code modification and before a particular code module is modified, the relationships existing between the associated elements that models that code module and other components may be used to determine which other code or data components need to be modified to maintain system's compatibility and efficiency so that all other end users would communicate through the CSMC environment seamlessly and in real time. At least one code modification is an image code responsive to filtered images and/or frames. These relationships may be graphically depicted using the Affinity Analyzer 122, which allows software analysts to interrogate and visually mine single or disparate sets of components without having to understand the details of the components or relationships involve.

Referring back to FIG. 7, the CSMC further comprises the Element Locator 125. This tool uses Natural Language Understanding (NLU) technology to locate science and engineering topics and also to potential data for advancing components of fashion, model, and dress code. This makes the SMC sharing social network TOI stored in the memory more accessible to other user environments because the details of the stored information or the structure of the information has to be known outside the centralized system. The Element Locator 125 is operatively configured with the component inventory 102 and communicatively connected to the Affinity Analyzer 122 to enable performing a very efficient concept such as search, using application domain mappings stored in the system's database shelves 70. The Process Manager 126 is rules-based tool that allows a user to define the centralized celebrity, science, engineering, SMC environment. At least one rule includes protocols to activate various processes that are in the database shelves 70. In the preferred embodiment, the server 00 and 000 is a web-based system having a “web-like” interface, although other types of interfaces, graphical or non-graphical, could be utilized.

Disclosed embodiments provide a communication engine for users of the network to invoke scripted tools by specifying a desired outcome instead of by specifying particular tool sequences. Thus the complexity associated with locating, transforming, processing, and managing the code and data modules of various SMC files are largely hidden from the user. However, any resulting program(s), having communication-readable program code, may be embodied within the IMMT 400. Certain embodiments provide the IMMT being communicatively connected to the processing module, in association with the SMC environment. The memory devices for the CSMC system include, but are not limited to, fixed hard disk drives, floppy disks, or zip diskettes, optical disks, magnetic tape, semiconductor memories such as RAM, ROM, Proms, etc. Transmitting devices for the CSMC data system include, but are not limited to, the Internet, intranets, electronic bulletin board and message/note exchanges, telephone/modern based network communication, hard-wired/cabled communication network, cellular communication, radio wave communication, satellite communication, and other stationary or mobile network system communication links. A machine embodying the CSMC data system may involve one or more processing system including, but not limited to, CPU, memory and storage devices, communication links, communication and transmitting devices, servers, I/O devices, and/or any subcomponents or individual parts of one or more processing system, further including software, firmware, hardware, or any combination and/or a sub-combination thereof, which embody the CSMC data system and the CSMC environment for routing celebrity, science, engineering, SMC sharing social network TOI.

Moreover, because protocol and processes are defined and managed as part of the SMC environment, the impact-analysis operations that are performed when tools, code modules, or data modules are modified or deleted are largely simplified to make complex task more simplified. Included in the Workbench are functions that allow the user to manage, view, and report all the components and element relationships existing within the SMC networking. These tools include SMC discovery Functions “SMCDF” 143. SMC discovery refers to the process of initially creating components and their relationships among other components in the SMC management system. Generally, SMCDF will analyze a target group of SMC via software and data constructs and the interrelationships between these constructs. SMCDF is configured to automatically create components associated with the code and data constructs. If the servers are model driven, the SMC data discovery function 143 will utilize the various element type definitions stored within the model, such as a program or database to create the components. Each of these components may include meta-data 114 that describes the location and function of the associated code or data element. This meta-data further describes the relationships that an element of the SMC has with other components, wherein each element relationship models the relationship between the associated code or data construct and other code or data constructs represented by the related components. The SMC data further associated with functions 143 configured to sort or create a group of components that may be stored within the Server Database shelves, and which may become available as part of the system knowledge base to manage the associated code and data components. More specifically, the embodiments provide the IMMT operable for utilizing TOI to identify patterns in which the topics were stored so that additional topics can be found. However, embodiments are not limited to any particular celebrity, science, engineering, or SMC topics, applications or specific implementation. Therefore, all descriptions of disclosed embodiments are for purposes of illustrations and not limitations.

Embodiments provide the search engine configured for solving celebrity, science, engineering, SMC data relating to TOI over the web and for advancing online destination services where other celebrities, science, engineering, SMC, and businesses will take advantage of the growing variety of the centralized services. Centralized services are important to knowledge distributions, industrial efficiency, profitability, resourcefulness, and celebrity, science, engineering, SMC success, including homeland security distributions of knowledge. Embodiments further provide process comprising the integration with Internet Technologies to enable social media and SNE comprising the SMC. The SMC further comprising a centralized digital workplace configured to offer the next level of SMC data exchange to queried topics. Search results are produced through the social interaction between plurality tools.

Some embodiments provide the SMC further comprising a platform for distributing data files, forms, or document s or files described in the initial results to be retrieved by clients via network servers 00 and 000 through a transmission medium 27. The search engine 402 may include one or more of the following: a Network interface 170, a SMC data decision engine 123 operatively configured with the affinity/data analyzer 122, databases 130 and 340, a report generator 124, and a payment module 104. The Network interface 170 connects the search engine servers 00 and 000 to the network 20 and 21, preferably a communication network, such as the Internet. The Network interface 170 is further configured to connect with networks such as wireless networks, television networks, telephone networks, satellite networks, local area networks, and other networks.

The decision engine may comprise neural network-based algorithms that are effective in several applications including: diagnosis or pattern recognition such as speech and image processing, because the neural network algorithm is further configured for adjusting to patterns in data transmissions. The neural network is further configured to deduce relationships between the different data variables, e.g. estimation or prediction applications even when difficulties exist in completely specifying the rules for science and engineering topics, including engine fashion/model relating to. The neural network is further configured to assess interrelationships between science and engineering factors and predict outcomes with significant accuracy. The neural network is further configured for processing large amounts of data in real-time. Once the training set for the neural network is developed, the learning algorithm trains the neural network by creating a network of associations between possible aspects of input relating to celebrity, science, and engineering, SMC sharing social network TOI to enable responses thereon. Disclosed neural network is more flexible than traditional programming methods used in prior art devices because the neural network is scalable and can be reused for solving other celebrity, science, engineering, SMC problem domains. Disclosed embodiments provide decision engine 123, further comprising components of: 1. A Java storage and retrieval (JSTAR) Class 023. 2. A ClicknVestServlet class 032. 3. A Servletrunner application 034. 4. A Trainer Module 036. 5. A Retrainer Module 038.

The network 20 and 21 comprise any distributed communication network such as a local area network (LAN), a wide area network (WAN), or other connection services and network variations such as the Internet, the World Wide Web, communication network terminal devices, such as personal communications, workstations, servers, secondary-communications, primary-frame communications, laptop communications, mobile communications, palm top communications, hand held communications, set top boxes for a TV, or a combination thereof, a touch screen, a keyboard, and a mouse, output devices, a value-added network, and the like.

Embodiments provide IMMT 400 for the network communications operable for providing specific SMC data relating to celebrities, science, engineering, SMC TOI commonly sought by a user. Typically a user seeks to access specific celebrity, science, engineering, and/or SMC data stored in one or several content servers. However, often the situation arises where the user does not know which content server or even where within a specific content server the data resides. To identify the location of the desired data, the user will usually request a search engine server to identify a set of links that are relevant to the user's desired information. To accomplish this, the user utilizes a network terminal to establish a communication session with the search engine server via the network 20 and/or 21. Having established this communication session, the user then inputs a query into a browser 040 for communication with network terminal, which transmits the query to the search engine server 00 and 000. The search engine server processes the query according to any one of a number of well-known algorithms and transmits to the user a list of links pointing to information resources such as science and/or engineering topics, and/or SMC files, forms, or documents on the database 340 and 130 that may be relevant to the user's query. The links are usually retrieved from a database stored in, or at least accessible through the search engine server. From the list provided by the search engine server, the user then selects at least one link that appears pertinent to the desired celebrity, science, engineering, and/or SMC sharing social network TOI.

When the user selects the link, the network terminal makes a request to the content server associated with the selected link to transmit the celebrity, science, engineering, and/or SMC files, forms, or documents from the database. A controller is provided and configured to coordinate the functionality of the links to the database, the indexer, the robot, and the queue. The controller may comprise any commercially available processor, such as a Pentium Pro. At least a memory is communicatively connected to the processor, and may be in the form of a cache memory for rapid access to the cached or stored information, or other type of memory, such as a dedicated hard disk, or a combination of both. The robot is a software module that is configured for accessing celebrity, science, engineering, SMC files, forms, or document s stored in the content servers 00 and 000, and identified by the links stored either in the database or the queue. The Robot gathers the data stored in the n files, forms, or documents and forwards it to the indexer. Software modules such as robot are well known in the relevant technology, but not for the services of the disclosed embodiments.

Robot is also known in the relevant technology by the names spider, crawler, wanderer, or gatherer. However, in one embodiment of the instant invention, the queue contains a list of links such as a subset of the links stored in the link database which the robot uses for updating purposes. The queue may be at least a file which is preferably stored in the memory of the search engine server 402. The indexer is configured to receive data such as web pages retrieved by the robot, and extracts some portion of that data that is used to associate a given link with the information on the file to which the link refers. That is, usually the indexer identifies individual words from the text of a file or, in the case of a web page; the indexer retrieves the text stored in the keywords or the description fields of the web page. The indexer is operable for indexing each SMC files, forms, or document to associate the link with the extracted data and stores them in the link database 130. Indexing programs that perform the functions of the indexer are well known in the pertinent technology such as the Ultra seek Server™. Indexer produced by Infoseek Corporation.

In one embodiment, the robot uses the links stored either in the link database or in the queue to access the files, forms, or documents stored in the content servers and optimize the freshness of the links being displayed in response to a user query. The robot then forwards some or all of the data associated with the files, forms, or documents to the indexer. From this data, the indexer would extract any data it needs for association with the respective link that identifies the files, forms, or document. The indexer is further configured to store the associated data and link in the link database 130. In one embodiment, the indexer may compare the data already stored in the link database 130 against the new data gathered by the robot. If there are any discrepancies in the data, the indexer would store the appropriate updates in the link database 130. Certain embodiments provide the indexer further configured for communications with the webmaster to prevent data modification in association with the files, forms, or document.

The indexer does not modify the contents of the link database. In another embodiment, however, the indexer may simply inspect that the link is still valid. That is, the indexer only verifies that the robot was able to access any data by using the respective link pointing to given files, forms, or documents. Thus, in this manner the robot, the queue, and the indexer collaborate to refresh the contents of the link database. The decision engine operation may be executed on a Microsoft Windows 95®-based personal communication or other Java compatible platform, including Microsoft NT® Server, Sun Station®, IBM RS/6000®, and/or other platforms. The decision engine may be incorporated into a kiosk system. The decision engine recognizes patterns and relationships within a set of input data or responses of TOI and estimates and/or predicts outcomes. The SMC decision engine may also process a large number of variables such as queries and responses and be able to deduce the interactions between the different variables. The relationships between numerous variables are enhanced to formally define automobiles, trucks, planes, marine engines etc. in linear relationships. The decision engine may be trained to handle the numerous variables and can self-adapt and sort through data to produce an understanding of the factors affecting these data.

The SMC environment in further association with a decision engine 123 for incorporate a scalable, robust, customizable, quick, simplicity, flexibility, and efficient architecture for large scale memory, retrieval, and classification problems. The SMC decision engine 123 is scalable by adding more self-organizing maps defining the various celebrity, science, engineering, SMC variables and the associate variables to the training set and re-training the celebrity, science, engineering, SMC neural network Unlike traditional programming techniques, the SMC decision engine's programming code need not be changed. Embodiments provide the re-training in association with the decision engine 123 to provide greater flexible without requiring further reprogramming. The celebrity, science, engineering, SMC database further associated with the decision engine 123 to infer new behavior and deduce patterns and relationships in the database. The decision engine 123 includes two Java classes: the JSTAR class 023 and the ClicknVestServlet class 032. The JSTAR Class 023 is a Java class that is also called a JSTAR Java Servlet. The JSTAR class 023 is an object-oriented, Java language based application.

Browser program 040 on client may be, for example, a web browser which allows a user to retrieve and view files on the WWW, or a program which performs a similar function on some other network. In some embodiments, client functions involved in implementation of the methods described herein are included in browser 040. For example, browser 040 preferably provides a framework for communication between server-side search program 39 and client-side search program 38, typically by calling an appropriate additional program. Browser 040 or a program called by the browser may include user-settable options as to whether additional client-side searching is done real-time or at a later time, or whether it is done at all. Other options could include whether the additional searching is done automatically by the program or at least in part manually by the user. Such functions, and/or other functions of the client computing device, may also be implemented in separate program instructions such as program instructions 26 or client-side search program 38. Disclosed embodiments provide the IMMT 400 further configured with memories for storing files 18 in association with various files stored on the client computational device, including files downloaded from information content servers 00. Files 18 may also include other files suitable for use in communicating across the network or in identifying stored information accessible using the network. For example, a file including initial search results sent from server 000 may be included in files 18, as may a file containing data associated with additional search results be produced using client-side search program 38. Client is typically associated with an output device 70 and input device 80, particularly in embodiments for which the client computational device is operated by a user of system 10, 20, 30, 40, and 50. Output device 70 may include, for example, a display screen 003 and/or a printer. Input device 80 may include, for example, a keyboard 009 and/or a pointing device such as a mouse 11.

The trainer module 036 trains the neural network. The optional trainer module 036 may be an integral component of the celebrity, science, engineering, SMC decision engine 123 or it may be a separate component. The decision engine 123 may also be trained without a training module 036. The optional re-trainer module 038 may use the queries, responses, confidence values and/or other factors to fine tune the decision engine 123. The re-trainer module 038 may be an integral component of the decision engine 123 or it may be a separate component.

### Fashion Brand Names

Brand names would gracefully embrace change made through creative minds as a path to economic growth, not as a means of inquiry, but rather as a dimension of social sustainability to gracefully improve corporate and CCI through economic vision provided by the search engine platform for the FWM. The search engine platform further provides a CE for individuals and groups such as colleges, universities, churches, stores, organizations, cultural entities, businesses, entertainment/sport entities, events, corporations and more, to present the positivism of their product brands for representation in a social media environment that is defined by fashion media, model media, and dress code media. The platform further allows these groups to post the uniqueness of their product offerings and the positive aspect of these products through the centralized system to bring out social measurements that would lead to generational awareness, brand awareness, leadership awareness, business awareness, corporate awareness, educational awareness, professional awareness, ethical awareness, religious awareness, institutional awareness, social awareness, cultural awareness, sociological awareness, casual awareness, and service efficiency to the society. Let the world capture fashion power trends by prioritizing model-related products and beauty services. The FWM brings to light a platform for capturing power trends, a SS for positive public declaration of fashion styles, brands, and trends through a centralized communication hub to strengthen brand awareness, generational awareness, corporate awareness, and community awareness through a social networking environment. The social networking environment comprises of fashion media, model media, and dress code media, to be presented by individuals, designers, professional models, fashion outlets, businesses, corporations, and other groups for public observation. The FWM is launched to provide the cosmic powers of social media through fashion expressions and trend predictions to empower the world and impact casual awareness and CCI.

The databases 130 may include vendor data, market data, and buyer data. The databases 130 may be partitioned into one or more databases, such as a vendor database 136, a user database 137, a market database 138, SMC model and make database 139. The vendor database 136 may include information about the vendor, the products that the vendor carries, vendor specific pricing and options, and the vendor's Internet site address. The vendor database 136 may also include detailed information about the products and services offered, including price, features, brand names, delivery methods and including on-line, store front, or via distributors, availability dates, and other information.

The user database 137 may include information collected about the users. For example, the user database 137 may include information about the user such as company, business type, years in business, age, income level, gender, address (home and/or office), and planned purchase timeframe. After the user has used the CSMC search engine server 000 to compare products or services, the user database 137 may include the user's preferences entered in the selection process and the user's down-selected list. The preferences of multiple users may be used to develop trend information that is stored in database 139. For example, the trend information may show that 80% of users want on-line CSMC EC shopping or ware house, 50% of users want interest bearing checking accounts purchase orders. After the user has purchased a product or service via the CSMC search engine server 000, the user database 137 may include information about the user's prior purchases. The user database 137 may also contain other user information such as the user's purchasing preferences obtained from other sources.

The market database 138 may include information about trends in the market place. For example, the market database 138 may include information about a trend among CSMC EC shopping or ware house features. The databases may include market intelligence database syndication, distribution and licensing of buyer data, vendor data, product data, and market data. Data mining techniques may be used on the databases to develop market trend data, competitive analysis, vendor profiles, and Centralized profiles.

The optional report generator 134 provides reports including vendor reports that indicate activities between users and vendors, user reports that indicate user activities with the CSMC search engine server 000 and/or the vendors, preference reports that indicate trends in Centralized preferences, ad hoc reports, and others. The optional data analyzer 122a comprises customizable data analysis tools. The affinity analyzer 122 provides customized or ad hoc data analysis that the server 00 or the server 123 uses to fine tune the marketing of the product or services.

The payment module calculates the fees charged to the vendors. Such fees may include periodic fees, banner fees, performance-based fees, and results-based fees. The results-based fees include fees based on the activities between users and vendors, when the users are referred to the vendor by the CSMC search engine server 000. A user is referred to a vendor when the CSMC associated with search engine server 000 provides the user information about a vendor or a product or service offered by the vendor. User activities may include accessing the vendor's network site, opening a new account with the vendor, purchasing a product, or other activities. The fees may include fees charged to vendors other than the user's preferred vendors when the user opens an account with the non-preferred vendor. The non-preferred vendor fee may be less than the preferred vendor fee. The amount of the fee may be based on various factors, for example, the number of activities the user performed prior to at least a purchase, the user's profile, or the type of activity.

The network 21 provides communication between multiple communication systems via personal digital assistant (PDA). Embodiments provide CA for communications with wide area network comprising the Internet. Certain embodiments provide the CA further comprises servers being hosts to provide access to resources such as information or services to client communication system that are communicatively connected with the Internet and/or network 21. With respect to the Web, there are thousands of server communication systems via personal digital assistant (PDA) that store the web pages that make up the Web. The web pages typically include links in the form of uniform resource locators (URLs) that are a link to another web page, whether it is on the same server or a different one. As described above, the Web is a distributed network of web pages. Networks of hyperlinked SMC files, forms, or document s can also be present in local area networks such as the intranets. The operation of these intranets is very similar to the Internet except that it is not uncommon for all or a majority of the hyperlinked SMC files, forms, or document s of an intranet to be stored on a single server communication system.

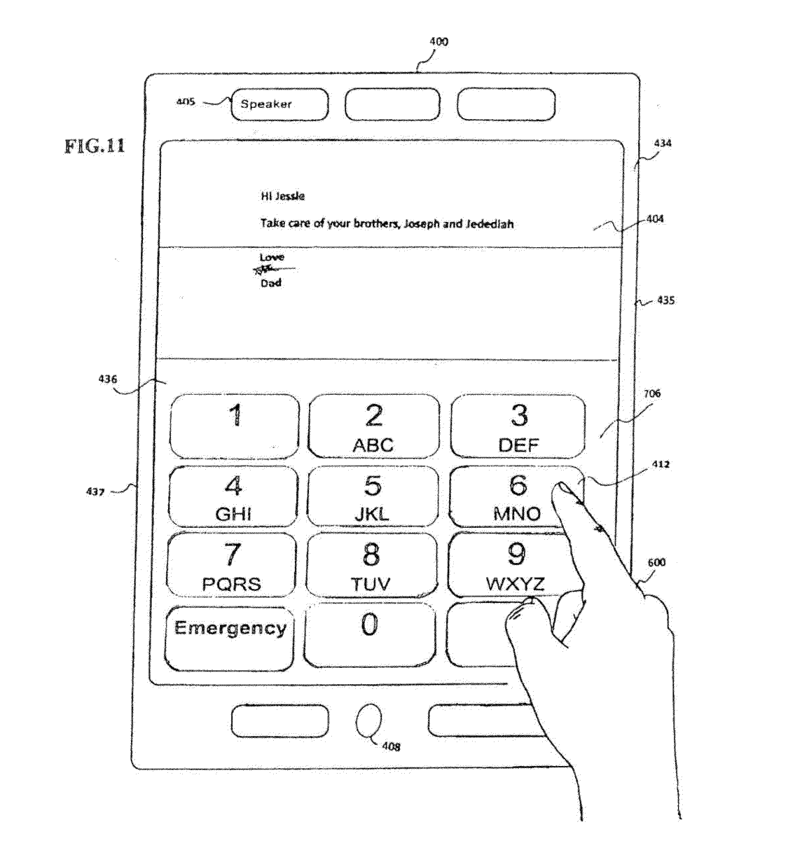

Referring to FIG. 11 is seen exemplary embodiments of IMMT 400 comprising a mobile phone with a touch screen panel operable for communications; interactive gaming; music applications; a virtual slider operable for accessing multimedia buttons. Disclosed embodiments provide the IMMT 400 comprising at least one of: at least a variable gain modules 434, a mobile device, 435, internal peripheral devices 436, a capacitive touch screen device, and an external peripheral devices 437. Certain embodiments provide the IMMT 400 comprising at least one of: cell phones, smart phones, laptops, handheld communication devices, handheld computing devices, satellite radios, energy harvesting device, wireless ED, wireless energy management device, global positioning systems via personal digital assistant (PDA), and PDA. Some embodiments provide internal peripheral devices in association with EDs and/or wireless mobile communication device. Other embodiments provide the IMMT 400 further comprising a Bluetooth radio, wireless local area network (WLAN) radio, a wireless personal assistance network (WPAN), a wireless wide area network (WWAN) radio. The external peripheral device further comprises camera, printer, card reader, scanner, radio connection, wireless device connection. Embodiments further provide the IMMT 400 configured with speakers 405, microphones 408. Certain embodiments provide the IMMT further comprises a display/input device 404 being operated by at least a human hand 600. The display/input device 404 further comprises a touch screen 412 being further operable on a detection platform 706. The platform is configured for individuals, corporations and these groups to provide the substance of things hoped for, revealing the evidence of things not commonly seen by bringing fashion cultural change to their community to impact the world with the hope for sustainable cultural independence, and to better corporate and community vision. The FSMSS for sharing knowledge relating to fashion, model, and dress code. The platform is an effective SS for empowering brand success, for bringing business awareness, and for sharing community social measurements to impact generational awareness and improve community cultural and economic values. Users of the network are encouraged to embrace creative minds as a path to fashion media, model media, or dress code media, providing their creativity in fashion model for community cultural growth, not as a means of inquiry, but rather as a dimension for social sustainability to gracefully improve corporate and CCI through economic vision.

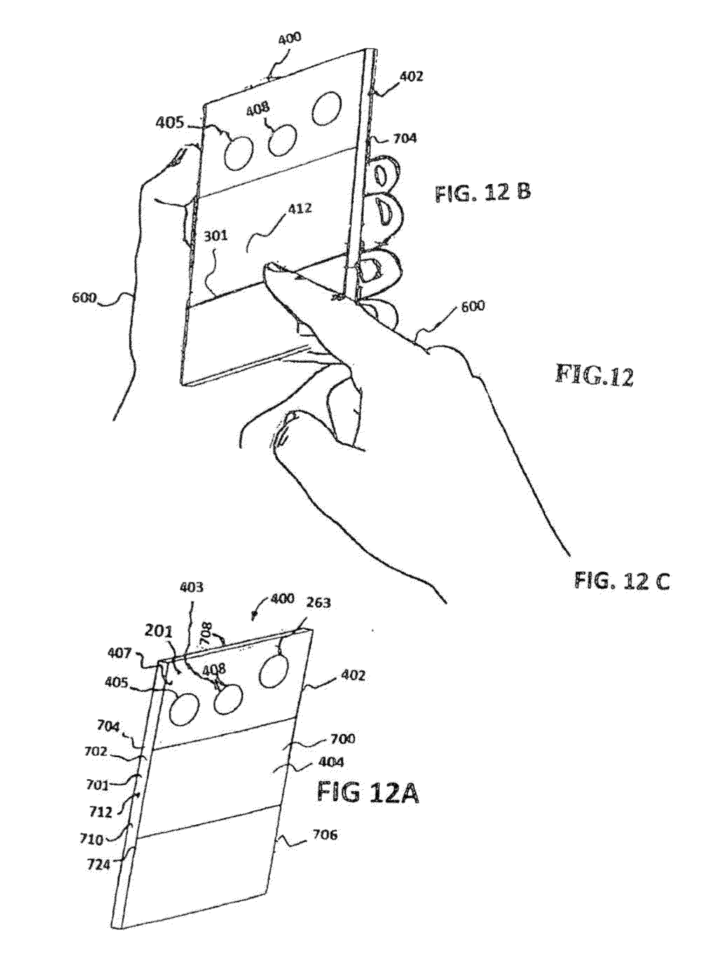

Referring to FIG. 12 is seen exemplary embodiment of an IMMT 400 comprising a mobile phone with numeric keypads operable to provide voice over texting applications; a slide out keyboard; and resistive/capacitive touch screen interactive interface, including character recognition in accordance with one embodiment of the invention. Referring to FIG. 12A, the IMMT 400 further comprises a housing 402 comprising of a sensory platform 700 consisting of NA. Some embodiments provide the housing 402 comprising at least a cell phone housing and/or belt clip. The sensory platform further disposed with strain gauges 701 embedded in load cells 702. Disclosed embodiment further provide nano technology applications comprising nano sensors 704 being embedded in silicon substrate 712 and fused/etched in nano-fiber/microfiber material 710, providing a silicon substrate nano-fiber/microfiber 724. The sensory platform 700 being operable to provide a detection platform 706 being further operable for detections, communications and/or for converting at least a form of energy into electrical energy. Disclosed embodiments further provide the sensory platform 700 further comprising a touch screen display/input device 404 being affixed on housing 402. Certain embodiments provide the housing 402 further configured with speaker 405, microphones 408, embedded antenna apparatus 201, in communication with at least a signal booster comprising a chip 403 in association with a logic circuit 407.

The IMMT 400 further comprises the detection platform 706 in association with sensors 708 being operable for detecting objects proximity to at least the display/input 404. The IMMT 400 may comprise at least one of: cellular telephone, telephonic, media device, PDA device, cellular telephone, GPS device, entertainment device and/or an information device being operable for road and traffic communications, including road side advertisement. Embodiments further provide the IMMT 400 configured with speakers 405, microphones 408. Certain embodiments provide the IMMT 400 further comprises a display/input device 404. The display/input device 404 further comprises a touch screen 412 being further operable on a detection platform 706. Disclosed embodiments further provide a device configured interactive input/output interface on a substrate. At least a piezoelectric sensor is further embedded in the substrate. The device further comprises a display/input formed on the substrate. The piezoelectric sensor is formed on the substrate in communication with at least a processor being further operable to calculate applied force and activate a force response based on the calculated value. Disclosed embodiments provide the IMMT further comprising a device configured for monitoring resistance associated with one or more piezoelectric sensors to detect changes in a force applied to the display/input device. The display/input device is further configured for detecting change in resistance associated with the one or more piezoelectric sensors being further configured with electrical crystals operable for measuring force applied to the display/input device based on the detected change in resistance.

Referring to FIG. 12B is seen an exemplary embodiment of a human hand 600, holding IMMT 400. The IMMT is disposed in a housing 402 configured with nano sensors 704, a display/input device 404, and a speaker 405, and a microphone 408. The display/input device 404 further comprises a touch screen 412 being further configured with an interface device 301. The IMMT 400 further comprises a media device further consists of input and output devices. Disclosed embodiments provide the IMMT 400 disposed at least a housing 402 comprising a cell platform for harvesting energy.

The IMMT 400 further comprises a cellular telephone, a game device, and a media player and a PDA. The IMMT 400 is portable and may fit within the hand of normal adult and grown children. In one embodiment, the display/input device 404 may include at least one of multi-point interactive touch screen input device 412, an LCD display. Disclosed embodiment provide the display/input device 404 further comprising liquid crystal display (LCD), a capacitive touch screen display or another type of interactive display operable for providing information to a use. Certain embodiments provide a display/input device being further operable for providing information regarding incoming or outgoing telephone calls and/or incoming or outgoing electronic mail (email), instant messages, short message services, multi-media message services, calendar application, text message application, the current time display, video games applications, downloaded content display, media applications. In one embodiment, the multi-point interactive touch screen is a capacitive sensing medium configured to detect multiple touches, including blobs on the display from a user's face or multiple fingers touching or nearly touching the display.

Referring to FIG. 12C is seen an exemplary embodiment of the disclosure comprising human hand interaction 600. Certain embodiments provide the IMMT 400 comprising a hand held device, further comprises a display/input device 404 as seen in further 12B, being operated by at least a human hand 600 as seen in FIG. 12C.

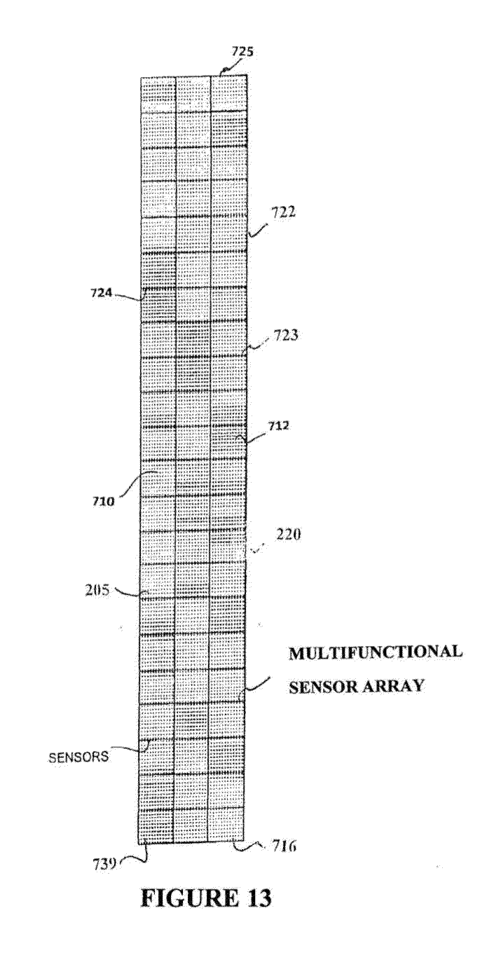

Referring to FIG. 13 is seen exemplary embodiments of NA of CMOS multiple antenna on a chip to realize at least a 60 GHz frequency. The CMOS multiple antennas 724 comprise miniaturized alloyed material comprising meta-material structured surface cavity 722 embedded/coupled in silicon-substrate-nano-fiber/microfiber platform 723. Disclosed embodiments provide the platform 722 further disposed with CMOS multiple antenna apparatus configured for providing detections and communications associated with the IMMT 400. The platform 722 further associated with personal digital assistant (PDA) for generating electrical energy. The IMMT comprises nano-fiber/microfiber material 710 further configured with sensors on silicon substrate 712. The sensor comprises electrode and/or temperature sensor 716.

Certain embodiments provide the substrate-nano-fiber/microfiber 724 further configured with miniaturized nonferrous materials 734 being embedded in the silicon substrate 712. Some embodiments provide the substrate-nano-fiber/microfiber 724 comprise energy transport platform 725. Certain embodiments provide the CMOS multiple antenna apparatus 724 coupled to the silicon substrate 712. Some embodiments provide the substrate further comprises glass substrate 739 comprising a gallium nitride high electron mobility transistor (GaN-HEMT) and/or titanium structure to improve communication signal amplification, faster data transport speed, and to reduce energy consumption for the IMMT 400. Some embodiments provide the IMMT further configured with a silicon to silicon bonding and/or silicon to ceramic wafer bonding to further provide a detection platform and for generating electrical energy. The silicon is further provided with ceramic wafer bonding responsive to solar energy. The silicon to ceramic wafer bonding may include at least silicon to glass bonding, forming single crystal silicon to improve the micro-acoustics and micro optics in the NAs to further reduce energy consumption and produce electrical energy. Disclosed embodiments provide the substrate further comprises optical properties of thin films being operable for the advancement of the integrated circuit further configured for converting solar energy into electrical energy. Certain embodiments provide the optical properties of thin films being associated with the advancement of the integrated circuit for converting solar energy into electrical energy. Some embodiments provide an energy platform consisting of at least surface acoustic wave line, paste, MEMS, thin film deposition, and multifunctional sensor array 205 embedded in the silicon substrate 712 and etched and/or fused in a micro-fibered material 220. The application of ceramic materials further provides many features, including high hardness, physical stability, extreme heat resistance and chemical inertness. Certain embodiments provide cell platform further comprising highly resistant material to aggressive chemicals, water, melting, bending, stretching, and corrosion.

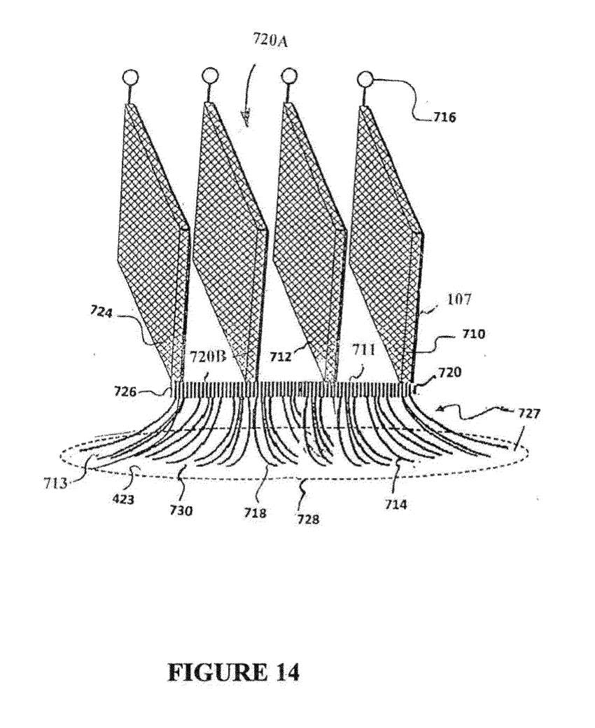

Referring to FIG. 14 is seen exemplary embodiments of the energy transport medium. Disclosed embodiments further provide the IMMT comprising systems for personal digital assistant (PDA) for generating and storing electrical energy. Certain embodiments provide the system further comprises nano-materials 710 associated with nano-fiber/microfiber material. Disclosed embodiments further provide the nano-fiber/microfiber material 710 comprising materials with excellent electrical properties being disposed with substrate 712. The substrate 712 further alloyed with meta-material structure and etched and/or fused in a nano-fiber/microfiber material to enable energy cell platform. The cell platform further comprises apparatus for removing radiation pattern back lobe. The nano-fiber/microfiber material 710 includes material components with nanometer dimensions in which at least one dimension is less than 100 nanometers. Some embodiments provide the nano-fiber/microfiber materials further configured with nano-wires/tubes 714. The nano-wires/tubes 714 further embedded in the silicon substrate 712. Certain embodiments provide the IMMT disposed with substrate 712 being configured with electrodes 716 at the opened end of the CMOS multiple antennas to enable antenna network in communication with the nano-wires/tubes 714. Some embodiments provide nano-sensors formed on silicon microfiber/nano-fibers. Other embodiments provide the electrode 716 further comprising at least a temperature sensor. Disclosed embodiments further provide the sensors comprising a WCD configured with nano-fiber/microfiber membrane consisting of structural communication and data transmission integrity.

Certain embodiments provide the nano-fibers being formed using electro-spray deposition. Other embodiments provide the nano-wires/tubes 714 comprising at least one component of: carbon char, carbon black, metal sulfides, metal oxides and other organic materials being alloyed with the nano-fiber/microfiber material 712. Disclosed embodiments further provide the interactive multimedia mobile disposed with alloyed material 718 comprising miniaturized nano-materials configured for exhibiting unique electrical and electrochemical properties to provide efficient energy properties to enable effective device operation. The alloyed material 718, in some embodiments, comprises multiple CMOS antenna on a chip configured for intra-chip wireless communication network 727. Embodiments further provide a combination of the silicon substrate and metal oxide and/or thin film or miniaturized metallic material in communication with signal booster chip, providing a battery cell an energy platform for the CA. Disclosed embodiment further provide the IMMT in association with a detection platform comprising touch screen display device configured with a processor means. The processor means further comprises a pattern recognition technique for producing “Sensing,” a controlled data/communication signal and for communicating sensed detection to a wireless modem or control module operable to provide wireless communication.

Certain embodiments provide the carbon char further configured with silicon substrate and nano-fiber/microfiber material to further provide an energy platform. Embodiments described herein include multiple antenna apparatus fabricated on relatively low resistivity CMOS-grade silicon substrate nano-fiber/microfiber with reasonable radiation efficiency. The IMMT is reconfigured with integrated sensor elements on at least a circuit board operable for energy harvesting. Disclosed embodiments provide the sensor elements further comprising at least nano-sensors having sensing mode operable to measure environmental characteristic and for generating electromagnetic charge outputs comprising time-encoded signal indicative of the measurement. The energy platform further comprising force responsive platform for force measurement, fluidic measurement, weight measurement, in association with energy harvesting module for harvesting energy from solar energy, wave energy, electromagnetic energy, and ambient energy source. Certain embodiments provide module comprising a switchable circuit board configured to switch from the sensing mode to the energy harvesting mode responsive to at least a predetermined threshold. The sensors further comprise piezoelectric, thin film, cantilever, accelerometers, magnetometer and gyroscope, NEMS/MEMS, infrared proximity sensors, vibrator motor, and/or voice recognition. The accelerometer is further configured for measuring physical activities, physical fitness, and burnt calories of a person during a sporting event.

Disclosed embodiments further provide the IMMT comprising systems for personal digital assistant (PDA) operable for producing energy properties from the presence of high surface areas and charge transport mechanism. Certain embodiments provide the charge transport mechanism being further derived from the flow of electromagnetic wave, radio wave, and pressured fluid 423. Certain embodiments of the pressure fluid 423 comprise sound waves, solar energy, vibration, and wind. Disclosed embodiments further provide apparatus for thermal expansion of fluid in communication with the nano-wires/tubes 714. Embodiments provide silicon-nano-fiber/microfibers in association with nano-wires/tubes 714 being further provided for converting thermal energy into electrical energy. Certain embodiments provide platform for the thermal expansion of fluid, the platform further comprising means for converting sound waves, solar energy, vibration, and wind and/or material pyrolysis into electrical energy. Some embodiments provide platform comprising energy medium, including apparatus 720 comprising means for electron transfer that occurs at the electrode 716 via the release of chemical energy to create a voltage through oxidation/reduction reactions 722. The oxidation and reduction reactions 722 is being separated through the electron 716. The electrode 716 is further configured with CMOS substrate-nano-fiber/microfiber 724 embedded with multiple antennas comprising intra-chip network re-enforcements to external electric circuit communication and data transmission efficiency. Certain embodiments further provide the apparatus 720 comprising at least energy cell platform. Some embodiments provide the apparatus 720 further comprising CMOS multiple antennas configured with meta-material surface cavity. Disclosed embodiments provide the apparatus 720 further comprises CMOS multiple antennas platform configured with at least opened ends 720A and shorted ends 720B. Certain embodiments provide the cell platform further comprises at least a storage medium comprising internally transporting voltages at electrodes configured for providing useful energy transport stream to batteries 724 and/or capacitors 726. Disclosed embodiments provide the energy transport stream further associated with silicon substrate nano-fiber/microfiber further comprising of Si-substrate consisting of a patterned isolation layer.

Certain embodiments provide the Si-substrate being etched and/or fused through openings of the patterned isolation layer to form a plurality of electric-conducting platform. Some embodiments provide the at least electric conducting platform further configured with electric-conducting wires and/or at least heat-conducting wires in communication with an opto-electronic device “Op-ED.” The opto-ED further comprises opto-isolation apparatus configured with at least a LED operable for photographic applications. Disclosed embodiments provide the silicon nano-fiber/microfiber further comprising a remote sensor assembly in association with multiple antennas configured with a plurality of nano-electromechanical system (NEMS)/micro electromechanical system (MEMS) embedded on the silicon substrate and etched/fused in nano-fiber/microfiber material having excellent electrical properties. The silicon substrate further configured for applications to wireless communication circuit in association with a processing devices operable to communicate and to obtain data, such as measurement values from at least one of plurality of NEMS/MEMS sensors. Certain embodiments provide the silicon substrate further configured to perform at least a filtering operation for at least one of: communication signals; data transmissions; measurement values, and detection signals. Disclosed embodiments provide the silicon nano-fiber/microfiber further comprising means for coupling light between input and output waveguides consisting of structures having higher portions or lower portions being arranged at a fine pitch equal to or shorter than a wavelength of visible light on a base surface responsive to plurality of arc track rows.

Disclosed embodiments provide the CMOS multiple antennas 724 further comprises at least a chip configured with integrated circuit. The integrated circuit further configured with nano wires 714 comprising miniaturized material embedded in silicon substrate nano-fiber/microfiber 712, and alloyed with Meta material structure including surface cavity. The CMOS multiple antennas further configured for radio frequency applications operable to provide intra-chip antenna network. The CMOS multiple antennas further configured for enabling GHz frequencies for applications that include Bluetooth, Wi-Fi wireless network, and mobile phones. In the disclosure, the chip is further configured with power amplifiers operable to provide communications clarity and data transmissions efficiency over short range to longer ranges. At least a metal oxide semiconductor is associated with the silicon substrate nano-fiber/microfiber to provide better power efficiency and to achieve better communication clarity and extended power life. The CMOS MAOC are further provided in association with embedded amplifiers to realize high operating frequencies to enable high data rate communications and to prevent atmospheric absorption. Nano wires 714 are associated with the CMOS antennas 724 to further provide multicast protocol label switching network for wireless communication. The CMOS antennas on chip 724 are further operable to realize wireless network regions that are better than at least 60 GHz for applications that include wireless communications, military application, high speed data transmission applications, and homeland security intelligence applications. Certain embodiments provide the nano wires 714 further configured to provide a platform to protect against oxygen absorptions, to protect against interference from other networks, and to protect against human health concerns. Some embodiments provide an IMMT configured with signal boosters to provide desirable high definition television “HDTV” signals with high data rate communications being operable at the realized transmission frequencies.

Disclosed embodiments provide the realized transmission frequencies comprises the act of providing better communications for wireless personal area network “WPAN,” local area network “WLAN,” and for allowing communications for wireless Gigabit Ethernet, mobile devices synchronizations, wireless fire wire, and USB display. Embodiments provide the high rate WPAN further includes point to point transport for bulk data transfer, multimedia streaming, and streaming HD multimedia contents. Some embodiments provide the CMOS multiple antennas on a chip comprising silicon substrate nano-fiber/microfiber being alloyed with meta-material in association with an integrated circuit. Other embodiments provide the integrated circuit further configured for low power consumption. Disclosed embodiments further provide the integrated circuit further comprising digital signal processing “DSP” for higher frequencies. Certain embodiments provide the chip comprising at least a single chip circuit or a module operable for converting digital signals into at least a 60 GHz modulated radio wave. Other embodiments provide the module further operable for converting radio wave signals into at least 60 GHz digital signals. Embodiments provide the silicon substrate nano-fiber/microfiber configured for providing additional output power gain and long term data transmission reliability. Disclosed embodiments provide the meta-material further comprising mete-material substrate and/or die-electric materials operable to provide at least a metal gate electrode 716. Disclosed embodiments provide the antennas 724 further comprising a chip configured with at least a software program. The chip is further disposed on a logic circuit further configured with at least transistorized switches to provide at least on chip multiple antennas arrays that are programmable for boosting signal reception and/or for changing signal transmission directions. The CMOS multiple antennas 724 further affixed with an opened end 716, and a shorted end 720. The shorted end 720 is integrated with power supply circuitry 726, 728, and 730 to further reduce/eliminate critical signal loose. Disclosed embodiments further provide the nano wires operatively configured for restraining internal noise and for providing stable communication operations.

Disclosed embodiments further provide the antenna apparatus 201, 418 comprising at least a field programmable gate array “FPGA.” Certain embodiments provide the FPGA disposed with Meta material being coupled to semiconductor substrate in communications with nano wires 714. The nano wires comprise signal interconnect lines in communication with the shorted end of the FPGA Meta material structured surface 712. The first antenna portion 201 is connected to the second antenna portion 418 at the shorted end 720. The shorted end further contains thin conductor layers portion characterized as having a plurality of thin, fine-pitch nano wires conductors 720. The nano wires are further configured to convert electromagnetic wave energy into electrical energy to provide further additional operating power platform for the IMMT 400. The opened end further contains conductive material configured to absorb electromagnetic wave energy for communications with the shorted end 720. The shorted end further consisting of FPGA Meta material structured surface. Plurality portions of three dimensional antennas are joined at the shorted end comprising a MEMS wafer leveled surfaces within flatness at the top and nano wires protruding at the bottom of the flat surface. The nano wire portions are fused and/or etched.

Disclosed embodiments provide the CMOS multiple antennas 201 and 418 further disposed on a semiconductor chip 403. Certain embodiments provide the chip consisting of integrated transceiver. In the disclosed embodiments, the antennas 201 and 418 are further configured to transmit, and to receive, comprising of a transmitter and a receiver. The transceiver is formed on a semiconductor substrate comprising silicon substrate alloyed with Meta material 712. At least one semiconductor substrate is configured with nano-fiber/microfiber material 710 to provide electrical connection between the transceiver 724 and the semiconductor substrate 712. The antenna is further formed with a dielectric layer 711 being connected to the transceiver 724. At least the Meta material structured surface 712 further comprises a reflective plate 713 connected to the substrate. The separation between the reflective plate 713 and the antennas 201 and 418 are about a quarter wavelengths of millimeter waves, which enhances radiation efficiency of the antennas. Some embodiments provide an array of silicon substrate nano-fiber/microfiber 712 being formed and filled with the dielectric material 711 to reduce the effective dielectric constant of the material between the antennas 201 and 418 and the reflector plate 713, thereby reducing the wavelength of the millimeter wave and enhance the radiation efficiency. Other embodiments provide the antenna apparatus 201, 418 being fabricated on a low resistivity CMOS-grade silicon substrate nano-fiber/microfiber. The antennas are configured to resonate at least at 6 GHz.

Embodiments relate generally to wireless communication systems via personal digital assistant (PDA) that employ micro machined antennas 201 and 418 fabrication on at least a field programmable gate array, comprising a removal of silicon substrate underneath the antenna structure to increasing the overall radiation efficiency. Disclosed embodiments provide the CMOS MAOC further embedded to provide a feeding portion, a radiating portion, a grounding portion, and a shorting portion. The feeding portion is operable to feed electromagnetic signals through the opened end 716. The radiating portion 724 is connected to the feeding portion 716 to radiate the electromagnetic signals. The radiating portion further includes a first radiator 201 and a second radiator 418. The first radiator is “L” shape, with a first end electrically connected to the feeding portion. The second radiator is formed by a plurality of radiating sections connected one by one. The second end of the first radiator and the second end of the second radiator are connected to the radiator shorted end 720. The first end of the shorted portion 720 is connected to a common node 726 of the first radiator 201 and the second radiator 418, and a second end of the shorted portion 720 is connected to the grounding portion consisting of nano wires 714.

Disclosed embodiments provide the CMOS MAOC further configured for resonating at least at 5.8 GHz. Embodiments further provide a differential feed operatively coupled to CMOS multiple antennas. In one disclosed embodiment, the antennas are fabricated on relatively low resistivity CMOS-grade silicon substrates. In one such exemplary non-limiting embodiment, the CMOS multiple antennas further comprises photo-resist elements to form antenna approximately 400 um in thickness, and is 12 mm long×2.8 mm wide. In another embodiment, at least one CMOS antenna is provided, the CMOS multiple antennas portion being separated from the CMOS antenna, and a photo-resist material connects the first and second CMOS portions. The antenna 201 includes at least one CMOS antenna 418 and the CMOS multiple antennas portion 724. A photo resist material 711 is coupled or connected to the CMOS portions 418 and 724. The antennas 201 and 418 can be fabricated on a silicon substrate nano-fiber/microfiber with a thickness of at least 10 um and/or between 10 um and 700 um. Disclosed embodiments provide the IMMT 400 in association with the COMS multiple antennas 201 and 418 being disposed on the chip for digital signal processing “DSP.” The chip 403 is further coupled to an application specific integrated circuit 107. Certain embodiments provide the antennas further comprising Meta material structured surface cavity configured for enabling high data transmission. Some embodiments provide the Meta material structured surface comprising at least a reflective element operable for wireless interconnections and for transmitting data wirelessly at a much faster speed.

Other embodiments further provide a silicon wafer comprising folded dipole antennas configured with meta material structured surface on at least a dielectric micro-fibered material to provide better conductor gain at a resistivity of at least 5 cm, and with a thickness of at least 10 um, and impedance of at least 100 being fed through at least the nano wires consisting of lengths of at least 1.5 mm. Disclosed embodiments are not limited to the dimensions herein. Certain embodiments further provide exemplary embodiments of the antenna being constructed of conducting nano wires 714. The nano wires consisting of a size comprising at least a 2.50 mm×4.3 mm at a height of at least 525 um. In the embodiments, the antenna further comprises at least silicon substrate nano-fiber/microfiber disposed with the Meta material structured surface configured for low resistivity and better conductor gain to enable a broader bandwidth. The CMOS multiple antennas is further disposed on flat surfaces consisting of at least a vertical slot being narrowed with at least a wavelength of at least a quarter deep. The antenna 201 and 418 are further configured for surface wave propagation to at least the shorted end 720B. In some disclosed embodiments, impedance is higher at the opened end 720A. In other disclosed embodiments, at least a corrugated Meta slap is coupled to at least a vertical wall to modify radiation pattern to increase antenna gain. Disclosed embodiments provide the radiation pattern further includes a radiation pattern back lobe consisting of nano wires being etched and/or fused at the shorted end 720B and configured with the Meta material surface to provide higher gains

The antenna 201 further comprises a dipole antenna comprising a generalized non-limiting antenna embodiment. Certain embodiments provide the antenna comprising a differential-fed antenna being configured for easy integration into active circuits. Disclosed embodiments further provide the antenna comprising complementary metal-oxide-semiconductor (CMOS) multiple antennas 724 being disposed in at least a chip. The chip in association with at least one of: microprocessors, digital logic circuits, static RAM, and microcontrollers. Certain embodiments provide the multiple antennas 201 and 418 comprises CMOS configured with silicon substrate nano-fiber/microfiber being alloyed with meta material structured surface 712 to provide wide variety of analog circuits such as image sensors, and data converters. Some embodiments provide the antennas further comprises highly integrated transceivers 724 configured for variety of communications, including military applications. Disclosed embodiments provide the CMOS multiple antennas further comprising complementary and symmetrical pairs of p-type and n-type metal-oxide-semiconductor field-effect transistors (MOSFETs) operable for implementing logic functions. Certain embodiments provide the CMOS further comprising a structured material with relatively low resistivity and relatively inexpensive. Certain embodiments provide the CMOS multiple antennas apparatus further comprising means for radiating/receiving electromagnetic energy and for accepting power from a source. Embodiments further provide the CMOS multiple antennas further configured for radiating power into the shorted end. The received energy is being radiated to the source, or dissipated to a resistive load. The ratio of the power radiated into the ground nano wires to the power received from the source is the radiation. Radiation efficiency is defined as “the ratio of the total power radiated at the shorted end by the multiple antennas to the net power accepted by the antennas from the opened end” (Pradiated/Pinput=ηefficiency).

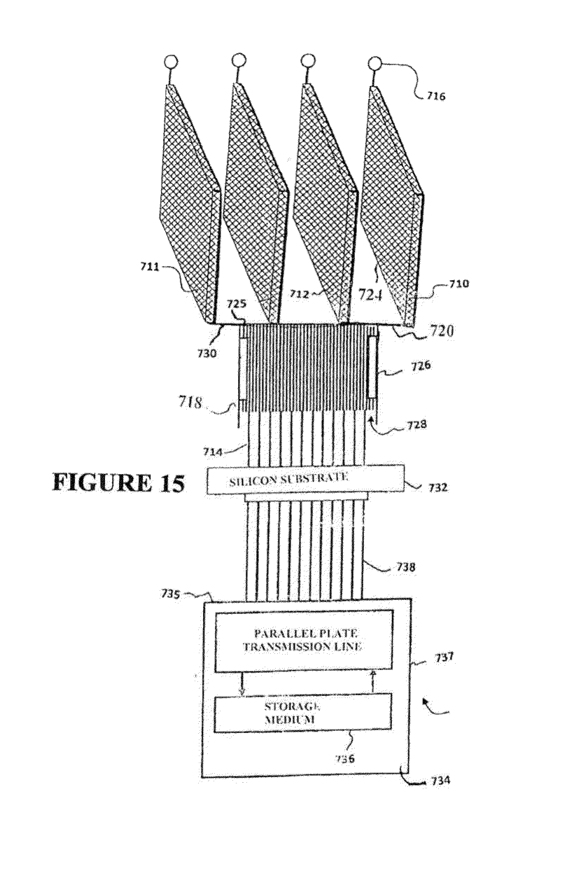

Referring to FIG. 15 is seen further exemplary embodiments of the CMOS multiple antennas 724 on a chip comprising substrate nano-fiber/microfiber embedded with meta-material for communications and for an energy medium. The CMOS multiple antennas 724 is opened on one end configured with electrode and temperature sensor 716, and shorted on the other end 720, further configured with nano wires for antenna network communications, in communication with the energy storage medium further comprising energy storage apparatus coupled to the shorted end 720. Disclosed embodiments provide the CMOS multiple antennas in association with a personal digital assistant (PDA) for communications, for energy harvesting, and for realizing frequencies of at least 60 GHz. Certain embodiments provide the multiple antennas further comprise apparatus for generating electric energy from the energy released by a reaction, such as pressure, thermal transport, heat, force, motion, and vibration. Certain embodiments provide nano-fiber/microfiber material 710 configured with silicon substrate for converting pressure, vibration, heat, thermal transport, wind, and force into electrical energy. Some embodiments provide the energy being generated comprising g electrical energy 730. Other embodiments provide the energy being converted comprising thermal energy 732. The thermal energy is being transported via the nano-wires/tubes 714 associated with silicon-substrate-nano-fiber/microfiber material and/or the electrode. Certain embodiments provide the nano wires/tubes further configured to provide a platform for antenna network to achieve at least a 60 GHz frequency. The nano-fiber/microfiber material 710 further comprises plurality meta-material substrate in association with textile fibers 711 being alloyed with zinc oxide (ZnO) nano-wires 734 to form at least a meta-material structured surface cavity. Disclosed embodiments provide the zinc oxide nano-wire 734 further configured with piezoelectric crystals for generating electrical energy 728. Certain embodiments provide a coil in association with the energy harvesting sensors for communicating and/or transporting the harvested/generated electrical energy being to at least a cell platform, including a capacitor. Disclosed embodiments further provide the piezoelectric further comprises electromagnetic composite meta-material for electromagnetic energy harvesting medium.

Certain embodiments of the piezoelectric comprising plurality of spaced electromechanical resonators disposed in the electromagnetic medium configured to control electromagnetic wave propagation properties in the electromagnetic composite meta-material. Certain embodiments provide an IMMT further associated with the energy harvesting medium configured with signal booster chip in communication with the multiple antennas operable to allow current flow 730 from plurality fiber pairs 736. Other embodiments provide the fiber pairs further configured for converting at least one of: vibration, pressure, blood flow, sound, waves, force, thermal energy, and other electrical properties into electrical energy 730. Some embodiments provide the fiber pair configured for generating pressure, thermal energy, and force to produce electrical energy 730. Certain embodiments provide the fiber pair further configured for producing electrical energy 730. At least one energy harvester further comprises radiation apparatus. Other embodiments provide the radiation apparatus comprising a radiator device configured with silicon substrate nano-fiber/microfiber and at least an electrode.

Disclosed embodiments provide the radiator device comprising a device that emits radiant energy. Disclosed embodiments provide NA comprising nano sensors and MEMS, being embedded on a silicon substrate and etched and/or fused in a nano-fiber/micro fiber material, comprising fabricating together a unified process with supporting integrated circuit (IC) on the same semiconductor substrate comprising integrated silicon platform comprising a chip configured with CMOS multiple antennas 724. Certain embodiments provide the integrated silicon platform being disposed in at least a single chip to greatly reduce the size, weight and power consumption of the IMMT 400 to enhance performance of all applications for the CA. Disclosed embodiments further provide the energy platform comprising a cell platform 720 configured for medical devices applications. Other embodiments of the cell platform comprise CMOS multiple antennas configured for intra-chip antenna network for effective communication applications. Disclosed embodiments further provide the cell platform comprising at least a nickel-cadmium (NiCd) configured with nickel oxide hydroxide and metallic cadmium for energy capture. Disclosed embodiments provide the nickel oxide and metallic cadmium further consisting electrodes 716 further configured for deep discharge applications. Other embodiments provide cell platform comprising systems for personal digital assistant (PDA). The PDA further configured for storing electrical energy associated with the cell platform 720. The cell platform includes battery cells and/or capacitors configured for withstanding higher number of charge/discharge cycles and faster charge and discharge rates. Certain embodiments provide the cell platform further comprises an electrode device. The electrode device comprising at least electrically conductive nano wires/tubes 714 being coated with at least one electrically isolating layer. The nano wire/tubes further comprises silicon nano wire operable to display biological analysis results such as electrical responses to either pH changes or receptor-ligand interactions of at least one of: protein disease, viruses, and DNA hybridization in real-time.

Embodiments further provide IMMT configured with the cell platform for generating pressure, thermal energy, and force, and for converting the pressure, thermal energy and force into electrical energy. Disclosed embodiments further provide personal digital assistant (PDA) configured for converting wind force into electrical energy. Certain embodiments provide nano-fiber/microfiber material 710 comprising zinc oxide (ZnO) further configured for converting pressure and force into electrical energy 730. Some embodiments provide the nano-fiber/microfiber material 710 further comprise meta-material structured surface cavity comprising NAs. Disclosed embodiments provide a method of selectively etching a solid sacrificial sensory layer, comprising wet etching and/or dry etching. Other embodiments provide personal digital assistant (PDA) further configured for generating renewable electrical energy via NAs. The NAs comprise at least a single layer nano-fiber/microfiber 736. Other embodiments provide the nano-fiber/microfiber 710 further comprise miniaturized meta-material arrays comprising nano-wire 734 further configured for applications in hybrid communication applications to increase data transmission speed, including HDTV applications, further comprising generator assembly 738 in communication with the energy platform. Certain embodiments provide the generator assembly 738 further comprises at least semiconductor properties consisting of nonferrous material arrays. The nonferrous material array comprises vertically-aligned zinc oxide (ZnO) nano-wires 734. The zinc oxide nano-wire 734 is further configured to exhibit flexible electrode 716. Certain embodiments provide the flexible electrode 716 comprising complementary metal oxide semiconductor. Some embodiments provide the flexible electrode further comprising conductive platinum tips 735 in association with CMOS NEMS/MEMS. The CMOS NEMS/MEMS further comprises probes switches operable to actuate down onto a specific programmable addressable location to deliver a current Phase change (PC). The CMOS NEMS/MEMS is embedded within a reconfigurable circuitry to provide a low or high resistance state, such that when the reconfiguration is complete, the heaters in the probe are turned off and electrical and/or mechanical contacts are broken. The application provides the reconfiguration of radio-frequency circuits further configured for repeatable contact resistance.

Other embodiments provide the nano-fiber/microfiber material 710 further comprising plurality fibers being operable for characterizing excellent electrical properties. The nano-fiber/microfiber material is coupled with meta-material structured surface cavity and/or coated with polymer and/or with zinc oxide layer 734 to realize at least 60 GHz frequency and to provide energy transport platform 725. Certain embodiments provide the nano-wires 734 configured to provide antenna network platform 718. Some embodiments further provide the nano-wires 734 being coated with gold 737, and fused or etched on the energy transport platform 725. Other embodiments provide the nano-wires 714 further configured for harnessing energy from at least a medium, comprising at least one of: vibration, pressure, blood flow, sound, waves, thermal source, pressure, wind, motion and Force. Embodiments provide the CMOS multiple antenna apparatus 724 further comprises zinc oxide (ZnO) 734 being embedded in a silicon substrate configured with at least polymer. Disclosed embodiment further provide a single crystal silicon to improve the fabrication of nano/micro-acoustics and nano/micro optics and to provide an energy platform for converting solar energy, sound wave, vibration, pressure force, and wind force into electrical energy.

The nano/micro-acoustics and nano/micro-optics are further fabricated in a nano/micro-electromechanical system and thin film technique to enable the integration of nano-electronics/microelectronics circuit in association with multifunctional sensors to enable a detection platform for the CA. Wafer bonding in single crystal silicon is applicable to significantly lower acoustic losses and improve optical properties and energy production. Disclosed embodiments further provide silicon on insulator bonding method having a silicon layer formed on a silicon nano-fiber/microfiber oxide film as an insulator film comprising parasitic capacitance further configured for high radiation-proof ability. At least a layer in the substrate surface layer portion comprise a region electrically isolated from the inside of the substrate via oxide film layer to eliminate effects such as a high speed/low power consumption operation and/or prevention of low signal transmission. The substrate further includes single-crystal silicon substrates comprising at least a single-crystal silicon substrate that becomes an SOI layer and/or a bond wafer. Certain embodiments provide the silicon substrate comprising a single-crystal silicon substrate that becomes a support substrate further configured with an oxide film on the surface of at least one silicon substrate nano-fiber/microfiber. The single-crystal silicon substrates may be bonded to each other via the oxide film there-between and heat treated to increase bonding strength. Then, a film thickness of the bond wafer is reduced to obtain an SOI substrate

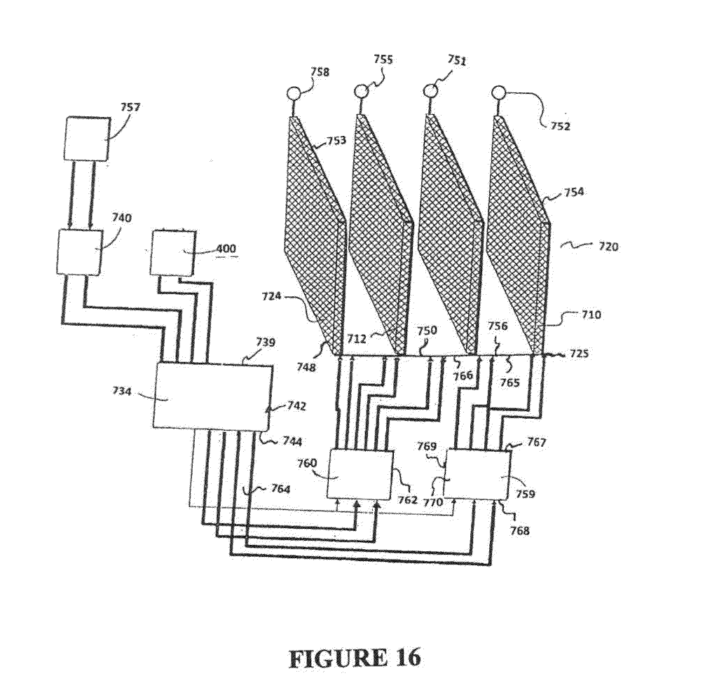

Referring to FIG. 16 is seen further exemplary embodiments of communication device including energy medium comprising energy platform. Embodiments further provide the silicon-substrate-nano-fiber/microfiber comprising energy transmission/storage apparatus 720. Certain embodiments provide the energy transmission/storage further comprising data being converted into electrical energy. The data may be derived from at least one of: vibration, pressure force, wind flow, sound waves, force, and electrical properties. The pressure may include pressure force from at least an object. The object may also include human hand being used to operate the IMMT 400 and/or when the human body is jogging or exercising. The IMMT is disposed with capacitive interactive interface comprising touch screen applications for communications, gaming, texting, programming, display/input, output, and other normally utilized operations. Disclosed embodiments further provide the silicon-substrate-nano-fiber/microfiber comprising charge couple apparatus 740 further configured with miniaturized conduit particles 734.

Certain embodiments provide the conduit particles 734 further comprises at least glass 739. Other embodiments provide the conduit particle further comprises at least Zinc Oxide (ZnO) and/or gold. Some embodiments provide the particles comprise at least non-ferrous material being alloyed with at least a substrate-nano-fiber/microfiber 724.

Disclosed embodiments further materials consisting of conduit properties comprising of at least glass fiber 739 responsive to light data transmission. Further embodiments of the charge particle apparatus 740 comprise electron-silicon substrate-oxide 742 configured with materials being characterized with good optical properties for exhibiting effective sensitivity to electron range. Disclosed embodiments further provide the electron-silicon substrate-oxide 742 further enabled via coatings to prevent glass-glass interface 744. Certain embodiments provide the silicon substrate 712 further comprising at least a constituent of glass 739. Other embodiments provide the silicon substrate 712 being layered with fibers 710 to exhibit durability and better charged properties. Certain embodiments provide an energy platform comprising AIN thin film. Disclosed embodiments provide IMMT consisting of solar cell comprising methods of generating electrical energy. The silicon wafers are presented for producing a simpler and cheaper alternative green energy that includes energy harvesting CA. Disclosed embodiments further provide an IMMT in association with direct band-gap semiconductors cadmium telluride (CdTe), copper indium diselenide alloy (CuInSe2) and copper indium gallium diselenide alloy Cu(InGa)Se2, comprising materials with high optical absorption coefficients being applicable for the photo absorption layer in thin film photovoltaic (TFPV) cells for the energy platform.

The electrodes 716 further comprise of battery cells 748. Other embodiments provide the battery cells 748 further include electrolyte 750 comprising of cathodes 751 and anodes 752. The cathodes 751 comprising the oxidized form of the electrode metal and the oxidizations and reductions are controlled by the electrochemical potential being responsive to the thermal expansion, pressure, composition and concentration of the electrolyte 750. The electrical potential differential being produced is the sum of the electrochemical potential at the electrode 716. Disclosed embodiments further comprise of Zinc batteries and/or zinc media cells 754 further configured for electrochemical power applications through the oxidation of zinc with oxygen from the air. Embodiments provide a device for exhibiting high energy density. Certain embodiments the device further comprises nano-materials 734 embedded in substrate 712 and etched/fused in nano-fiber/microfiber material 710 to provide advanced cell platform 756. The cell platform 756 communicatively connected to the electrodes 716. Other embodiments provide the cell platform 756 comprises a battery cell 753. Yet, other embodiments provide the cell platform 756 further comprises media cell 754. Still, other embodiment provide the cell platform further comprise energy storage medium. Disclosed embodiments further provide the cell platform comprises a capacitor/battery cell apparatus for EDs and automotive vehicles.

Yet, some embodiments provide the cell platform comprises CMOS multiple antenna configured with at least an opened end 755, and at least a shorted end 766 in communication with conductive nano wires 764 forming at least antenna NE.

Disclosed embodiments provide the cell platform 756 further configured for medical devices applications 757. Other embodiments of the cell platform 756 comprise communication applications 758. Disclosed embodiments further provide the cell platform 756 comprising nickel-cadmium batteries (NiCd) 758 configured with nickel oxide hydroxide and metallic cadmium 760. Disclosed embodiments provide the nickel oxide and metallic cadmium 760 further consisting of electrodes 716 configured for deep discharge applications. Other embodiments provide the cell platform in association with personal digital assistant (PDA) for storing electrical energy. The cell platform 756 includes battery and/or capacitor configured to withstand higher number of charge/discharge cycles and to provide faster charge and discharge rates. Certain embodiments of the cell platform 756 further comprise an electrode device 762 comprising at least electrically conductive nano wires/tubes 764 being coated with at least one electrically isolating layer 765. Disclosed embodiments further provide nano-wires/tubes 714 764 in association with at least substrate 712. The substrate being coated with at least one metallic layer 760 having a nano-metric pattern thereon, and being at least partially exposed at a tip of electrically conductive core 760. The cell platform 754 further comprises at least plurality nano-wires/tubes 714 764 being configured with flexible electrode devices 762 disposed with the guided re-enforced silicon substrate 712. Other embodiments provide the electrode device 764 further configured with plurality of micro-wires 734 being connected to at least one nano-wires/tube. The nano-wires/tubes further comprise flexible electrode devices 762 configured to provide electrical communications, video recording, mobile broadband applications, camera/webcam, and television applications.

Disclosed embodiments further provide the cell platform 756 comprising particles of zinc mixed with an electrolyte consisting of at least potassium hydroxide data. Certain embodiments provide an IMMT configured for converting sound waves, solar energy, vibration, and wind into electrical energy. Some embodiments provide the cell platform in association with oxygen from the air to enable reaction at the cathode 751. The reactions can form hydroxyls, which is being migrated into zinc paste and form zinc oxide hydroxide 734 configured for releasing electrons to the cathode 751. Disclosed embodiments further provide the reactions comprising zinc decaying into zinc oxide 734. The IMMT generating electrical energy from sound waves, solar energy, vibration, and wind, in communication with the cell platform 756. The cell platform 756 further configured so that the sound waves, solar energy, vibration, and wind and hydroxyls from the anode 752 are being recycled for energy production at the cathode 751. The recycling further enables the sound waves, solar energy, heat, vibration, and wind to serve only as a catalyst to effectively produce maximum voltage. Embodiments provide the substrate 712 and nano-fiber/microfiber material 710 for the design configuration of the cell platform 756. The cell platform further comprises electro-active material to enable better charge transport. The cell platform 756 further comprise of plurality nano-components consisting of nano-particles 767 forming conductive carbon-based nano-clusters 768 bound together by a conductive carbon-based cluster binder having high densities of mobile charge carriers such as electrons, electronic acceptors, and ionic species. The cell platform 756 further comprises at least a terminal 769, being electrically coupled to the nano-particles 768 for enabling a charge transport being operable for supplying electrons and electron acceptor sites. Other embodiments of the cell platform 756 further comprise charge transport 740, occurring by means of the electron traveling through the highly conductive and short path of the binders 770. Disclosed embodiments provide the binders in close proximity with the nano-clusters 768 for enhancing the energy and power densities. Disclosed embodiments further provide the cell platform comprising battery cell and/or capacitor.

Disclosed embodiments provide a radiator apparatus comprising a renewable energy source. Certain embodiments provide IMMT in association with solar panels comprising crystalline silicon wafers for converting solar energy into electrical energy. Some embodiments provide solar panels comprising thinner wafers via laser processing to ablate the circuit board, providing more electrically efficient CE for signal amplification. Disclosed embodiments provide the radiator apparatus being further configured with substrate-nano-fiber/microfiber and metallic materials to prevent any radioactive or chemical impact within the environment. Disclosed embodiments further provide the radiation apparatus being further configured for extracting energy from the opposing outside wind to be stored within the cell platform. Disclosed embodiments provide digital assistant (PDA) configured for generating electricity at any time without physically plugging the IMMT into a wall socket for recharge, thereby extending the life of the battery.

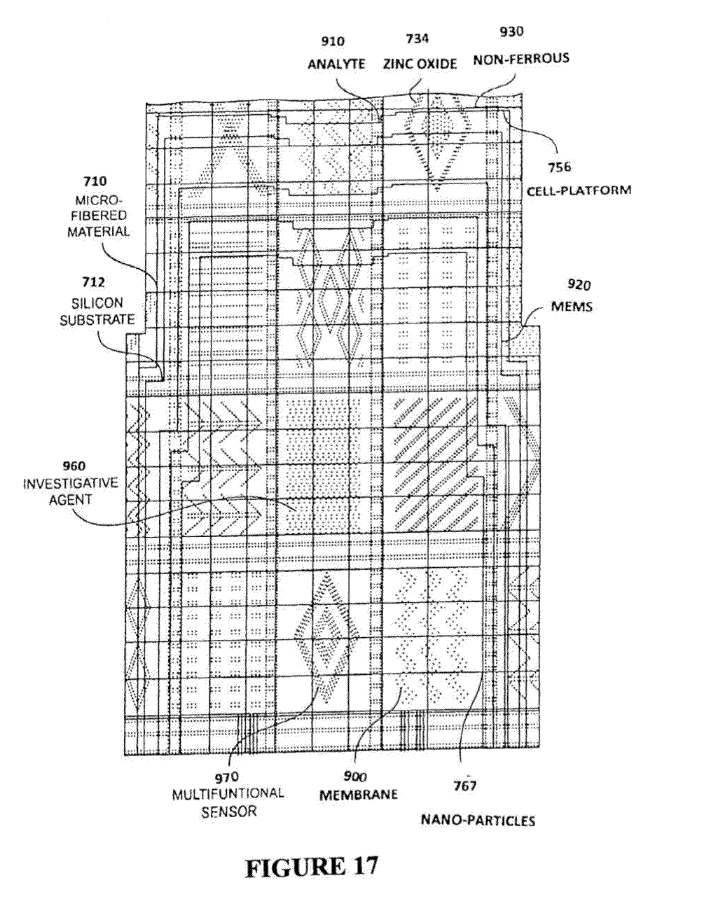

Referring to FIG. 17 is seen exemplary embodiments of a charge transport comprising nano-fiber/microfiber material 710 further configured with silicon substrate 712 for the design of a WCD. The silicon nano-fiber/microfiber comprises cell platform 756 configured with GPS technology for locating individual personnel, for harvesting energy and for communication with EDs, networks, and smart phones. The cell platform 756 further comprises nonferrous material 930 embedded in the silicon substrate 712 to provide effective transparent detection platform. Multifunctional sensors 970, nano-sensors 360, 327 and MEMS 920 are embedded in the silicon substrate to enable a sensory network for detection of charge characteristics, including communication signals. The cell platform 756 further comprises nano particles 767 further configured with membranes 900 to provide structural effective communication integrity. Disclosed embodiments provide personal digital assistant (PDA) configured for generating electrical energy and for transporting the energy to a storage medium. Some embodiments provide the PDA in association with a cell platform consisting of zinc oxide 734. Certain embodiments provide the cell platform further comprises analyte 910 operable for conducting an immunoassay, for measuring properties of analyte, and for testing biological substances. Other embodiments provide the cell platform that comprises an investigative agent. Embodiments further provide MEMS 2-D scanning nano/micro-mirror elements further configured with miniature optics and flexible electronics to enable unrestricted probe movement for the WCD. Embodiments provide a WCD that comprises IMMT further configured with flexible electronics to enable unrestricted freedom of movement on a wearer's body due to pressure, vibration, and sound waves, generating electrical energy through voltage-transformation circuitry in communication with the battery cells, and providing effective short range communications in proximity with the CA. The cell platform further provides security safety into the MEMS system to protect consumers from dissipative radiant energy. Certain embodiments provide the cell platform comprising a wearable communication system that includes IMMT operable on low power consumption. Certain embodiments provide the cell platform comprising highly efficient fiber amplifiers produced by means of ultrafast laser technique. Other embodiments provide the cell platform further comprises an accelerometer.

The WCD configured with GPS technology and is not limited to a watch, an eyeglass and/or a wearable glass, a wearable band, a ring, a garment, a shoe, a brace, a pad, a napkin, a hat, a diaper, measurement device, location determination device, detection device, a display device, a transceiver, a phone case/housing. Embodiments further provide the WCD associated with immunoassay for communication with an antigen to detect the presence of antibodies associated with that antigen. Certain embodiments provide the WCD further comprises means to produce a measurable signal in response to a binding. Some embodiments provide the WCD further comprises means for emitting radiation and/or for producing color change and fluoresce under light and/or when voltage is applied. Other embodiments provide the WCD further comprises labeless immunoassay comprising surface Plasmon resonance operable to detect binding between unlabeled antibodies and antigens. Disclosed embodiments provide the WCD further comprises enzymes in association with reagents.

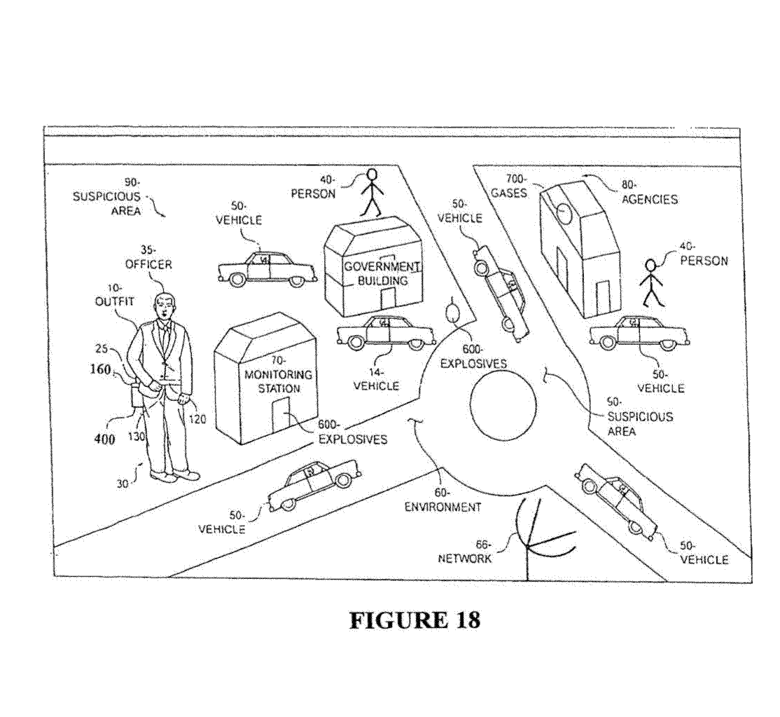

Referring to FIG. 18, is seen exemplary embodiment of a CE 60, comprising a monitoring/network station 70, agencies 80 and a government building. Engines 14 and 50 and at least a person 40 are being watched by an Officer 35, wearing a WCD 10, and monitoring a suspicious area 90. The WCD further configured with GPS technology for monitoring and for locating individual personnel who be outfitted with the device. Officer 35 is outfitted with certain embodiments of the disclosure, comprising outfit 10 and includes a watch wearable on the hand, an eyeglass and/or a wearable glass, a wearable band, a ring, a garment, a shoe, a hat, a pad, tie, shocks, a brace, a napkin, a diaper, measurement device, location determination device, detection device, a display device, a transceiver, a phone case/housing, and enabling an environment for an IMMT 400. The IMMT 400 may be disposed on the outfit 10, in proximity with a smart phone 160. The smart phone case 25 comprises a connector operable for housing the smart phone 160 and for enabling data communications from a social network with the smart phone 160 to alert the network client that a network communication prominent. Embodiments provide a wearable CE that includes, but not limited to garments 10, other wearable 30, waist belt 120, watch, wearable glass, wearable bands, hats, ties, a diaper, measurement device, location determination device, detection device, a display device, a transceiver, shoes, a pad, tie, shocks, a brace, a napkin Outfit 160 is firmly secured on the officer's waist by the waist belt 120, and connector 25 being disposed within the waist area 130 for communications with the network Officer “A network client.” The shoes further disposed with sensors for measuring physical activities/fitness and for measuring burnt calories during physical activities. The pad further configured with sensors embedded in silicon substrate. Embodiments further provide the WCD being worn by an Officer 35, seen to have identified a suspicious person 40 patrolling at least agencies 80. The outfits 10, 30, and 120 are seen to provide exemplary CE during an emergency such as detected explosives 600 and gases 700. The IMMT 400 is further associated with the WCD 10, further configured analyzing detections for communication with a network 66. Network 66 further comprises a social media tool where various communities from around the world gather to discuss and share various TOI that are to be fashioned and/or modeled.

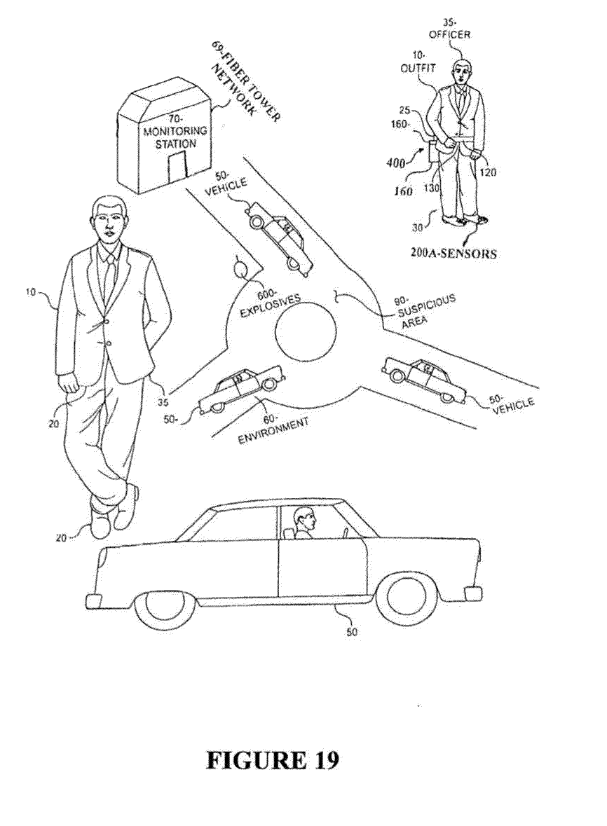

Referring to FIG. 19 is seen further embodiment of a monitoring system in association with a network station 70. The network station 70 further comprises a fiber tower network for enabling network communications that include monitoring, locating, and sharing information and/or data relating to celebrity, science, engineering, SMC. The network further comprises a tool for sharing social media TOI within a centralized SNE and/or with social network clients wearing a WCD. Disclosed embodiments further provide the WCD in association with a network for sharing knowledge. Certain embodiments provide the WCD being worn by a person 35 being outfitted with a WCD to provide physiological data of the person. The WCD 10 further comprises a detection outfit comprising of sensors embedded in silicon substrate and fused/etched in a nano-fiber/microfiber material. At least one sensor comprises a GPS sensor. At least an IMMT 400 is disposed with the WCD. Certain embodiments provide least an outfit 160 comprising a housing being secured on the waist area 130 via a waist belt 120 by the person 35. The housing further comprises silicon substrate nano-fiber/micro fiber being embedded with the sensors and operatively configured for detections, communications, monitoring, locating, and for generating electrical energy. The IMMT 400 is communicatively configured with signal booster apparatus operable for boosting signal reception to prevent radiation that may cause cancerous disease.

The WCD is responsive to network communications with the monitoring station 70 and/or fiber optic tower 69. The IMMT is further configured with battery cells responsive to electromagnetic signal for harvesting electrical energy to provide primary, secondary and/or supplemental empower. Embodiments further provide the WCD 10, comprising, but not limited to watches, eyeglasses and/or wearable glasses, wearable bands, rings, garments, shoes further disposed with NEMS/MEMS, pads, napkins, brace, hats, a diaper, measurement device, location determination device, detection device, a display device, a transceiver, phone cases/housings wearable by a person 35 and/or an ED for communications with a communications apparatus 400. Disclosed embodiments provide the CA further comprises a WCD that may be worn by a respective person 35. Outfits 10, 20, 30, 120, 160 and 130 are further disposed with GPS sensors operable for detections, including detecting weapons of mass destructions and locating personnel. By providing the person 35 with the WCD enables communicating information from a social network more effective IMMT 400. Interactive multimedia television is enabled via proximity to a smart phone environment in communication with a NE 60. The IMMT 400 may be configured to detect suspicious area 90 containing explosive 600. A suspicious vehicle 50 is seen to have been detected with weapons of mass destructions.

An exemplary embodiment of the knowledge being shared comprises the science of positivism. For example: A model of the “Joseph A. Tabe” the inventor, may be expressed as: Fearfully and wonderfully created by a Father who is a mighty warrior, great in battles, fearful in praises, and just to forgive, the Alpha and the Omega, who seeded me in a human body through spiritual encounter in human interaction, trusted unto them as parents who knew Him not. “Fashion of the Inventor:” Publicly declaring His name, His works, His wills, His gift, and His passion, His everlasting Love for me in Christ Jesus, who is the word of God and who has put every spirit of darkness to shame in the grave. “Dress code of the Inventor:” The Holy Spirit.

A Church Model: 1. A model for Christian growth and Church growth. 2. A visible structure consisting of people of faith united by their participation in God's spirit through Christ Jesus, transmitting his visible signs and invisible grace by faith, exhibiting personal proclamation over interpersonal relations and mystical communion as part of a total human family acting in union with the flow of God's Kingdom life.

A Church Leadership Fashion/Model: 1. A good shepherd lay down his life for his sheep. 2. One who leads by modeling godliness and righteousness in his own life and encouraging others to follow his example in Christ Jesus.

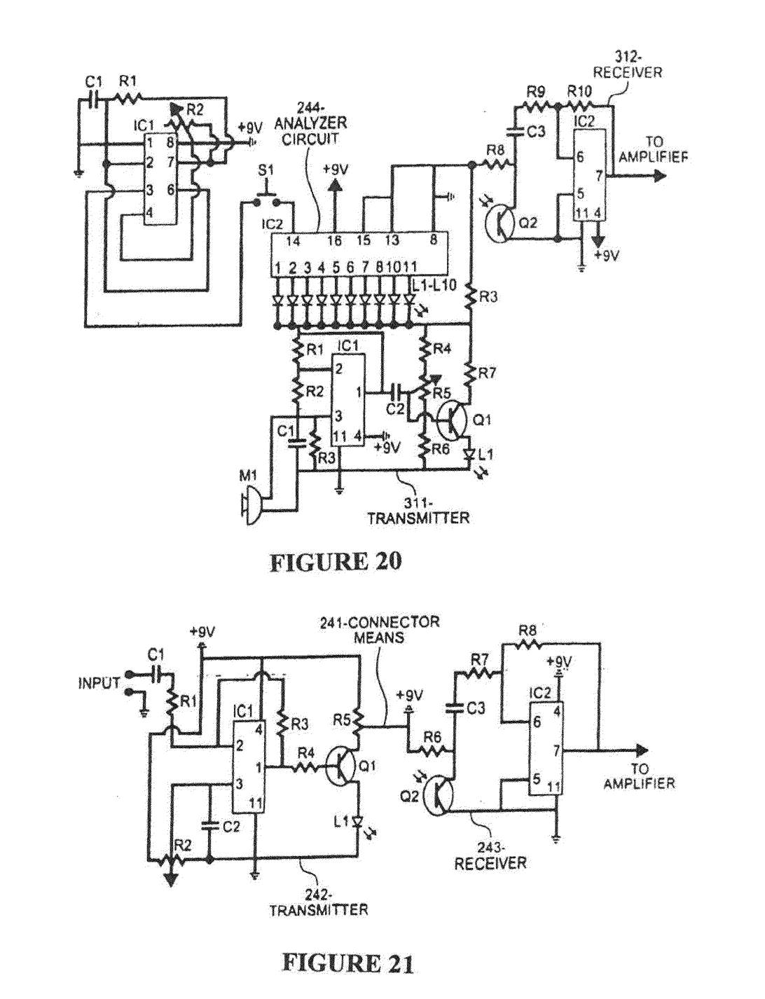

Referring to FIG. 20, the transmitter 242 is configured with energy apparatus comprising a battery cell which may be charged wirelessly. An amplifier is configured with the IMMT for amplifying signal communications. Transmitter 311 and receiver 312 are communicatively connected. Transmitter 311 and receiver 312 are communicatively connected to analyzer circuit 244. The CMOS circuitry is operable to dissipate less power. Certain embodiments provide the CA in association with a static logic configuration being operable on p-type and n-type metal-oxide-semiconductor field-effect-transistors “MOSFET.” further configured for implementing logic gates.

Referring to FIG. 21 is seen an exemplary embodiment of a transmitter 242 and 311, and a receiver 243 and 312. The amplifier is seen responsive to signal communications. Transmitter 242 is operatively configured with receiver 243 and communicatively connected to connector beam 244 responsive to communication network connections. The amplifier comprises a chip communicatively connected to a receiver 243 and operatively configured with transmitter 242. The transmitter 242 and 311, and the receiver 243 and 312 comprise CMOS comprising of solar cells on n-type CZ silicon substrates, including Polycrystalline thin-film cells, lightly boron-doped CZ, or gallium-, indium-, and aluminum-doped CZ for converting solar energy, pressure force, sound wave, vibration, wind force into electrical energy. Disclosed embodiments further provide the WCD in association with thin-film comprising thin layer of transparent conducting oxide, including tin oxide. Certain embodiments provide the oxides being highly transparent and configured to conduct electricity efficiently. Some embodiments provide thin film further associated with antireflection coatings.

Other embodiments provide Polycrystalline thin-film cells comprising tiny crystalline grains of semiconductor materials operable for converting solar energy into electrical energy. At least a CPU-1C1 is provided in communication with RFID chip reader-1C2. L1 and L2 are LED. S1 is an automatic momentary single pole double throw switch operative for transmitting and for receiving signals. C1 is an electrolytic capacitor being disposed on an energy platform comprising C2 and C3, which are IMF capacitors. Q1 and Q2 are infrared LED emitter and M1 is a speaker microphone. R1 through R10 are resistors responsive to signals. Disclosed embodiments provide a digital signal processing system which allows signal transmission reconfiguration to the environment to improve signal conditions. At least the antenna is developed for electrical operation, which can be reconfigured in terms of frequency and may also increase or decrease its directivity. The increase and/or decrease of signal directivity are a measure of the gain of the antenna in a particular direction. Disclosed embodiments provide the IMMT further configured with the antenna to operatively pick up faint signal by increasing its gain or overcome interference by creating a null point. Certain embodiments provide a smart IMMT further configured for operation on any given network or environment. Some embodiments provide a miniaturized adaptive nano/micro antenna in communication with at least a chip configured for signal amplification and to minimize interference and maximize intended signal reception. Disclosed embodiments provide the signal amplifier further comprises a signal booster chip comprising of at least a MEMS, in communication with a logic circuit.

The MEMS further comprises MEMS based phase shifters further configured on at least a single silicon substrate microfiber and/or substrate nano-fiber comprising communication control circuitry. The sensors are being coated with silicon substrate polymer and/or with zinc oxide layer to provide energy transport platform. Certain embodiments provide the IMMT further associated with silicon substrate nano-fiber/microfiber configured with optical properties of thin films being operable for the advancement of the integrated circuit for converting solar energy into electrical energy. Disclosed embodiments further provide the CA further configured to enable smaller feature sizes, faster switching speeds, and lower power consumption. Some embodiments provide the CA in association with a cell platform configured with basic wiring such as dielectric and photolithographic layers, providing a circuit for electrical energy production. This integrated circuit could employ copper/low-k interconnects, silicon-germanium and silicon on insulator-based transistor structures. Infrared spectroscopy is provided to offer metrology approach to sensing through the display/input device/outfit, complementary to UV-VIS techniques that provide excellent sensitivity to layer composition, including chemical bond densities and free carriers with the enhanced immunity to roughness induced scattering.

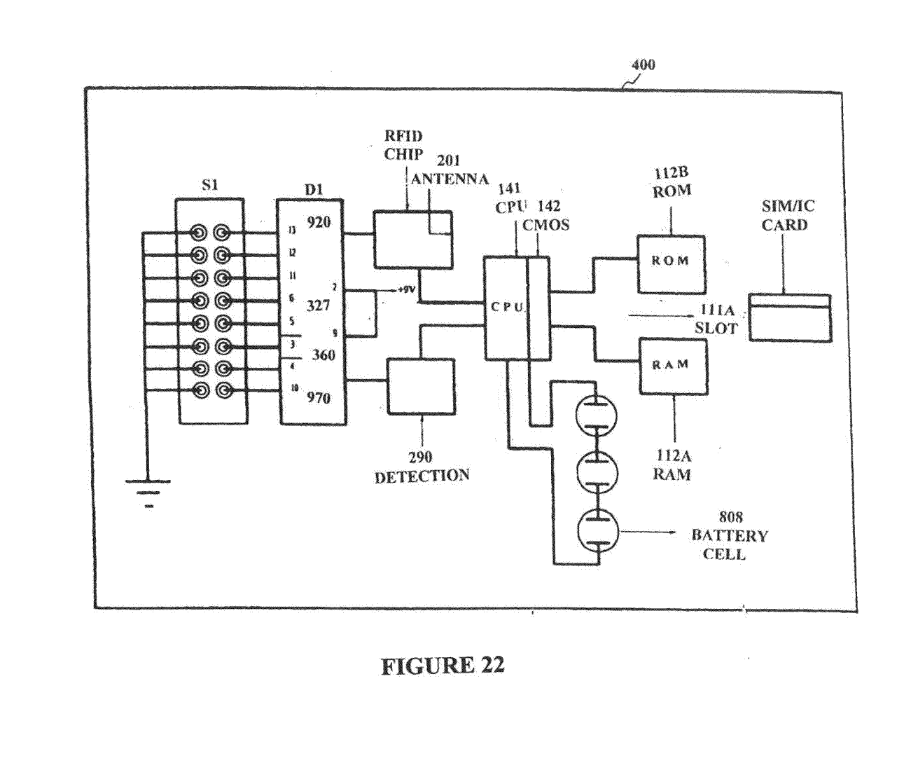

Referring to FIG. 22 is seen an embodiment of the circuit diagram of the IMMT being disposed with a privacy indicator. Switch (51) is communicatively connected to RFID CHIP for signal amplification. Certain embodiments provide a common node display (D1) comprising touch screen operatively configured with multifunctional sensors 970. The display device is further operable for executing functions and for generating energy. The RFID CHIP further operatively configured with antenna 201. A CPU 141 is operatively configured with detection device 290 communicatively connected to at least a CMOS 142. The detection device is responsive to detection signal communications and operatively connected to a battery cell 808. The IMMT 400 further comprises an IC and/or SIM card slot 111A comprising SD card slot and/or HDMI/USB ports. Embodiments further provide the IMMT in association with user identification card 112. The IMMT 400 further disposed with an operating system consisting of software operatively configured with ROM 112B to read the ID card 112. The ROM 112B is communicatively configured to provide communications to the RAM 112A. The RAM 112A is responsive to communication database 113 where information may be stored or retrieved. A screen readout 113A is configured with the CA. An 8-pin privacy indicator switch (51) in association with the IMMT 400 and configured for providing private communications. Switch (51) further comprises of display selections corresponding to cathode A, cathode G, and cathode D of at least a 7-segment common anode display settings (D1). Chip 200a comprises a detection tool responsible for providing communications to at least a network. The IC and/or SIM card 112 is further operable with the IMMT 400, comprising wireless communication applications in communication with a software program.

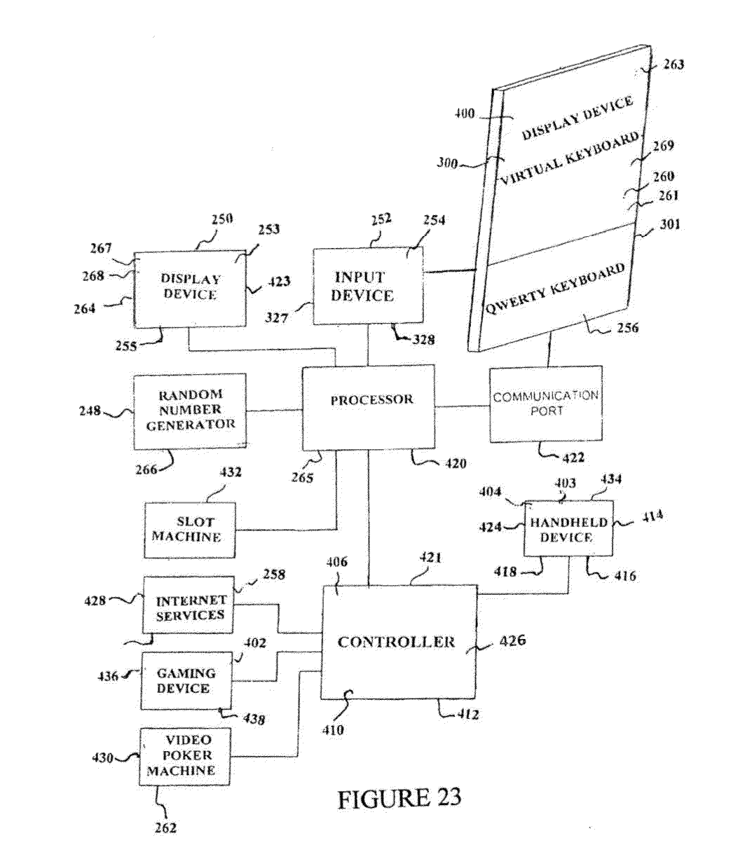

Referring to FIG. 23 is seen an exemplary embodiment of the CA. The IMMT 400 comprises at least an input device 252, including a keyboard 254. The keyboard 254 may consist of a virtual keyboard 255 and/or QWERTY keyboard 256 in further communication with a random number generator 248. At least a social network application 258 is configured with the keyboard and in communication with the processor 420. Disclosed embodiments further provide the keyboard comprising a touch screen being disposed on an LCD display screen 260 configured with sensors 327 operable for object recognition. Certain embodiments provide the sensors 327 configured for video recognition 262. Some embodiments provide the IMMT configured with a display device 260 in association with an activation button 264 configured for activating at least one of: phonebook 266, calendar 268, dictionary 267, calculator 265, and camera 263. Disclosed embodiments further provide the IMMT further comprising at least one of: a mobile communication device 400, a gaming device 402, a media device 403, and an interface device 404. Disclosed embodiments provide the interface device further comprises at least an integrated phone in association with/PDA 400 configured with integrated connectivity apparatus 406 operable to provide global roaming. At least a communication port 422 is associated with the IMMT 400. Certain embodiments provide the IMMT comprising a GSM phone 400 in association with plurality microprocessors 420. Certain embodiments provide the IMMT further operable to allow multiple inputs/outputs 252. Some embodiments provide the IMMT in association with a touch interface 261 operable on a touch screen 260 configured for at least one of: interactive communication, interactive gaming, interactive music, interactive video, and phone book.

Yet other embodiments provide the IMMT further configured with at least a slider 253 operable to access multimedia buttons and/or numeric keypads further configured with piezoelectric sensors 327. The piezoelectric sensors 327 further comprise crystals 328 configured to provide voice operations and/or voice over text applications. Disclosed embodiments provide the IMMT further configured with voice over text technology operable to provide hands free texting applications while driving. Still, other embodiments provide the IMMT being disposed with carbon fiber 408 and/or silicon substrate nano-fiber/microfiber consisting of resistive touch screen 260 in association with character recognition 269 and/or a communication board 300. Certain embodiments provide a housing 301 in association with the IMMT 400. The housing further comprises carbon fiber 408 and/or a silicon nano-fiber/microfiber configured for energy harvesting.

Disclosed embodiments further provide an IMMT further configured with at least a WAP browser 410, an integrated GPS device 412, an MP3 music device 414, a camera apparatus 416, and an internal antenna apparatus 418 each in association with a controller 421 in communication with a predictive text messaging applications 423. The network further comprises a terrestrial radio frequency receiver 243 configured to receive media segments and associated IMMT 400 via radio waves from the terrestrial radio transmitter 242. The terrestrial radio frequency receiver comprises an antenna 201 and a CMOS 142. The antenna 243 is configured to receive radio waves of frequencies set by the CMOS 142 and the terrestrial radio frequency receiver 243 processes the radio waves into electric signals and sends the electric signals to the processing unit 122. IMMT 400 associated with the media segments can include information such as a title of the media segment and a performer performing the media segment. The terrestrial waves include FM radio waves and AM radio waves. In one embodiment, the terrestrial radio frequency receiver 243 includes CMOS MAOC, such that media segments can be received from multiple radio frequencies simultaneously.

Disclosed embodiment further provide a satellite radio comprising a radio frequency receiver 424 configured to receive satellite radio waves from the satellite radio transmitter 242, decrypt information received by the satellite radio waves, and to convert the information received by the satellite radio waves to signals that can be processed by the processing unit 122. Information received by the satellite radio waves includes media segments and associated IMMT 400. In one embodiment, the satellite radio frequency receiver 424 sends encrypted radio signals such as, when receiving media segments from subscription services to the processing unit 122, and the processing unit 122 decrypts the radio signals.

In alternate embodiments, media segments and IMMT 400 can be received via other types of wireless communications. Exemplary types of wireless communications include TV band communications such as: UHF and VHF band communications, wireless peer-to-peer communications accessing the Internet through at least one of: Wi-Fi and/or Wi-Max communications network, and cellular communications. The network interface 170 further comprises data network interface operable to facilitate transmission and receipt of wireless communication. Certain embodiments provide the wireless communication further enabled via radio frequencies between the processing unit 122 and data networks such as an external network CA 24, the GPS device 412, and/or the messaging/personal scheduling device 423. In one embodiment, the wireless data network interface 170 accesses the network CA 24, the GPS device 412 and the personal scheduling device 423 utilizing wireless peer-to-peer communications such as Wi-Fi and Wi-Max communications. Some embodiments provide the network CA further comprising a communication network 24. Certain embodiments provide the IMMT 400 further configured with at least one of: infrared sensor 326, calendar 268, FM radio 424, Bluetooth technology 426, and GPRS Internet services 428. Disclosed embodiments further provide the IMMT 400 comprises at least one of: a video poker machine 430, a slot machine 432, a handheld device 434, a gaming device 436, and a play station 438, each in communication with communication port 422.

The social network application 258 further comprises at least one science TOI, including FWM consisting of a social platform for publicly declaring the will of positivism, sharing human knowledge for organized studies, dealings with the body of facts and truths to explain the phenomena of social media in the environment of natural fashion media, model media, and dress code media “FMDC,” exhibiting a dimension of social sustainability to gracefully improve corporate and community wellbeing through social, cultural, environmental, and economic vision by the goodness of change. Change can be embraced with the hope for sustainable cultural independence.

FMDC is about public declaration, a social media consisting of a network that comprises of dynamic database driven platform that enables interactive web content creation, collaboration, and exchange. The network is a social platform for publicly declaring the will of positivism, comprising the gathering of human knowledge that are reliably organized for shared studies, dealings with the body of facts and truths governing a SS that acquires knowledge for human observations to explain the phenomena of social media in the environment of natural fashion media, model media, and dress code media “FMDC.” The FMDC network further comprises of a social platform for providing substance of things hoped for, revealing the evidence of things not commonly seen. This evidence of things not commonly seen is CHANGE, which can be embraced with the hope for sustainable cultural independence, for by CHANGE the society receives good reports that things which are seen were not spiritually made of things which do appear, but are made through creative minds and innovative discoveries that may lead to economic growth, not as a means of inquiry, but rather as a dimension of social sustainability to gracefully improve corporate and community wellbeing through social, cultural, environmental, and economic vision by the goodness of change.

In reality, a socially sustainable community should have the capacity to deal with change and to adapt to changing situations and attributes that may be essential for globalization. FMDC network is a network of change, providing a CE that has the capability of moving data between storage areas sufficiently scheduled for media communications for reasons of performance and convenience, establishing private CE for individuals and groups such as colleges, universities, churches, stores, organizations, cultural entities, businesses, corporations to explain the phenomena of social media in model media, fashion media, and dress code media, communicating to one another through a centralized system.

The human knowledge is organized bodies of knowledge that are shared by people so as to produce useful feeds that comprise of reliable knowledge about at least an FMDC TOI to aid and educate the society through the environment of social enterprise. Social enterprise consist of social measurements relating to the way society operates through a systematic examination of truth, existence, reality, causality, exhibiting the freedom of shared knowledge relating to at least one FMDC TOI. Social measurements comprise of asserting the influence of FMDC for the betterment of the society by contributing to product offerings through a blend spirit of positivism and methodological evolution of information backed by the organizing principles underlying the science of Fashion, Models, and Dress Code.

The methodological evolution of FMDC information is embodied for societal change that comes with time, and time blends with technologies and innovations. That is why FMDC sharing is embodied to change the way knowledge is derived about an object, a business, a corporation, an institution, an educational institution, a testimony, a Pastor, an art, an event, a project, a play, a book, a culture, a Bishop, a struggle, a success, the society and its environment. Social measurements further leads to generational awareness, brand awareness, leadership awareness, business awareness, corporate awareness, educational awareness, professional awareness, ethical awareness, religious awareness, institutional awareness, social awareness, cultural awareness, sociological awareness, professional awareness, causal awareness, and service efficiency to the society relating to the positivism in fashion media, model media, and dress code media. Individuals, businesses, corporations, religious groups, cultural groups, and community organizations/associations must have the freedom to choose how to improve their product life in the context of fashion media, model media, and dress code media for their product line. Just as true prophecy never come by the will of man, but from God through the Holy Spirit to bring Lamb upon our feet and Light upon our paths, so must the positivism of good products/objects be lightened to bring out the truth by modeling the products/objects to create a clear path for knowledge and economic growth.

Social enterprise further includes bringing the actualization of potentials in Fashions, Models, and Dress Codes “FMDC” through an objective reality of social bodies being shared in a shared environment by observers that are governed in the SS. The SS is communicable through electronic NE by means of observation to sharing a common reality that is not commonly absolute by all observers. The shared environment further comprises the Internet comprising electronic CE for sharing productive/objective TOI on the FMDC network. The SS further comprises a dynamic website that includes dynamic database driven web-pages by means of server site programming. Certain embodiments provide the dynamic website further comprises a SS comprising a platform operable for communicating with the dynamic web-pages. The SS is further configured with interactive interface. The interactive interface is configured with a software based system that provide peer-to-peer CE to enable knowledge based sharing system that is properly configured for efficient communications and that supports decision making. A multicast approach may be employed to deliver these communications between clients within the network and to update the network with additional tools for further interactions and/or interactive communications. The multicast approach includes technologies to deploy the multicast service in existing multiprotocol label switching virtual private network “MPLS/VPN” for transmitting multicast data between FMDC clients within the FMDC network through their private networks by encapsulating the original multicast packets.

The organized bodies of knowledge through the SS would allow the mind and spirit of observers to generate its own reality, in that, what is true in one observer's mind may not be true for other observers. The reality here comprises of the knowledge of positivism, which is the knowledge based on actual positive sense in near real physical, visual and/or virtual experience based on social and/or sociological facts that may lead to economic knowledge in social values. For example, just as a human brain may be pronounced dead by a doctor, the heart in that same body may bring to life another separate body of faith in need of a heart transplant. This is the spirit of positivism.

The dynamic website is further configured for social network activities and for generating dynamic database driven web-pages using server site programming tools. The dynamic website comprises a platform for CSP in which a client would have to log into the website to create a user account to enable an access point. Once the access point is enabled, client would be allowed access to do at least one of: Model themselves, Model their product, Model their jobs, Model their hobbies, model their favorite shows and participants of the shows, model their company, Model their favorite sport and/or the best player for that sport, Model their state, country, government, president, governor, model their educational institutions, model their professions, model their professors, model their favorite stars, minister, CEO, curses, books, authors, schools, etc.

Client would be allowed access to Fashion their Models and to describe and/or prescribe a Dress Code for their models. Upon completion and clicking the complete button, a web-page and/or a virtual private network “VPN” would be established for the client account and the client would be able to share or connect with others, friends, and people in the centralized FMDC organizational network of Models, Fashions, and Dress Codes. The presentation of models, fashions, and dress code contents must be created by clients, and FMDC network would moderate the contents. Clients would display FMDC account on their blog or on user profiles that they own on other social networking accounts. This, in turn, gives you more back-links and more attention. Community members would be able to create or be part of a subculture within the FMDC network. Let the voice of the community create an existing model based on the CCL. Let the voice of a religion affiliation create a model based on their culture. The VPN is a private network within FMDC network that uses a public network such as the Internet to connect clients at remote sites together in FMDC network. Instead of using a dedicated, real-world connection, such as leased line, the VPN uses virtual connections routed through the Internet from remote sites of clients to the FMDC network. VPN permits secure, encrypted connections between FMDC network and clients' private network at remote sites. FMDC may act as a third-party service provider between clients and their observers. The VPN is to connect clients in the network with other clients in the same network, forming intranet/extranet VPN or network gateway, while providing better features such as:
Security
Reliability
Scalability
Network Management
Policy Management

Additionally, data in each account would constitute a packet. Each packet would be assigned a label so that data from one client to another client would be directed on short path labels to enable high performance network CE through multiprotocol label switching “MPLS.” The labels may be configured to identify virtual links comprising paths between distant notes or switches. The multiprotocol label switching network approach would allow data packets forwarding decision to be made solely on the contents of the label without examining the packet itself. With this design approach, circuits would be controlled across any type of transport medium using any protocol. Usernames and passwords are stored on the VPN termination device server, or on an external server, which would provide authentication to numerous other databases such as Windows NT, Novell, and LDAP. The MPLS would be able to route packets through the network by utilizing “label switching” which comprises tagging or labeling high priority traffic and routing those packets through FMDC high capacity circuits and routing non-critical data through low cost, low capacity circuits consisting of a single integrated IP network that is highly optimized.

What MPLS brings is the ability to create reliable VPN without the use of VPN clients reducing the level of management and deployment complexity considerably. The advantage of MPLS in FMDC network is that it eliminates multiple routers, firewalls and IT management headaches from all of the remote locations by putting control and management of the entire network into one center such as the main FMDC network. The backing of the MPLS VPN Data would allow FMDC network to provision among other things, and manage intranet and extranet VPNs within the network. Other embodiments provide the VPN in association with the FMDC network. The network is further designed with multipoint technology approach to making specific VPN tunneling unnecessary, so that when data is moved from one client site to another, it would look up the client site in the routing table, adds a tag for that site, and sends the packet to the next router. With this embodiment, latency is reduced for client inter-site data transfers. Embodiments further provide flattened wide area network operable for simplifying engineering approach to delivering data between clients in the network. This approach requires clients' remote sites to be connected to FMDC network through MPLS network.

When a request to establish a tunnel “the process of encapsulating an entire packet within another packet and sending it over a network” comes in from a client, the VPN software would prompt for a username and password. This must be authenticated or sent to the external server, which would check for:
Who the client is (Authentication)
What the client is allowed to do (Authorization)
What the client actually does (Accounting)

The accounting information is especially useful for tracking client activities for security auditing, billing or reporting purposes

The VPN comprises a social VPN created automatically for individual client within the FMDC network. The creation is based on relationships established by clients through the FMDC network. The VPN is desired for providing peer-to-peer network connectivity between a client and his or her friends, in an easy to set up manner that hides from the client the complexity in setting up and maintaining authenticated/encrypted end-to-end VPN tunnels.

The architecture of the Social VPN further comprises a centralized infrastructure where clients/users authenticate, once the account is confirmed, clients would then be allowed access to display their models, fashions, and dress code and be discovered by their friends whom they have exchanged cryptographic public keys with. This is enabled by a peer-to-peer overlay which is used to route messages and deliver videos between VPN endpoints.

The VPN is configured for communication with a virtual network interface that includes tap/tun devices in Windows and UNIX systems via personal digital assistant (PDA) to capture and inject the IP packets from the FMDC network. Once captured, packets are encrypted, encapsulated, and routed over an overlay network. The VPN is further configured for FMDC online social network communications with the capability to distribute public keys and advertise node address to friends. The acquired public keys are necessitated to establish encrypted communications between two endpoints. In this manner, symmetric keys are exchanged during the process of establishing end-to-end links by FMDC peers in the network. Routing in the FMDC Social VPN is a peer-to-peer that is structured for communications within the system for sending IP packets that are encapsulated in overlay messages from a source to destination.

Within the FMDC Social VPN, a dynamic IP address is assigned and translated to avoid collision with existing (private) address spaces of the network, allowing the system to scale to the number of clients/users of the network to successfully maximize the FMDC online social network service serviceable for millions of clients. Clients would be able to connect directly to a subset of the total number of clients with access to their TOI within the FMDC network. The subset is determined by clients established relationships. Each client would be assigned VPN names derived from the FMDC social network services to serve as the assigned host names to endpoints. These names are translated to virtual private IP addresses in the overlay by a loop-back DNS virtual server.

A model is a representation of a system that allows for investigation of the properties of the system and/or prediction of the future outcomes. A model comprises of many shapes, sizes, and styles. It is important to emphasize that a model is not just the real world object but also consist of human construct to help the society better understand real world systems via personal digital assistant (PDA). A model should at least have an information input, an information processor, and an output of expected results, and should provide an environment where:
simplifying assumptions must be made;
boundary conditions or initial conditions must be identified
the range of applicability of the model should be understood

This may include conceptual models that consist of qualitative models highlighting important connections in real world systems via personal digital assistant (PDA) and processes as a first step in the development of the more complex models. People receive information, process this information, and respond accordingly many times each day. This sort of processing of information is essentially a conceptual model of how things in our surrounding environment actually work.

An exemplary embodiment of “The Sun model:” 1.) The intensity of scattered light from the atmosphere increases with decreasing wavelength. 2.) The intensity of scattered light is inversely proportional to the 4th power of wavelength.

An exemplary embodiment of “A model of the Inventor:” Fearfully and wonderfully created by a Father who is a mighty warrior, great in battles, fearful in praises, and just to forgive, the Alpha and the Omega, who seeded me in a human body through spiritual encounter in human interaction, trusted unto them as parents who knew Him not. “Fashion of the Author:” Publicly declaring His name, His works, His wills, His gift, and His passion, His everlasting Love for me in Christ Jesus, who is the word of God and who has put every spirit of darkness to shame in the grave. “Dress code of the Author:” The Holy Spirit.

An exemplary embodiment of “A Church Model:” 1.) A church is a model for Christian growth and Church growth. 2.) A visible structure consisting of people of faith united by their participation in God's spirit through Christ Jesus, transmitting his visible signs and invisible grace by faith, exhibiting personal proclamation over interpersonal relations and mystical communion as part of a total human family acting in union with the flow of God's Kingdom life.

An exemplary embodiment of “Church Leadership Fashion/Model:” 1.) A good shepherd lay down his life for his sheep. 2.) One who leads by modeling godliness and righteousness in his own life and encouraging others to follow his example in Christ Jesus.

A model may also be visualized as a visualization model. Visualization models comprise of direct links between data and some graphic or image output that may be linked with other type of models to convert the intended output into a visually useful format.

A model may also consist of abstractions of reality to deliberately emphasize one part of the reality at the expense of other parts. This is necessary due to objective power limitations, and may enable others to focus their attention on an important aspect of the model. Models are also mathematical, logical, business, corporate, or some other structured representation of reality consisting of the specific applications of the models to arrive at some outcome.

Fashion is an art, ultimately consisting of individual statement of expression. It is also a religion, a job, a peek into a personality, playfulness, an escape, or a disguise. Fashion is a feast for the eyes. Fashion is not something that exists in dresses only. Fashion is in the sky, in the streets, and has to do with ideas, the way we live, what is happening around the society. Fashion isn't defined solely by clothing choices, but it is also conveyed through the way we carry ourselves, our personalities and our views of the world. Fashion comprises of a prevailing style, custom, dress, or behavior.

Fashion also comprises fashion trends, consisting of anything which is popular in a culture at any given time. Fashion is inclusive of areas such as; style of dress, cuisine, literature, art, architecture, and structures, fashion trends and many other popular factors. Though fashion trends often change rapidly, fashion is often used to describe the latest version of these trends. Fashion is also used positively as a synonym for style, glamour and beauty. However, fashion can also be expressed to have negative connotations of fads and trends, and materialism.

Dress Code is a set of rules governing what garments may be worn together and in what setting to convey a social message. Clothing can convey a social message, even if none is intended. If the receiver's code of interpretation differs from the sender's code of communication, misinterpretation follows. In every culture, current time fashion governs the manner of consciously constructing, assembling, and wearing clothing to convey a social message. Clothes convey other social messages, including the stating, claiming personal, cultural identity, establishing, maintaining, defying social group norms, and appreciating comfort and functionality.

The platform further comprises the virtual private network (VPN), which is a network that uses primarily public telecommunication infrastructure, such as the Internet for connectivity, to provide remote offices that include addresses, blogs, link-sites, websites, and/or traveling client/users through to allow access to TOI in the central organizational network for the distributions of data relating to potential knowledge in models, fashion, and dress code. The VPN typically requires remote users of this network to be authenticated and secure data with encryption technologies to prevent disclosure of private information to unauthorized parties. The VPN may serve any network functionality that is found on any network, such as sharing of data and access to NRs such as printers, databases, websites, etc. In this regard, a VPN user typically “registered users” would be able to experience the central network in a manner that is identical to being connected directly to the central network. The VPN further includes a technology via the public Internet to replace the need to requisition and maintain expensive dedicated leased-line telecommunication circuits found typical in wide-area network installations. Further benefit of the virtual private network technology includes costs. The VPN reduces costs because it would not need physical lease lines to connect remote users to the Intranet “a network of communications, using World Wide Web conventions, accessible only to authorized users within a company” operations. The VPN system is classified by:
The protocol used to tunnel the traffic; the tunnel's termination point, i.e., customer edge or network-provider edge; whether they offer site-to-site or remote-access connectivity; the levels of security provided; the OSI layer they present to the connecting network, such as Layer 2 circuits or Layer 3 network connectivity

The VPN security comprises of cryptographic tunneling protocols to provide:
Confidentiality by blocking intercepts and packet sniffing and for allowing sender authentication to block identity spoofing and message integrity by preventing message alteration

The MPLS is a platform consisting of a mechanism in high-performance telecommunication networks that directs data from one network node “one registered member” to the next “registered member” based on short path labels rather than long network addresses, so that long complex lookups in a routing table would be avoided. In this embodiment, the labels would identify virtual links (paths) between distant nodes “terminal or points in the network where a message/data can be created, received, or transmitted” rather than endpoints “transmitting and receiving.” The MPLS should be able to encapsulate packets “message or part of a message packaged as a fixed-size segment of data for transmission through the FMDC network” for communications with various network protocols. The MPLS should also be able to support a range of access technologies, including T1/E1, Tier1, Tier2, Tier3, ATM, Frame Relay and DSL. The MPLS is highly scalable, protocol agnostic, and further comprise of data-carrying mechanism. In FMDC MPLS network, data packets are assigned labels. Packet-forwarding decisions are made solely on the contents of this label, without the need to examine the packet itself. This would allow the FMDC network to create end-to-end circuits across any type of transport medium, using any protocol. The primary benefit is to eliminate dependence on a particular OSI model data link layer technology, such as Asynchronous Transfer Mode (ATM), Frame Relay, Synchronous Optical Networking (SONET) or Ethernet, and also eliminate the need for multiple layer-2 networks to satisfy different types of traffic. The FMDC MPLS network consists of a family of packet switching networks.

The platform further comprises a decision SS (DSS), consisting of a communication-based information system that supports business or organizational decision making activities. The DSS would be able to serve the management, operations, and planning levels of our organization and help us to make decisions, which may be rapidly changing and not easily specified in advance.

The DSS is a knowledge based system consisting of interactive software-based system intended to help organization decision makers compile useful information from a combination of raw data, documents, personal knowledge, or business models to identify and solve problems and make decisions for the company to enable serve our users better. The decision support application includes gathering of information such as: inventories of information assets (including legacy and relational data sources, cubes, data warehouses, and data marts), comparative sales figures between one period and the next, projected revenue figures based on product sales assumptions.

The platform further comprises means for communicating with servers, including communication programs running to serve the requests of other programs such as the clients. The server is configured to perform some computational task on behalf of “clients”. The clients may either run on the same communication or connect through the network. The servers are also physical communication such as a communication hardware system dedicated to running one or more such services as host, to serve the needs of users of the other remote communications on the network. The services further require a database server, a file server, a mail/email server, a print server, a web server and other servers to support the efficient operation of the network. At least one server is operable as a socket listener to provide other essential services across the network, either to private users inside a large organization or to public users via the Internet. For example, a query is routed in a search engine server from client communication over the internet to the servers that store all the relevant web pages. The results are sent back by the server to client communication. Our NE would employ the following servers:
Application server, a server dedicated to running certain software applications
Catalog server, a central search point for information across a distributed network
Communication server, carrier-grade computing platform to enable network communications
Database server, provides database services to other communication programs or communications
Fax server, provides fax services for clients
File server, provides file services
Sound server, provides multimedia broadcasting, streaming.
Standalone server, an emulator for client-server (web-based) programs
Web server, a server that HTTP clients connect to in order to send commands and receive responses along with data contents. The data content including electronic data for electronic data management.
Client server, almost the entire structure of the Internet is based upon client server model. Other servers would include high-level root name server, DNS server, and routers operable to direct traffic on the internet to the platform.

The platform further include a multicast for the delivery of a message or information to a group of destination client communications simultaneously in a single transmission from the FMDC network “the source” creating copies automatically in other network elements, such as routers, only when the topology of the network requires it. The multicast is commonly implemented in IP multicast, which is employed in Internet Protocol (IP) applications of streaming media and Internet television. In IP multicast the implementation, the multicast concept would occur at the IP routing level, where routers create optimal distribution paths for data-grams sent to a multicast destination addresses. At the Data Link Layer, multicast describes one-to-many distribution such as Ethernet multicast addressing, Asynchronous Transfer Mode, (ATM) point-to-multipoint virtual circuits (P2MP) or Infiniband multicast. The platform further includes a packet consisting of a formatted unit of data that is carried by a packet mode communication network. Communication communications links that do not support packets, such as traditional point-to-point telecommunications links, simply transmit data as a series of bytes, characters, or bits alone. When data is formatted into packets, the bitrates of the communication medium can be better shared among users than if the network were circuit switched.

The FMDC network further comprise a platform comprising of a neural network consisting of an interconnected group of artificial neurons that processes information using a connectionist approach to computation. The neural network may include an ANN consisting of an adaptive system that changes its structure based on external or internal information that flows through the network during the learning phase. The neural networks may further comprise of a non-linear statistical data modeling tools for modeling complex relationships between inputs and outputs or to find patterns in data. The neural network may further be configured with network element, being defined as a manageable logical entity uniting one or more physical devices. This would allow distributed devices to be managed in a unified way using one management system such as the centralized FMDC network.

According to Telecommunications Act of 1996, the term ‘network element’ means a facility or equipment used in the provision of a telecommunications service. Such term also includes features, functions, and capabilities that are provided by means of such facility or equipment, including subscriber numbers, databases, signaling systems via personal digital assistant (PDA), and information sufficient for billing and collection or used in the transmission, routing, or other provision of a telecommunications service.

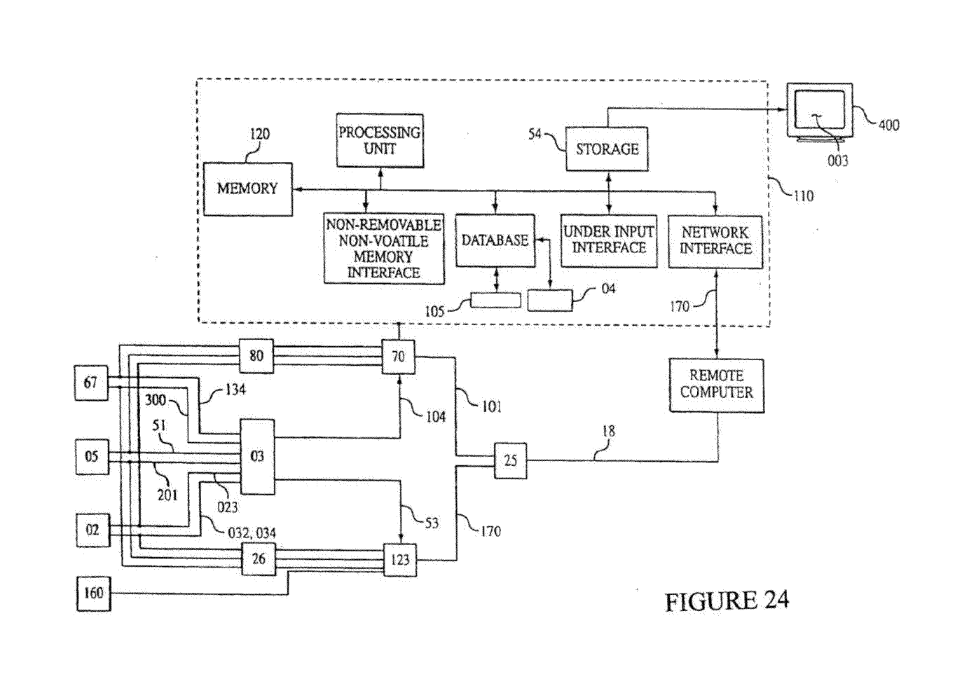

Referring to FIG. 24 is seen further exemplary embodiment of the IMMT 400 comprising, storage medium 54, a processing unit 122, and CMOS 142, in communication with a memory device 120. Disclosed embodiments further provide a non-removable non-volatile memory interface, a database, input interface and network interface 170. Certain embodiments provide the IMMT disposed with hardware 105, a graspable hardware/browser 04, and a display device 003. Other embodiments provide IMMT 400 disposed with software 300, central processor 51, a RAM 05, a ROM 02, a network adaptor 160, and a media device 201. Disclosed embodiments further provide an IMMT 400 in association with at least an output device 70, a remote communication in communication with a connection key 25. The connection key is further in communication with industrial files 18, network files 110, decision engine 123, graphic user interface 101, sensors 104, and system memory 53. Certain embodiments provide the IMMT further configured with system bus architecture 67 in communication with an input device 80. Some embodiments provide the output device 70 further comprises a report generator 134 in communication with an instruction program 26. At least a CPU 03 is provided, in communication with a java class 023, a clickn Vest Servlet class 032, and a Servletrunner application 034.

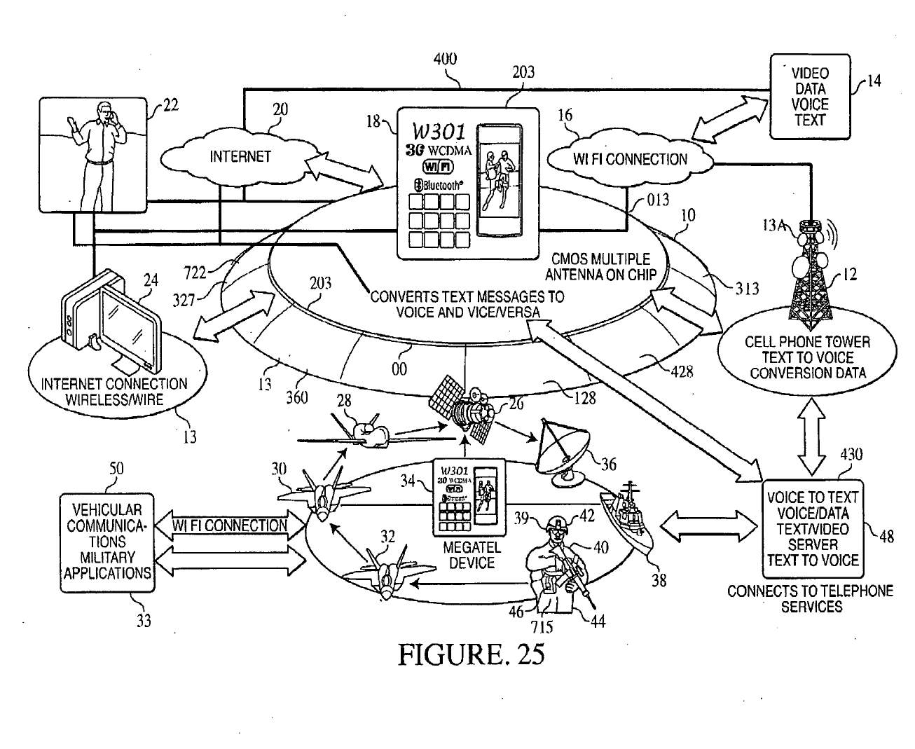

Referring to FIG. 25 is seen exemplary embodiment of the disclosure, comprising an IMMT 400 in communication with CMOS MAOC 10. The CMOS MAOC is configured with silicon substrate microfiber/nano-fiber. Disclosed embodiments provide the CMOS MAOC configured for communications and for converting text messages to voice auditory messages and voice messages to text messages. The CMOS MAOC are configured for installation on cell phone towers 12, further operable for converting electromagnetic radiation into electrical energy. Certain embodiments provide the CMOS MAOC further configured for transmitting/receiving video data/voice text device 14. Some embodiments provide the CMOS MAOC operable for Wi-Fi connections 16. Other embodiments provide the CMOS MAOC comprising at least a receiver apparatus and/or a transmitter apparatus for a communication device 18. The communication device further comprises at least a 4G and/or at least a 5G communication device operable on at least a network. The network further includes a millimeter wave spectrum. The communication device may comprise a 4G and/or 5G further operable on a WCDMA and/or a Wi-Fi network. Some embodiment provides the communication device comprising an energy harvesting smart phone “E-PHONE.”

The communication network 24 further comprises a media segment guide operable for disseminating information utilized to update fields of the database 113. The guide further includes software program 300 in communication with a plurality of media segment identifiers along with availability information associated with each media segment. In one embodiment, the software 300 provides information including a plurality of media segment identifiers, an available time associated with each media segment, such as the time at which the media segment is broadcast, and access information associated with each media segment identifier, including information from the radio station that the media segment will be broadcast on. Other embodiments provide the media segment in association with the IMMT for communications with the software 300 to periodically update data content within the storage medium 54. Disclosed embodiments provide the media segment software 300 being downloadable from the Internet. In an alternative embodiment, the software 300 is stored externally such that a system may exhibit the media segments or access the software 300 from the Internet if the system for exhibiting media segments does not store the software 300. Disclosed embodiments provide the GPS device 412 further configured to provide information relating to a global position. In one embodiment, the GPS device 412 provides GPS coordinates indicative of a current global position of the network 24. In one embodiment, the GPS device 412 communicates to the network 24 through the communications apparatus 400 and 430. In one embodiment, the GPS device 412 communicates with the network 24 either wirelessly or through communication wires.

The storage medium 54 further comprises a storage device for storing digitally encoded data. Exemplary storage devices for the storage medium 54 include flash memory storage devices, magnetic hard drive storage devices, solid state storage devices, and like data storage devices. Some embodiments provide the storage medium 54 comprising a single storage device accessible by the processing unit 122. Certain embodiments provide the storage medium 54 further comprises multiple storage devices, wherein each storage device is accessible by the processing unit 122. The data stored by the storage medium 54 includes data associated with the software 300, data associated with a memory device 120, data associated with recorded media segments 201, data associated with a database 113, and data associated with other processing software 023. The memory device 120 includes media segment identifiers that identify media segments available for exhibition. In one embodiment, the media segment available for exhibition includes recorded media segments and media segments data that are available to be received from the remote communication devices via the communications apparatus 400. Other embodiments provide the media segment identifiers of the memory device 120 are associated with user selection preferences. In one embodiment, the media segment identifiers of the memory device 120 are associated with media segments having high user selection scores. The recorded media segments include data that are processed by the processing unit 122 for exhibition by the media segment controller 421. In one embodiment, the recorded media segments are stored in a compressed media storage format that can be decompressed by the processing system utilizing the processing software 023. The database 113 includes both a storage structure and several records that are stored, accessible, and updateable within the storage structure to define a user selection criteria database. Each record includes a user selection criteria field and a score field associated with the user selection criteria field.

The user selection criteria field includes criteria descriptive of a particular media segment. Disclosed embodiments provide the selection criteria comprises of non-limiting examples wherein the user selection criteria field can include criteria descriptive of a particular media segment associated with at least one of: fashion, model dress code, soccer news, short story reading, celebrity, science, plasma physics, Performer, Rock Band, soul music, electronic-commence, electronic tailing, electronic market place, talk, music, electronic learning, news, world news, local news, world weather, local weather, national weather, national sports, local sports, regional information, football news, out of class learning, movies, country music, surf music, fast beat music, melancholy beat music, worship, Christmas music, games, plays, events, and song title. The exemplary listing of user selection criteria fields exemplifies that the user selection criteria fields can cover a large number of media segments or a small number of media segments. Disclosed embodiments further provide a listing that exemplifies a single media segment and/or a segment greater than at least one user selection criteria fields associated therewith, and the database can contain at least one user selection criteria fields.

The score field includes values and algorithms that are associated with the user selection criteria field. In one embodiment, the algorithms include complex algorithms wherein the algorithm has variables associated with several user selection criteria fields, wherein each field is given a different level of weight when associating the selection criteria with the media segments. Certain embodiments provide the score field being updated based on a user selection from the directory. Some embodiments provide the score field being updated based on external modification values. In one embodiment, the external modification values are based on collaborative data based on other users having similar tastes in media content. The collaborative data can be stored on a database of the communication network 24. The collaborative data can include selection data from multiple users and can be analyzed to predicted future preferences of any one of the users based upon past selections of the multiples users. The collaborative data allows the IMMT 400, in association with the software 300, to score media segments based on information regarding the interests of several people. The IMMT 400 can access the collaborative data via the communication network 24. In one embodiment, the score field is updateable by accessing transactional information from the EC, for example information relating to items purchased by the user, items purchased by other people having a similar taste to the user, and items recommended by other people. In one embodiment, the external modification values are based on information.

The E-PHONE comprises a smart phone disposed with a housing made of silicon substrate nano-fiber/microfiber comprising a solar cell platform. The housing could be a combination of both solar cell material and piezoelectric element. The reason is to increase the energy efficiency since solar cell is band gap limitation. Certain embodiments provide the IMMT in association with a CA communicatively connected to a CMOS MAOC. The CMOS MAOC further embedded on a communication circuit board 13. The shorted end is configured with nano-wires in association with a rectifying circuit capable of harvesting microwave and infrared power, and converting these powers and/or electromagnetic radiation into electrical energy. The communication circuit board further comprise a platform for converting solar energy into DC power and for converting electromagnetic radiation into DC power. The rectifying circuit may comprise of a thin oxide layer for measuring the voltage, providing a platform for converting electromagnetic radiation and solar energy into DC power. Because photovoltaic cells are only 35-40 percent efficient, converting electromagnetic radiation into usable power is required since the rectifying circuit is not band gap limitation and would harvest energy based on the wave behavior of light.

Embodiments further provide the nano-wires comprising materials with good electrical properties, and may consist of, but not limited to gold. Disclosed embodiments further provide the communication device comprising at least a Bluetooth. Certain embodiments provide the CMOS MAOC further configured for communications with Internet device 20 operable for enabling communications clarity and for providing faster data transmission. The Internet device further comprises at least a handheld device 22. Some embodiments provide the Internet device further comprises a CA 24 configured for wired/wireless Internet connectivity in association with the millimeter wave spectrum. Other embodiments provide the Internet device comprising apparatus operable for Intranet communications. Disclosed embodiments further provide the CMOS MAOC device further comprising at least a transceiver apparatus 26. Certain embodiments provide the transceiver apparatus further configured for communication applications, including at least aircraft 28. Some embodiments provide the transceiver apparatus further configured for applications that include at least airplane 30. Other embodiments provide the transceiver apparatus further configured for applications that include military craft 32. At least an interactive multimedia television 33 is further associated with a mobile backhaul link Disclosed embodiment further provides the backhaul link comprising multiple antennas being opened on one end and shorted on the other end. At least the shorted end is disposed with nano-wires/tubes 714 operable for converting electromagnetic radiation into DC power.

At least an acoustic sensor 203 is configured with the circuit board 13 for providing other source of energy harvesting platform within the environment where the phone may be used. The acoustic sensor 203 is in association with the CMOS multiple antennas 201 to harvest energy from two fronts. 2A.) The acoustic sensor would convert sound waves “Voice communication” into usable energy. 2B.) The CMOS multiple antennas is further disposed on a circuit board 13, which is further made of solar cell platform to convert electromagnetic radiation and solar energy into usable energy. Because the energy from the acoustic sensor depends on the sound level, the acoustic sensor is not a standalone alternative to energy harvesting.

The E-PHONE is an energy harvesting phone, and each day we do not account for the areas of energy that are being used. When we dial a number using our phones, we are actually applying pressure on the surface of the phone, which is another phone of energy. Some people go jogging with their phones attached to their bodies. The incorporation of the piezoelectric element on the display or in association with the phone housing provides a sensory platform for converting force/vibration into electrical energy. This is an optional configuration for energy harvesting. The touch screen, in other embodiment, is part of the E-PHONE because any amount of pressure on the surface could be converted into electrical energy. The touch screen device is also configured with the communication circuit board. However, the touch screen could be a standalone device. Disclosed embodiment further provide a cell phone case disposed with a converter affixed on a male USB port, similar to the conventional charger inserts for smart phones. The converter is configured to convert one form of energy into DC power and is connected to the case by a flexible elastic structure. The flexible elastic structure may comprise of an elastic ribbon-like structure with conductive nano-wires.” The DC power is further directed to the conventional female charge port for smart phones through the male USB port to keep the battery charged “Battery circuit.” Some embodiment provide a meta material structure cavity 722 and nano-sensors 327 and 360 each further embedded in the solar cell material to provide an electromagnetic wave transport stream for electromagnetic wave absorption. In this endeavor, the electromagnetic energy would be converted into DC power to compensate for the band gap limitation of solar cell and to increase the efficiency of the energy harvesting cell phone case 715 and the E-PHONE.

Disclosed embodiments further provide the transceiver apparatus 313 and 428 further comprising at least a portable communication device 34. In the disclosure, the transceiver apparatus may comprise at least a stationary IMMT36. Certain embodiments provide the transceiver apparatus further disposed on at least a vessel apparatus 38. Some embodiments provide at least military personnel 39, being outfitted with the transceiver apparatus. The transceiver apparatus further comprising at least a battlefield gear consisting of at least one of: a camouflage 40 and 44; a head gear 42; an IMMT 46. Other embodiments provide the transceiver apparatus further comprising IMMT 46 configured to connect to at least a telephone service. The telephone service may comprise at least voice to text monitoring/transmission, voice data monitoring/transmission, text data monitoring/transmission, video data monitoring/transmission, text to voice, and server data monitoring/transmission. The transceiver apparatus further comprises vehicular IMMT50. Disclosed embodiments further provide the vehicular IMMT further operable for military applications. Some embodiments provide the vehicular apparatus further comprises at least a mega IMMT “ELECTRONIC IMAGE PROCESSING.” Certain embodiments provide an IMMT 400 comprising at least one of: a transmitter apparatus; a receiver apparatus; a transceiver apparatus.

Disclosed embodiments further provide a base station 13 comprising a cellular communication system for providing wireless communication among wireless users 22. The base stations 13 may include a stationary and at least a mobile base station disposed with low and high speed wireless transceivers, a connecting station comprising a millimeter wave spectrum 00, a wireless transceiver 313 is configured to communicate at millimeter wave frequencies higher than or between 30-300 GHz with a fiber optic or high-speed cable communication network 12. The base stations are constructed with CMOS MAOC and disposed with nano-wires for harvesting energy from electromagnetic wave. The chip is further embedded on a solar cell platform for energy harvesting. The antennas are opened at one end and shorted on the other end and serve as a separate communication cell. The shorted ends are further configured with the nano-wires disposed for harvesting the heat due to electromagnetic radiation, converting the heat into electrical energy. Embodiment further provide multiple base station 13 equipped with low frequency wireless transceiver 313 for communicating with the wireless users within the communication cell at a radio frequency lower than 6 GHz and with a millimeter wave wireless transceiver 428 operating at a millimeter wave frequency higher than 60 GHz. Some embodiments provide the wireless transceiver operable for communicating with another millimeter wave transceiver 728 at another base station or a millimeter wave transceiver 428 at the connecting station. The connecting station may comprise a backhaul link 13A. At least a data transfer device 430 in association with a database is operable for transferring data communicated through the low frequency wireless transceiver 313 to the millimeter wave wireless transceiver 428, 728. The data transfer device is operable to transfer data communicated through the millimeter wave wireless transceiver 428, 728 to the low frequency wireless transceiver 313. The low frequency wireless transceiver may comprise one cellular base stations or a mobile base station.

The E-PHONE device comprises of NA comprising sensors embedded in silicon substrate nano-fiber/microfiber. The E-PHONE comprises a fully integrated CMOS multiple antennas from RF to millimeter wave frequencies using a scalable Orthogonal Frequency Division Multiplexing with Multiple Access (OFDMA). Embodiments further provide the E-PHONE further configured to utilize Wi-Max for “wireless” broadband. Wi-Max (Worldwide Interoperability for Microwave Access), an evolving standard for point-to-multipoint wireless networking, and works for the “last mile” in the same way that Wi-Fi “hotspots” work for the last one hundred feet of networking within a building or a home. In addition to “last mile” broadband connections, Wi-Max has a number of other applications in hotspots, cellular backhaul and in high speed enterprise connectivity.

Certain embodiment provides the CMOS multi-antenna comprising a receiver front-end capable of accommodating various multi-antenna schemes including spatial multiplexing (SM), spatial diversity (SD), and beam forming (BF), The use of orthogonal code-modulation at the RF stage of multi-antenna signal paths enables linear combination of all mutually orthogonal code-modulated RE received signals. The combined signal is fed to a single RF/baseband/ADC chain 13. The primary advantages of this architecture include a significant reduction in area and power consumption. Some embodiments provide a path-sharing of multiple RF signals to mitigate the issues of LO routing/distribution and cross-talk between receive chains. The system is operable to exhibit system-level analyses of variable gain/dynamic range, bandwidth/area/power trade-off, and minimize interference. The millimeter wave network is further operable at frequency band of 8-38 GHz, 71-76 GHz, 81-86 GHz, and 92-95 GHz, and at data delivery/wireless connectivity at gigabits per second. The network comprises of network processors, baseband modules, and radio frequency frontend.

The IMMT 400 further comprises a 5G-BETTER Wi-Fi. The 5G-BETTER Wi-Fi encompasses the 3G/4G, and comprise a solar cell technology platform that includes energy harvesting for EDs, including cell phone devices “E-PHONES” and wireless communication network applications. The E-PHONE would operate on networks such as Wi-Fi, CDMA, WAN, LAN, MAN, WPAN, WWAN, WLAN, GSM, NADC, TDMA, E-TDMA, WCDMA, and CDMA-2000, providing solar cell platform for phone devices, delivery, marketing and navigation of secure wireless communications for individuals, businesses & entire communities. Wi-Fi is quickly becoming the standard in the delivery of Internet connectivity throughout many organizations, government agencies and businesses. But 5G-BETTER Wi-Fi is configured to deliver better and secure Wi-Fi services to commercial and residential property owners as well as traditional Internet service providers that are looking to improve the service offerings. Embodiments provide a 5G-BETTER Wi-Fi comprising full service wireless network applications for businesses, individual building owners and municipalities. Certain embodiment provides 5G-BETTER Wi-Fi in association with data for upgrading conventional Wi-Fi network. As connectivity to the Internet has become a necessary utility, just like water, phone and electrical hookups, so has the trend of providing a central Internet connection via 5G-BETTER Wi-Fi for providing better data transmission speed. In this regards, truck Stops would receive accelerated Wi-Fi services throughout any region quickly and efficiently. Embodiment further provides 5G-BETTER ISP or Wi-Fi-Internet Service Providers (ISPs) for providing network connectivity at much better speeds. This connectivity can be distributed throughout an entire area without the need to re-wire any current wired connections. Not only is this faster than older wired networks, but it's also easier to scale up and upgrade the technology, providing further applications. 5G-BETTER Wi-Fi provides the ability to distribute large amounts of bandwidth up to 30 miles between Wi-Fi base stations.

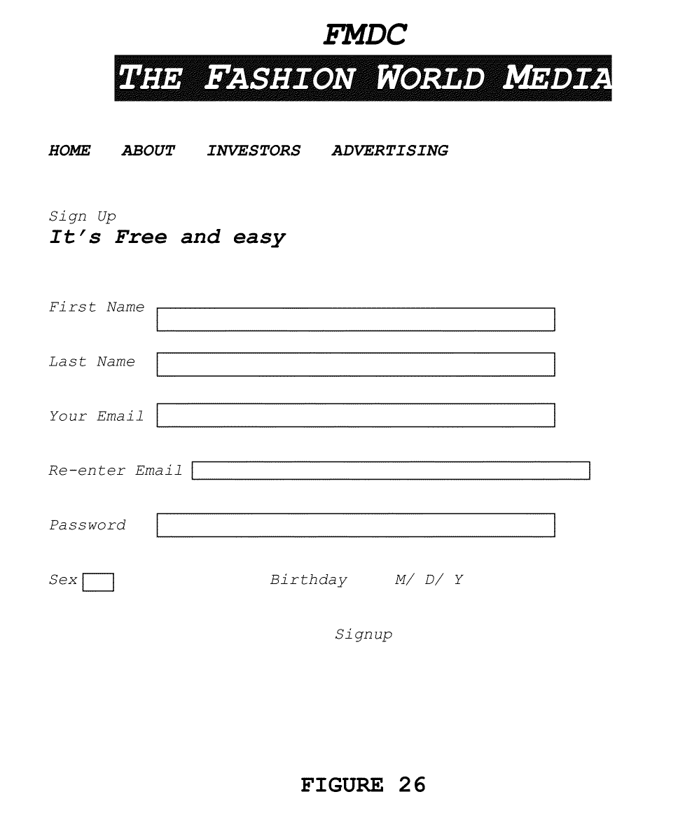

Referring to FIG. 26 is an exemplary embodiment of a signup page. At least one environment comprises the FWM, a social platform for publicly declaring the will of positivism, sharing human knowledge for organized studies, dealings with the body of facts and truths to explain the phenomena of social media in the environment of natural fashion media, model media, and dress code media “FMDC,” a dimension of social sustainability to gracefully improve corporate and community wellbeing through social, cultural, environmental, and economic vision by the goodness of change. Change can be embraced with the hope for sustainable cultural independence. Disclosed embodiments further provide the signup page comprising at least one of: the FWM, FMDC, home, about, investor, advertising, signup, it's free and easy, name, last name, email, re-enter email, password, sex, birthday, and month, day, year “M/D/Y.”

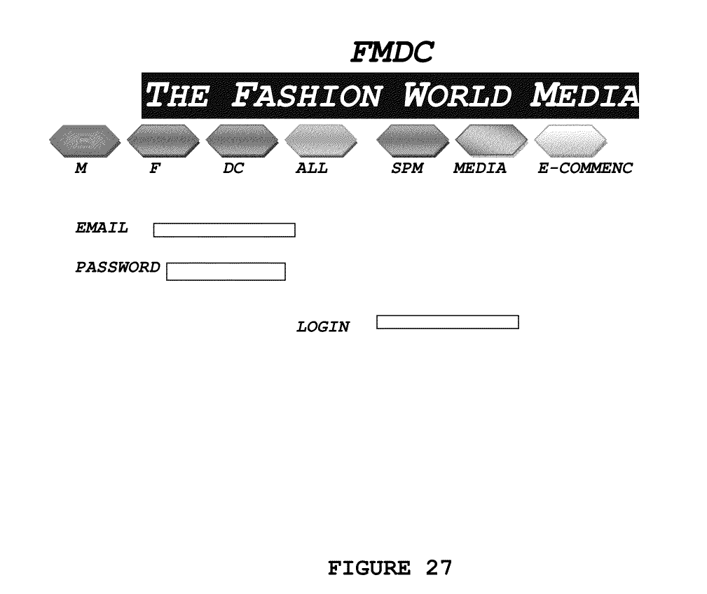

Referring to FIG. 27 is seen an exemplary embodiment of the login page. Knowledge are reliably shared to produce useful feeds relating to a person, a product, a culture, an association, entertainment, a sport, an event, a career, a show, a business, an organization, a program, a sport tool for measuring burnt calories, an educational institution, a corporation, consisting of TOI to aid and educate the society through the environment of social media, asserting the influence of positivism for the betterment of the society. Disclosed embodiments further provide the login page comprising at least one of: the FWM, FMDC, model “M”, fashion “F”, dress code “DC”, all mails “All”. Special mails “SPM”, media, e-commence, email, password, and login.

The FWM (FWM) is launched as innovative, fashion-inspired social media platform for cultural interest aficionados and for the general public, and is found at this link: www.thefashionworldmedia.com, www.fashionworldmedia.com. Let the world capture fashion power-trends by examining the universe of model-related products and beauty services.

FWM is a platform for exploring some of the key fashion industry markers including:
A. Power Trends
A. SS for fashion style announcements
B. Centralized Communication-hub for brand awareness
C. Improved fashion community awareness via social networking

Embodiments provide fashion social networking environment that is spearheaded by individuals and regularly feature professional models, fashion outlets, businesses, corporations, product models, business models, photographers, makeup artists, hairstylists, fashion employees, beauticians, and other interested, qualified groups, consists of the following:

### A. Fashion Media

B. Model Media
C. Dress Code Media

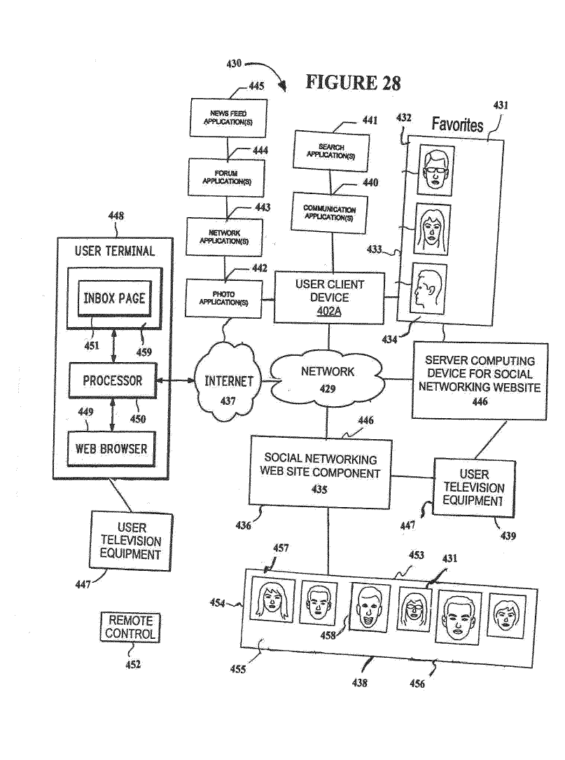

Referring to FIG. 28, embodiments provide a CA 430 comprising a tool where various communities from around the world meet to share fashion TOI associated with celebrity media 431, science media 432, and engineering 433. The tool is further configured for communications with WCD 434 in association with a SN. Embodiments provide the CA 430 being associated with smart antennas 436 in NA. The smart antennas further comprise MAOC. Certain embodiments provide the tool comprising a platform to impact positive social measurements to improve CCI. Some embodiments provide the tool comprising an environment that defines fashion in the categories of expressions, love, arts, habits, styles, dress codes, models, and professions, because fashion is not limited to clothing choices. The tool further comprises a NE 429, comprising Internet 437, network 438, client device 439, communication applications 440, search applications 441, photo applications 442, network applications 443, forum applications 444, news feed application 445, a server computing device for social networking site 446, network user television equipment 447, and a network user terminal 448. The network user terminal 448 is communicatively connected to user television equipment 447, a web browser 449, a processor 450, an inbox page 451, configured with buttons 459 for enabling multifunctional applications, and a remote control device 452.

Embodiments further provide the remote control device 452 further comprises an ED, a WCD 434, a digital device 453, a photographic device 454, a video device 455, a camera 456, an image recorder 457, each comprising a media tool taken from a group that associates fashion with celebrity media, fashion media, model media, dress code medial, photographic media, hair stylists media, beautician media, science media, engineering media, transportation media, medical media, communication media via fashion social media, fashion SNE.

More particularly, the present invention provides a CA configured for IMC that include MT and mobile photographic CE. Embodiments provide the tool further comprising an ED 458, a DE for facilitating social media interaction and for communications, for producing images, for editing images, and for receiving images and sounds of a video signal for social network distributions. Embodiments further provide the tool comprising a centralized IMMT configured with a camera and operable for communication with at least one of WCDs, a server to enable communications, a wireless network, cloud network, a wired network, enabling image social sharing within a social networking platform. Embodiments provide a CA comprising an environment for social media communications that include media controlled environment where social networking environment is provided as a networking environment. Network occupancy pertains to the confines of network communities that is not limited to wireless network, events, entertainment, industries, companies, apartments, mobile network community, houseboat, or other types of offices and residences. In one embodiment, the occupancy includes the surrounding area of the network community, the industries, the company offices and residences, as well as any shelters, constructs, improvements, or the like, within a designated perimeter of the environment. Certain embodiments provide the CA 430 further configured for detecting an environment where communications and/or image postings may be linked to a media environment where a network user may elect to like, fashion, favorites, model, dress code the posting.

The CA is configured for communications with the WCD configured for short range communication that allows users of the social network platform to receive, transmit, talk and listen to their social network communications. The social network communications further comprises social communications that include but not limited to text messages, voice messages, and voice commands. At least a voice command may be enabled via the WCD to enable a mobile search for information about the recipients of the social network platform, providing means to find locations, and be notified of incoming calls to the inbox, texts, and events of other recipients communicable when the CA is in proximity with the WCD. The communication methods further include texting, blogging, live chat, LED light, vibration, text displays, melodies, music, pulsing, imaging, sound, alarm, and entertainment events.

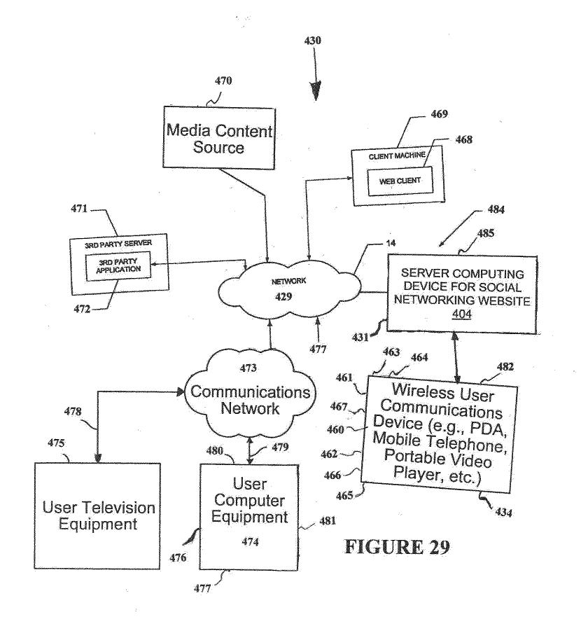

Referring to FIG. 29, embodiments further provide a CA 430 in association with a WCD 434. The WCD 434 further comprises wireless user communication device associated with mobile telephone or portable video player, comprising a hand watches 460, glasses 461, gaming device 462, garments 463, a hat 464, a shoe 465, wearable electronics 466, a diaper 467 each configured with GPS in NAs to detect, locate, monitor, and to allow hands free communication. The diaper 467 is further disposed with NEMS/MEMS 476 and/or a nano-sensory environment 477 each configured for physiological detection, force measurement, weight measurement, fluidic measurement, monitoring, for determining location, and for communications. The WCD is further configured for directly connecting to the CA. The CA 430 further configured for communications with web client 468 associated with client machine 469. Certain embodiments provide the WCD further comprising a wearable remote control for home appliances to allow voice and buttons communications using short distance waves. Communications and network sensors are configured with audio generation device for social communications with the social media platform. Some embodiments provide the WCD in association with a wearable Bluetooth communication device to enable connections with the CA and to enable a hands free communications with the WCD. The WCD is further configured to show information, harvest energy to power itself, receives and transmits data, monitor physiological conditions of the wearer, and communicate detections to programmed recipients. Some embodiments further provide the CA being associated with media content source 470, NE 429, a 3^{rd} party server 471, a 3^{rd} party application 472, communications network 473, user computer equipment 474, and user television equipment 475. The WCD further comprises means for monitoring student's emotional states in an educational environment and for locating students within the educational environment.

Embodiments further provide the CA 430 comprising a system for facilitating interaction between at least a computing device 478 and humans 479. At least one data type includes locations, text, voice, activities, gestures, contents, pulse, emotion, physiological state, mental state, physical state, sound, events, functions of the communication device, imaging, microphone signal, loudspeaker signal, voice commands. Certain embodiments provide the data type further comprising an alerting means to consider an action, movements, exchanged data, and in association with software program 480 communicatively connected to a processor means 481 for initiating functions. The WCD in association with a module 482 disposed with programmable buttons 483 that may be configured by a user of the social network platform 484 via a web portal 485, a software program 480, a mobile application. Embodiments further provide the WCD further configured for wireless communications via at least a Wi-Fi and/or Bluetooth enabled applications in association with nano-sensors in NAs. The NAs may include IR proximity sensors, touch sensors, thin film, plasmonic sensors, GPS sensors, photonic sensors, and electro-chromic sensors, in association with touch panel for exchanging data over short distances through radio transmissions for personal area network “PAN.”

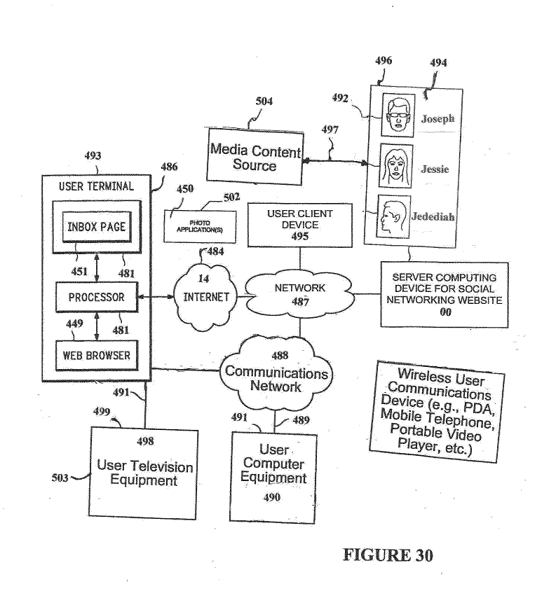

Referring to FIG. 30 embodiments provide the WCD 434 further comprising an input/output device in association with the CA. The WCD further associated with on-chip antennas 724 and 201 that may include nano-antennas configured for adaption to different communication protocols 180 to allow various notifications, automations, and to automatically provide access to services in the Internet 370 and the social network platform 100. Embodiments provide the WCD 434 further comprises wireless user communication device associated with mobile telephone or portable video player 486. The WCD further comprises hand watches 460, glasses 461, gaming device 462, garments 463, a hat 464, a shoe 465, wearable electronics 466, a diaper 467 each configured with GPS in NAs to detect, locate, monitor, and to allow hands free communications. The WCD is communicatively connected to Wi-Fi 570, and Bluetooth 580, each comprising a wireless technology associated with a no-code pairing system protocol. At least one protocol further configured for allowing a user to effectively and rapidly pair the WCD 434 with the CA 430 and/or the social network platform 484 without having the user entering a pass code. In this endeavor, pairing is done to allow connections between the devices for the social network platform 484 and the WCD 434.

The pairing may provide a connection for social gaming 486, networking 487, cloud computing 488, texting 489, entertainment 490, sporting 491, expression 492, and education institution 493. Some embodiments provide the WCD in association with Global Positioning System “GPS 590.” The GPS 590 is associated with the processor 481 to further enable social tracking and/or monitoring of patients, network users, students, sports and fitness persons, including tracking and/or locating various routes of patients or routes associated with hiking, running, jogging, record-keepings and other movement tracking applications for communications to the social network platform 484. The processor 481 is further associated with the browser 449 and the inbox 451. Embodiments further provide the processor 450 in communication with the MT 502. Other embodiments provide the WCD further comprising a tool for measuring burnt calories during a sporting event. Embodiments further provide the WCD having at least an interactive interface. At least one interactive interface comprises a display device configured for interactive display having a touchable control environment for user interface virtualization.

In other embodiments, the CA and the WCD are associated with communications in non-occupancy environment. A non-occupancy includes, but is not limited to extranet and/or intranet commonly found in office complex, suite of small offices, production studios, warehouses, entertainment arenas, health care facilities, hotels, vacation resorts, aircrafts, ships, automobiles, or the like. In these and other embodiments, the non-occupancy further includes non-traditional networks that comprise controlled environments for residential, non-residential and commercial/industrial NE. Embodiments provide the CA and the WCD operable to include not only the actual confines of the aforementioned structures but also other surroundings within a designated perimeter. Disclosed embodiments further provide methods and systems for a programmed IMMT. The multimedia MT further includes product for image sharing, security monitoring, and for managing plurality of devices to determine destination, locations and/or applications within an environment, such as SNE, wireless network, SN, devices network, wearable communication network, a network community, business, school, community environment, etc., as well as their surrounding areas. The CA further comprises a control server, comprising one or more servers or processing systems configured to enable centralized communications, command and control of other devices, destinations, locations and/or applications, wherein the servers may be configured for providing a uniform resource locator “URL” to each client. Clients of the network are responsive to communications from the servers corresponding to a location where a client video is stored. In this embodiment, the video may be an overlay for integration into media sequence that is played to a user through a browser in accordance with the media sequence. At least one media sequence comprises a tag for automatically associating a client to content associated with the overlay via a click of the tag being displayed on the browser. Embodiments provide the interactive MT in further association with a processor 481. A video display 494 is controlled by the processor, and a network interface 495 in communication with the processor 481 for receiving Internet video from the server over the Internet 14.

The interactive MT further comprises an act of engagement into photographic and video activity for performing image editing, filtering, and/or producing frames. Embodiments further provide the CA in association with a mobile apparatus operable for activating, sensing, storing, transporting, transmitting, and/or posting images into the social network platform 484. The CA further comprises control server and/or cloud computing environment 488 associated with the social network platform 484 for storing and/or sharing the images for mass communications. Embodiments further provide the CA in association with a user interface device 496 configured for communications with the processor 481 operable for transmitting and for receiving video/image selection signals to enable at least a media video module “MVM” 497. Certain embodiment provides the processor 481 further configured to execute a “MVM” to create an interactive MT “IMT” comprising a story content for Internet video 498. The story contents may comprise frames in the video in communication with the processor for enabling video content display. The MVM in further association with a decoder 499 cooperatively configured for streaming the video content from various locations of the server for display over the Internet 14. Some embodiments provide the decoder being further configured to decode frames from Internet video to enable video broadcasting clarity. Disclosed embodiment provides interactive MT “IMT” in association with at least a control device associated with a frame selector 500. Certain embodiments provide the frame selector operable on at least video/image database configured for selecting subsets of frames for presentation to the social media platform 484 to enable social network display of the frames as a social network objects.

The CA further comprises an entertainment device such as a MT 502 configured with a camera 503 in association with one or more controlled servers 00. Disclosed embodiment provides the MT further comprises a device associated with a network client. The client comprise of an interface in association with a device operable for allowing at least a user to enter at least a displayable information and receive a displayable information. The displayable information may be presented within a user interface on a display device commonly associated with wearable electronics 466, a desktop, an ED, portable communication, telephone, a mobile phone, a display system, communication monitor; navigation system; a television; portable media player/recorder; personal digital assistant (PDA); gaming device, medical device, game console, handheld ED, embedded ED, and a WCD 434.

Embodiments further provide the social network platform comprising a network community executable by one or more communication devices comprising client system having means for displaying media content and for communicating/commenting within a medium having display area for distribution within a social networking environment. The social networking environment configured for receiving inputs from the client system to create a virtual chat room relating to the media content being communicated, commented, and/or displayed at the client system for sharing within the social network community.

Embodiments further provide the CA configured for identifying the media content to a NR 504. Certain embodiments provide the CA further operable for identifying the media content, comprising generating a description of the media content by the client system and associating the generated description to the client system. The server 00 receiving from the NR 504, information related to virtual files, network connections, and chat rooms 505, comprising live chat environment. The NR 504 further associated with virtual resource component for identifying media contents. At least one media content further comprises a resource that is being accessed. Some embodiment provides the virtual chat room having participants within the SNE. Each participant being automatically selected for ecommerce discounted products from users of the network accessing the media content based at least on a match between the time spent on the network for identifying media contents and other identifiers from another client system within the social network community.

Disclosed embodiment provides the CA further comprises apparatus for identifying media content, in association with the virtual chat room so that users of the network may display videos, images, text, and may post each display for communications, comments, as a model, as a style, as a fashion, as an expression, as an expression of love, as an art, and as a graphic image within a medium display area. The virtual chat room further comprises a medium for receiving chat content from the NR and for updating the chat content according to the network user's participation within the SNE. Certain embodiments provide the updating being selected based at least the identified matching media content. Some embodiments provide the updating comprising periodically updating chat contents, periodically displaying at least chat content in the virtual chat room for association with the media content for broadcasting within the social network communities. The media content further comprises information and experiences that may provide value for the network user or network audience. The media content is delivered via a medium such as the internet, television, MT, and audio CDs, as well as live events. Embodiment provides the media content further comprising digital media

Disclosed embodiment further provides a social media in association with means of transmitting and/or sharing information with a broad audience. Certain embodiment provides a social media comprising a communication channel consisting of a system that disseminates information to others to enable networking. Embodiment further provides social networking comprising an act of engagement.

Some embodiments provide the social media comprises a strategy comprising a purposeful environment built on social networking for mass collaboration. At least one social media environment further comprises an outlet for broadcasting. Certain embodiments provide the social media environment further comprises a system for disseminating information to a social community within a social networking environment that socializes the network through an act of engagement.

Discloses embodiments further provide social networking comprising utility for connecting with others in an environment where people congregate to join others. Certain embodiments provide a separation between social media and social networking in that social media further comprises tools for sharing and for discussing information and social networking is the use of communities of interest to connect to or with others in a centralized system. Embodiments provide social media to facilitate social networking. In the instant invention, one can network by leveraging Social Media because the instant invention further teaches social media as a way to transmit, or share information with a broad audience within a social network. Social it as provided herein further comprises a format and/or platform that delivers' messages, comprising, but not limited to televisions, radios or newspapers, electronic communications.

Embodiments provide a tool where various communities from around the world meet to share fashion TOI. The tool is configured to impact positive social measurements and to improve CCI, bringing out the true definition of fashion because fashion is not limited to clothing choices. The tool further provides a marketplace where social media is used as a communication channel while SNE is used as an engaging environment for multiple channel communications with broad audiences. Certain embodiments provide the tool further configured with electronic mall and/or electronic shopping center that is comparable to physical mall environment where people may have live chat with designers or their regular online 3rd party marketplace to empower the world with fashion, to let fashion be the voice of the people, to let the voice of the community create a model based on the CCI, and to impact community cultural values.

The CMOS multiple antennas 724 comprise miniaturized alloyed material in association with meta-material structured surface cavity 722 embedded/coupled in silicon-substrate-microfiber/nano-fiber 723 to enable a detection platform 295. Disclosed embodiments provide the detection platform further configured for communications with plurality sensors. The sensors are embedded in silicon substrate 205 and fused/etched in nano-fiber/microfiber 220, further include NEMS/MEMS 420, antenna 201, detectors 250, piezoelectric thin film 730, piezoelectric AIN thin film 731, other sensors 200 and 200A, multifunctional sensors 215, investigative agent 176, analyte 175, zinc oxide 734, cell platform 756, temperature sensor 716, glass 739, non-ferrous material 930, nano-particles 767, accelerometer 768, membrane 769, RFID chip 780, buffer reservoir 560, charge transport 297 in association with interface 172, web-file module 401, SMC 100, network interface 170, software 300, media module 22, internet protocol television 180, Internet 370. Embodiments further provide the detection platform comprising an outfit 10 configured for pattern recognition 73. The platform configured for generating electrical energy. Certain embodiments provide the CMOS multiple antenna apparatus 724 coupled to the silicon substrate 205, further comprises at least glass 739 comprising a gallium nitride high electron mobility transistor (GaN-HEMT) to improve communication signal amplification, faster data transport speed, and reduce energy consumption. Some embodiments provide the WCD configured with a silicon to silicon bonding and/or silicon to ceramic wafer bonding to further provide a detection platform for generating electrical energy. The silicon is further provided with ceramic wafer bonding responsive to solar energy. The silicon to ceramic wafer bonding may include at least silicon to glass bonding, forming single crystal silicon to improve micro-acoustics and micro optics associated with the nanotechnology. Disclosed embodiments provide optical properties of thin films associated with integrated circuit for converting solar energy into electrical energy. Some embodiments provide energy platform consisting of at least surface acoustic wave line, paste, NEMS, MEMS, thin film deposition in association with multifunctional sensor array 205.

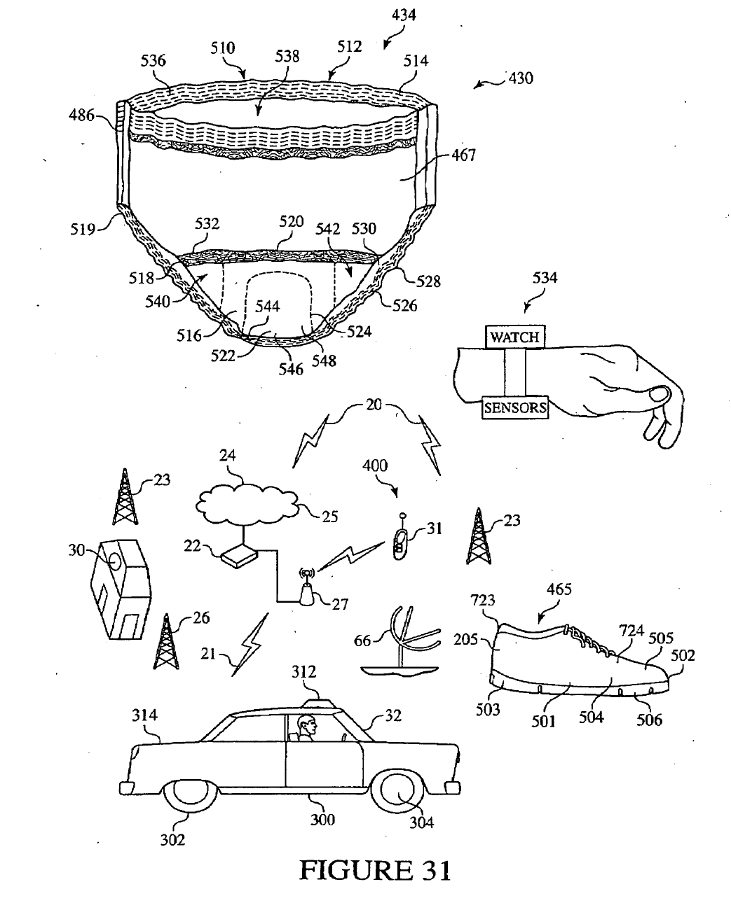

Referring to FIG. 31 is an exemplary embodiment of a CA 430. Embodiments provide the WCD 434. The WCD 434 further comprises a shoe 465, a hand watch 460, diaper 467 comprising a wearable article 510 having an opened and/or a closed construction portion 512. The article 510 is disposed with sensors, and may include nano-sensors 514, NEMS/MEMS 516, each associated with the main portions 518. The article 510 further disposed with nano-sensors via NAs configured for sampling DNA associated with a reference sample. Embodiments further provide the NEMS/MEMS 516 further configured to measure changes in skin hydration surface ion composition and to measure electrical activity profiles relating to physiological state of a person and/or wearer of the WCD. The main portion 518 in association with a nano-fiber/microfiber membrane 519 configured to provide communication clarity and data integrity. The nano-fiber/microfiber membrane 519 further comprises polymer nano-fiber membrane. Certain embodiments provide the membrane further comprises electrspunpolystylene nano-fiber comprising poytrimethylene/polyethylene-terephthalate membrane configured to provide nano/microfiltration media environment for selective separation of weighted fluidic substance from making contact with human body and for enhancing short communications. The article 510 having first side panel 520 and second side panels 522 and 524, each configured with embedded sensors. The article 510 further comprises nano-structured material 524, includes silicon substrate 526, nano-fibers 528, and microfiber 530. The article 510 further comprises Meta material substrates 532 and in communication with an ED 534 that includes smart phones. The main portions 518, and the side panels 522, 524 forming a waist portion 36. The waist portion includes an opening 538, and a pair of leg openings 540, 542 constituting a pull-on comprising a pant-like structure. The incorporation of nanotechnology in silicon substrate and nano-fiber provide a sensory structure that allows effective detection and communications, further providing a flexible and/or partially elastic structure to facilitate placement and removal off a wearer's body.

The article further comprises a rapper, a blanket, and shocks. The article 510 further comprises an opened and/or a closed structure, comprising constructions that include multiple applications, including pull-up, zipper-up, and strap-able. Embodiments provide the article 510 associated with sensors embedded in silicon substrate and etched/fused in nano-fiber/microfiber having excellent electrical properties. Certain embodiments provide the article 510 in association nano-sensors, nano-antennas, and nano-antennas on chip, rectifiers, receivers, and transmitters to enable communication with a communication device in proximity with it. Some embodiments provide the article 510 comprising a social diaper for social networking. Other embodiments provide the article 510, further disposed with platform for weight measurement 544, force measurement 546, and fluidic measurement 548, and each measurement is further communicable to an ED, a NE, a SN, or multiple devices in a network. At least one SN comprises a GPS, radio wave sensor, signal detection sensor, and a signal booster module. Embodiments provide the article 510 further configured for monitoring physiological conditions, including body temperature, vital signs, detecting bacteria that may cause illnesses, and analyzing fluidic samples, including urine, blood, hair-like, and perspiration.

Embodiments provide the WCD comprising apparatus that allows parents to monitor the wellbeing of their toddlers, children, and/or relatives in the care of a 3^{rd} party, such as daycare, nursing home, elderly leaving facility, retirement home, hospitals, educational facilities, and/or any care given facility. Some embodiments further provide at least one CA such as a network configured for allowing at least another CA such as a smart phone to download entertainment articles such as music, melodies, sounds, videos, images, and other media contents for communication with another CA such as the WCD as disclosed herein in entirety. Other embodiments provide the wearable apparatus further comprises means for administering treatments to a wearers body. The article further comprises a wearable modular system further configured with a buffer fluid reservoir portion 560 in association with the membrane 519 to monitor conditions of the skin Embodiments provide the skin comprising information boundaries associated with samples capable of reflecting physiological change. Disclosed embodiments further provide the buffer fluid reservoir portion 560 further comprises nano-fluidic sensing “NFS” and/or micro-fluidic sensing “MFS” platform configured for the containment of biological substance, in communication with the analyte for the interpretation of the substance in the manner that includes, but not limited to electrocardiography and/or electroencephalography.

Certain embodiments provide the WCD 434, 461, 462, 463, 464, 465, 466, 467, and 486, each configured for communications in a NE that include CA 400. The NE further include a CDMA network 20, a GSM network 21, a wireless network 22, a local area network 23, an Internet network 24, Wi-Fi network 25, LTE network 26, WIMAX network 27, millimeter wave network 28, backhaul link 29, base station 30, mobile communication device 31, a vehicular communication network 32, cloud network 33, satellite network 66, mobile network 312 in association with a vehicle 300, being affixed with at least two wheels 302 and 304, and antenna network 201. The network further comprises a mobile network that may include, but not limited to mobile backhaul link Certain embodiment provide the antenna network 201 further comprises CMOS MAOC, sensory network, means for converting electromagnetic wave into electrical energy for communications with storage medium that includes, but not limited to the WCD, interactive multimedia media, interactive media interface. At least one storage medium is configured for supplying energy to the WCD wirelessly and may include a capacitive means.

The shoe 465 further comprises footwear comprising an insert-able pad 501 configured to fit over a sole portion 502 to enable measurements and data collections extending under a wearer's foot. The pad 501 further comprises flexible structure 503 disposed with sensors 504 embedded in silicon substrate 205 and etched/fused in nano-fiber/microfiber material 723 having excellent electrical characteristics and conforming to the shape corresponding to the sole of the footwear. The sensors 504 further comprises layer surface of functional sensor groups, including antennas 724 having a transition layer 505, in association with a processor 506. The pad is worn for gathering data, analyzing data, and for enabling measurements. At least one measurement comprises the amount of calories burnt during an event. At least one event includes jogging, exercising, gaming, running, and entertaining. The pad 501 is communicatively connected to at least a processor 506 being configured for analyzing data, in association with a memory configured for storing executable instructions executed by the processor 506. The processor 506 is in association with GPS 590. Embodiments further provide the execution further comprises causing the pad 501 to process image data associated with image of an object. At least one object comprises wearer's destination, weight, location, current environment, objects around the environment, and comparing the objects to at least a threshold to determine wearer's activities, safeties, fitness, ability, possession of an object, health, and physiological conditions based on the threshold value. At least one threshold value comprises weight, location, state of mine, mental state, physical conditions, and physical fitness.

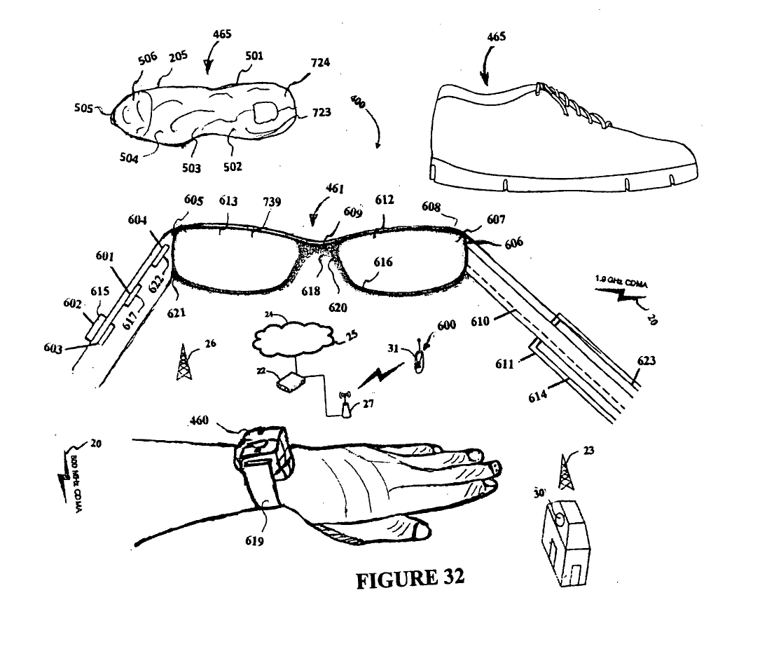

Referring to FIG. 32 is seen an exemplary embodiment of the WCD. The WCD further comprises apparatus for virtual communications, further comprises glasses, watches, garments, shoes, pads, bands, hats, ties, diapers, but not limited to receiving a first digital image data and virtual data associated with objects in the first digital image data via a mobile device. The shoe further disposed with pads affixed with sensors for measuring activities and/or burnt calories during sporting activities. The WCD further comprises a reader for reading measurements relating to burnt calories, physical activities, and physical fitness of a person. The virtual communications further include data comprising metadata received from a user of a mobile device. The WCD further comprises apparatus for generating a digital signature from a digital image data that describes objects, inserting the digital signature into a searchable index of digital images for distributions and/or for communications via a SNE. The WCD may also include storing the digital signature in a database, a virtual data, in association with indexes of digital images. Disclosed embodiments further provide the WCD comprising means for monitor/measuring properties of analyte, further comprising an antibody. The CA further comprises a SN, a sensor control unit, and an interactive media interface, comprising an interactive multimedia environment. The WCD is further configured with silicon substrate associated with a recessed channel, and a miniaturized conductive material is disposed in the recessed channel to form an electrode. The WCD further comprises contact pads associated with sensors. The sensors further comprise transmitters associated with the substrate, forming a housing coupled to the conductive material or contacts for transmitting data obtained via the sensors. The interactive media interface further comprises a receiver for receiving data transmitted by the transmitter associated with the sensor for displaying data and/or the level of analyte properties. Further comprises an analyte monitoring apparatus comprising a drug delivery apparatus and for monitoring body conditions for communications with communication devices associated with hospitals and/or physicians.

Certain embodiments provide the WCD further comprises a computer-implemented WCD for communication with a server computer system. The WCD further configured for communicating and/or accessing digital image data and/or virtual data associated objects in a digital image data environment. At least one digital image environment further comprises digital image data captured via a mobile device. The virtual data further includes, but not limited to metadata received/transmitted from/by a social media user via a mobile device. The mobile device capable of generating a digital signature from the digital image data associated with objects. The WCD is further provided with wireless communications circuitry. The wireless communications circuitry further associated with simultaneous reception functions that allow the DEs to simultaneously receive multiple communications signals in a single communications band. The WCD further configured for communications with smart phones to allow all playing and communications functionalities over the DEs. The WCD may have local wireless communications capabilities supported via local wireless links such as Wi-Fi and Bluetooth links Users of the WCD can simultaneously receive signals such as Wi-Fi and Bluetooth signals. The wireless communications circuitry further comprises transceiver circuitry having a first transceiver circuit and a second transceiver circuit to enable different communications protocols via a common radio-frequency frequency band.

Multiple antennas are embedded to handle radio-frequency signals in the common radio-frequency frequency band to enable the wireless communications circuitry to receive radio-frequency signals from the antennas and simultaneously provide corresponding low signal versions of the received radio-frequency signals to the interactive media interface. Disclosed embodiments further provide the MAOC further configured with switches connected for association with the transceiver circuits to enable activities that include, but not limited to transmitting radio-frequency signals through the switches and the antenna without passing through a radio-frequency coupler, operating in a mode that generates radio-frequency signals for transmissions via at least a switch. The WCD is configured for implementing short range communication to a cell phone to facilitate user interface. The low signal version comprises low power implementation to allow a user to easily access all features of a smart phone via proximity with the WCD. Embodiments further provide the WCD in communication with a smart phone for talking, listening, sending and receiving text messages, placing and answering calls, initiating voice commands to enable mobile search for information, gaming, monitoring, locating, administering treatment, entertainment, and to be notified of social media communications, incoming calls, texts, and for updating events, all while in proximity with the smart.

Embodiments further provide the WCD further comprises NA of the glass 739 comprising material to enable the eyeglass and/or wearable glass 461. The glass 739 further comprises silicon substrate material embedded with nano sensors and fused etched with nano-fiber/micro fibers to enable an effective detection platform, comprising applications for a wearable glass 461. The glass 461 further configured for communications with EDs, such as smart phones 600. The glass 461 further operable in proximity with the smart phones 600. The glass 461 is further disposed with control means 601 operable to enable control operations via the glass in association with the smart phone 600. Disclosed embodiments provide the transmitter 242 further comprises a transducer operable for controlling operations such as sounds, images, signals, communication signals, and audios. Certain embodiments provide the glass 461 configured with a plasma region 602, a photo region 603, each comprising plasmonic and/or photonic elements 604. The transducer further configured for converting audio signals into mechanical signals such as vibrations for conversion into human understandings. Some embodiments provide the glass 461, having at least a curved surface 605, comprising a bendable hinge 606 having at least a flexible structure and configured to enable interactive multimedia interface 607. The curved surface 605 further comprises NAs comprising nano sensors embedded in a detection platform 608.

The detection platform further comprises silicon substrate nano fiber/microfiber embedded with at least one of nano sensors, NEMS/MEMS, infrared sensors, accelerometer, gyro-sensor, nano-antennas, LED, nano-antennas on chip, and configured to provide light operations to enable photo and video operations. The detection platform 608 further disposed with camera 609, memory 610, processor 611, plasmonic sensor 612, photonic sensor 613, microphone 614, power button 615, and a lens region 616, a charge port comprising USB port 617, and configured for Bluetooth, Wi-Fi. Some embodiments further provide the glass 461 having a nose ridge region 618 further configured with meta material substrate to form a nose pad 620. The glass flexible region is further extendable to be secured against the ear. The flexible structure constitutes a bendable region 621, further configured with a battery housing 622. Embodiments provide the battery housing further comprises a cell platform configured for harvesting energy to power itself and/or for communication with an energy storage medium 623. Certain embodiments provide the cell platform further comprises means to power other EDs wirelessly. The glass 461 further configured for multimedia operations, including, but not limited to television, video, entertainment, monitoring, location base applications, sunglass application, and electro chromic applications. The lens region further comprises a region that include sunglass, charcoal, sky blue, mirror like, means for changing color when voltage is applied.

The shoe 465 further comprises footwear, including an insert-able pad 501 that may be portable to conventional shoe to enable measurements and detection characteristics. The pad 501 further configured to fit over a sole portion 502 to enable measurements and data collections extending under a wearer's foot.

The pad 501 further comprises flexible structure 503 disposed with sensors 504 embedded in silicon substrate 205 and etched/fused in nano-fiber/microfiber material 723 having excellent electrical characteristics and conforming to the shape corresponding to the sole of the footwear. The sensors 504 further comprises layer surface of functional sensor groups, including antennas 724 having a transition layer 505, in association with a processor 506. The pad is worn for gathering data, analyzing data, and for enabling measurements. At least one measurement comprises the amount of calories burnt during an event. At least one event includes jogging, exercising, gaming, running, and entertaining. The pad 501 is communicatively connected to at least a processor 506 being configured for analyzing data, in association with a memory configured for storing executable instructions executed by the processor 506. The processor 506 is in association with GPS 590. Embodiments further provide the execution further comprises causing the pad 501 to process image data associated with image of an object. At least one object comprises wearer's destination, weight, location, current environment, objects around the environment, and comparing the objects to at least a threshold to determine wearer's activities, safeties, fitness, ability, possession of an object, health, and physiological conditions based on the threshold value. At least one threshold value comprises weight, location, state of mine, mental state, physical conditions, and physical fitness. Embodiments further provide the WCD 434 further comprising at least a hand watch 460 disposed at least one configuration disclosed herein for a WCD. The watch 460 further configured for energy harvesting 619.

While certain aspects and embodiments of the disclosure have been described, these have been presented by way of example only, and are not intended to limit the scope of the disclosure. Indeed, the novel of the apparatus described herein may be embodied in a variety of other forms without departing from the spirit thereof. The accompanying claims and their equivalents are intended to cover such forms or modifications as would fall within the scope and spirit of the disclosure. It is to be understood that the scope of the present invention is not limited to the above description, but encompasses the following claims;

What is claimed:

1. A communication medium for data processing implementation of interactive multimedia activities, comprising:
at least a CA;
at least a processor in association with a software program;
at least a memory apparatus; and
at least means for detecting communication signals;

2. The communication medium of claim 1, wherein said CA further comprises at least a WCD.

3. The communication medium of claim 1, wherein said CA further comprises at least an interactive interface apparatus communicatively connected to at least an electronic media, wherein the electronic media further comprises data content management in association with said processor, wherein said processor in association with said means for detecting communications for controlling operations of EMC management and for monitoring operations of the EMC.

4. The communication medium of claim 1, wherein said CA further comprises a cell phone in proximity with at least a WCD and communicatively connected to said memory apparatus.

5. The communication medium of claim 1, wherein said CA further comprises at least an interactive MT device.

6. The communication medium of claim 1, wherein said CA further comprises at least a social network management platform.

7. The communication medium of claim 1, wherein said CA further comprises social media environment in association with at least a social network platform associated with EMC for implementing social communication within a centralized NE.

8. The communication medium of claim 1, wherein said CA further disposed with functional buttons configurable via at least a web portal, and wherein at least one web portal further associated with a social network platform associated with EMC being accessed by users of the social media environment.

9. The communication readable medium of claim 1, wherein said CA further comprises at least one of an EC platform, an electronic marketplace, an electronic shopping center, an electronic mall, a social marketplace.

10. The communication medium of claim 1, wherein said CA further associated with said WCD for communicating at least one of force measurements, weight measurements, fluidic measurements, physiological measurements, health measurements, mental measurements data contents, location awareness, monitoring awareness, sporting activities awareness, tracking awareness.

11. The communication readable medium of claim 1, wherein said processors in association with said memory for providing network authentication and for storing said one or more software programs for execution by one or more processors.

12. The communication medium of claim 11, wherein said software program further comprises instructions configured for at least one of multimedia interactions, executing feeds, data contents management, multimedia communications, multimedia entertainments, mobile multimedia interactions, for execution over at least one of a NE, a social network platform, a social media environment.

13. The communication medium of claim 1, wherein said CA further comprises at least one of a NE, a marketplace environment, a marketplace associated with applications operable to provide marketplace functions and/or services to users of the social media and/or SNE that access the EC frontend and/or backend to provide and/or purchase products.

14. The communication medium of claim 1, wherein said CA further comprises at least one of a social media environment, a SNE; and at least a marketplace environment, each configured with at least a payment method comprises payment applications for users of the media and NE to connect with media services, network services, and payment services and functions.

15. The communication medium of claim 14, wherein said payment services further configured for the payment applications to allow users of a NE to deliver and/or purchase products and/or accumulate discounted values that are made available via hours/time of communication within the media and/or NE.

16. The communication medium of claim 1, wherein said CA further comprises at least a NE configured with at least a basic structure for providing at least one of: easy communication to a smart phone, social media communications, social network communications, gaming, entertainment, emergency communications, detections, distinctive contents, forms, colors, texture, textile, glamour, trending, branding, awareness and/or composition as an alternative network services, payment applications, each associated with at least one of social media services, social network services, market payment services, at least one service further comprises an online marketplace for at least one of retailing goods, multimedia commercial activity, merchandising, products promotion, commercialization, advertisement, television.

17. The communication medium of claim 1, wherein said CA further comprises a NE configured for social networking service that allows at least a user of the service to create an interest list associated with a topic of interest, wherein the interest list further comprise at least one of shopping habits, purchased products, postings, blogging, gaming, sporting, running, jogging, entertainments, events and sharing the habits with users that may post content via the social networking services.

18. The communication medium of claim 1, wherein said CA further comprises IMMT apparatus configured for at least one of photographic imaging, news media, social media, image posting, providing connections via one or more communication medium associated with a social networking environment, and wherein at least one communication medium further comprises at least one of: an mobile television, television, Internet television, electronic shopping center, electronic mall, radio, newsfeed, an image filter, a frame and/or stream.

19. The communication medium of claim 1, wherein said CA in association with said software program to perform operations; comprising at least one of: tracking a user, locating a user, monitoring a user, within a network receiving information from at least a user of the network to add an activity to a list associated with at least another user of the network, determining whether a user has added an activity to a social and/or shopping list based on a predetermined relationship, establishing a predetermined relationship with friends based on user's habits and friends shopping on the market place, blocking at least an unauthorized user from adding an activity and/or topic of information to the list of another user, allowing wireless communications from a smart phone to the WCD, wherein at least one relationship with friends includes at least one of: share, post, invite, like, blog, fashion, style, model, dress code, each comprising a request for the network to associate users passion with their habits to enable connecting and/or sharing information relating fashion TOI.

20. The communication medium of claim 1, wherein said CA further comprises a sensory NE comprising a platform associated with at least one of voice recognition, short distance wireless communications, a network-based marketplace for social media, social networking, providing fashion topics communication to monitor; share; and follow the progress of a communication, make purchase, network, provide auctions and/or sales activities, energy harvesting.

21. The communication medium of claim 1, wherein said CA further comprises an interactive MT comprising an ED operable for at least one of producing images, editing images, for receiving images, receiving sounds, receiving video signals, each for enabling social network distributions to a centralized CE.

22. The communication medium of claim 21, wherein said interactive MT further comprises at least one of embedded sensors, LED, cameras for enabling image security and communication network with at least a media device, database for photo files sharing, database for video files sharing, a platform for enabling image and video distribution over a SNE, signal distribution network, communication signal network, EDs network, digital signal network.

23. The communication medium of claim 1, wherein said CA further comprises means for sensing objects and for analyzing frames from a video data taken from said interactive MT, wherein said interactive MT communicatively connected to a SNE for transmitting data relating to social media objects distributable to a network community from at least a remote environment.

24. The communication medium of claim 1, wherein said CA further configured for communications with a WCD, wherein said CA further comprises a control server comprising one or more servers associated with at least a processing systems communicatively connected to software program for enabling centralized communications, command and control of plurality devices, destination and/or applications, and wherein the interactive MT in association with said processor for controlling video display, in association with a network interface for receiving Internet video from the server over the Internet.

25. The communication medium of claim 1, wherein said CA further comprises at least a user interface device further configured with said processor for transmitting and for receiving video/image selection signals to enable at least a media video module “MVM,” wherein said processor being further configured to execute the “MVM” to create an interactive MT environment “IMTE,” and wherein the “IMTE” further comprises a story content for Internet video being distributed in a centralized CE, wherein the story contents further comprise frames in the video in communication with the processor for displaying at least one of: text, video and/or image content in a SNE.

26. The communication medium of claim 1, wherein said CA further configured for communications with a WCD configured to enable communications and to alert a network client of network communications, wherein the MVM further associated with at least a decoder cooperatively configured for streaming the video content from various locations of the server for display over at least one of wearable ED, mobile ED, smart phones, digital communication device, the Internet, and wherein said CA further comprises means for decoding frames from videos to enable video broadcasting clarity over a centralized CE.

27. The communication medium of claim 1, wherein said CA further communicatively connected to said software program to perform at least one of: HTML frame application, graphic publishing applications, desktop publishing applications, video frame application, animation application, packet transmitting application, social construction application, media feed application, posting application blogging application, marketing application, ecommerce application, wearable communication application, television application, network application, sensors network application, signal detection application, medical response application, advertising application, communication application, social distribution application, streaming application, filtering application, smart phone application, communication alert application, voice command application, signal booster application, energy harvesting application, search engine application, short distance communication, application, web portal application, function activation application, pre-programmed application, messaging application, gaming application, entertainment application, voice recognition application, Internet application, cloud communication application, and social sharing application over a centralized CE.

28. The communication medium of claim 1, wherein said CA in communication with said means for detecting communication signals, further comprises at least one of on-chip antennas, SN, MAOC, electronic image processing, client interface, millimeter wave network, energy harvesting electronics, energy harvesting network, path sharing RF signal network, data transfer apparatus, a transceiver, a CMOS antenna, a CMOS multiple antenna on chip, a virtual chat apparatus, a detection platform.

29. The communication medium of claim 1, wherein said CA further comprises a CE for at least one of fashion media, fashion network, model media, model network, celebrity media, celebrity network, dress code media, dress code network, photographic media, photographic network, art media, art network, hair stylish media, hair stylish network, entertainment media, entertainment network, beautician media, beautician network, sporting media, sporting network, events media, events network, educational media, educational platform, educational network.

30. The communication medium of claim 1, wherein said CA further comprises at least one of gossip media, gossip network, science media, science network, engineering media, engineering network, medical media, transportation media, social media, medical network, technician media, social network, nanotech media, nanotech network, wearable media, wearable network, distributive network, backhaul link.

31. The communication medium of claim 1, wherein said CA further comprises a media environment where a network user may elect to perform at least one of like, fashion, favorites, model, dress code a posting.

32. A WCD, comprising: at least a sensor means; at least a receiving means in association with said sensor means; at least a processor means in communication with at least one of said sensor means, a memory means, said receiving means; at least a software program associated with a module, comprising instructions stored in the memory means for execution by said processor means to perform at least an operation; and at least an interactive media interface.

33. The WCD of claim 32, wherein said operation further comprises at least one of: receiving communications, enabling signal network, enabling SN, measuring physical activities, measuring physical fitness, measuring calories burnt via physical activities, transmitting communications, reading physical activities, reading burnt calories from physical activities, harvesting energy, generating energy, storing energy, enabling multimedia interaction, enabling multimedia communications, DNA profiling, enabling cloud communications, determining a user state associated with said sensor means data, providing a recommendation via said interactive media interface based on profile associated with the user, determining at least a location, monitoring a user, communicating with a network, associating with a social network, associating with social media environment, gathering data, analyzing data, sharing data, providing a virtual display, communicating with a smart phone, communicating with at least a computer device, tracking a person, determining a wireless network, taking samples, enabling wireless communications, monitoring emotional state, monitoring students, monitoring physiological conditions, monitoring and/or tracking a person, playing music, playing melodies, playing videos, playing games, playing sounds, displaying images, enabling measurements, monitoring and/or checking physiological conditions, administering treatments, reporting and/or monitoring body conditions, fluidic filtration media, bacteria detection media, detection communication media, reporting and/or monitoring mental conditions, reporting and/or monitoring physical conditions, reporting and/or monitoring injurious conditions, enabling interactive media, taking measurements based on at least one of force, weight, fluidic substance, sound, physiological conditions, mental state, physical state, health state.

34. The communication medium of claim 1, wherein said CA further comprises an infotainment system in communication with at least one of vehicular wireless network, smart phone, mobile wireless network, WCD, IMMT.

35. The communication medium of claim 1, wherein said means for detecting communication signals further comprises multiple antennas on chip in association with sensors configured for sensing airwave signals to enable effective online television, communication, and/or video streaming clarity.

36. The communication medium of claim 1, wherein said CA in association with said processor and communicatively connected to the multiple antennas on chip for providing at least one of online video streaming, broadcast television programs, mobile communication medium, television services, mobile television applications.

37. The communication medium of claim 1, wherein said software program further operable for converting said broadcast programs into at least one of online video streams, online broadcast television program, mobile communication medium, television services, mobile television applications.

38. The communication medium of claim 37, wherein said broadcast programs further comprises applications being transmitted on public airwaves and said online television and or online video streaming further comprises at least one of broadband Internet video services, video streaming services mobile communication services, television services, mobile television applications.

39. The communication medium of claim 36, wherein said multiple antennas on chip further comprises a performance apparatus associated with television clarity and/or video streaming clarity, and wherein said multiple antennas on chip further configured for providing faster data transmission for at least one of mobile communication application, television service application, mobile television applications, video sharing applications, video streaming applications, data transport applications, database contents applications.

40. The communication medium of claim 1, wherein said CA further configured for implementing performance associated with multimedia server operations for at least one of: online television services; online video streaming; mobile television services; wherein the performance further comprises at least one of: capturing airwave signals; receiving a plurality of profiles associated with users of at least a media server; storing the plurality of profiles in said memory in association with at least a database residing on the media server; receiving from at least an entity, at least a content and content metadata based on the plurality of profiles associated with a remote content database; receiving from an entity at least one airwave signal associated with programs, advertisements, credentials, and/or advertisement metadata based on plurality of profiles associated with a remote database content; storing database content and/or content metadata in at least a second database residing on the media server; storing advertisement data and/or advertisement metadata in at least one database residing on a media server; providing at least a performance content item based on a user and/or airwave profile associated with plurality of profiles and/or plurality of content associated with metadata; selecting at least one advertisement based on a user profile and the advertisement metadata; inserting at least an advertisement into an advertisement slot; and streaming at least a performance associated with multimedia content to at least a user device based on the user profile.

41. The communication medium of claim 1, wherein said CA further associated with systems for capturing airwave media content and for distributing the content via online media.

42. The communication medium of claim 1, wherein said CA further configured for at least one of receiving online multimedia content, broadcasting contents online, providing web based services, providing mobile television services, providing mobile network services, providing mobile communication services, providing television services, enabling mobile television applications.

43. The communication medium of claim 42, wherein the multimedia content further comprises at least one of recordable content, compress-able content, storable content, shareable content, radio defined content, software defined content and wherein each associated with at least one of software defined media, sensor defined media, radio defined media, software defined radio, mobile communication services television services mobile television applications, and multimedia communications.
